(19) United States
(12) Patent Application Publication
(10) Pub. No.: US 2026/0267253 A1
(43) Pub. Date: Sep. 10, 2026

(54) ELECTROPHOTOGRAPHIC IMAGE FORMING APPARATUS, PROCESS CARTRIDGE, AND IMAGE FORMING METHOD

(71) Applicant: CANON KABUSHIKI KAISHA, Tokyo (JP)

(72) Inventors: KOSUKE FUKUDOME, Tokyo (JP); MASAHIRO KURACHI, Shizuoka (JP); DAI NOZAKI, Shizuoka (JP); TORU ISHII, Shizuoka (JP); YUICHI KIKUCHI, Shizuoka (JP); SHOHEI TSUDA, Shizuoka (JP); MASATSUGU HONGO, Shizuoka (JP)

(21) Appl. No.: 19/556,963

(22) Filed: Mar. 4, 2026

(30) Foreign Application Priority Data
Mar. 10, 2025 (JP) 2025-037302
Feb. 19, 2026 (JP) 2026-025166

(51) Int. Cl. G03G 15/02; G03G 9/093; G03G 21/00; G03G 21/18

(52) U.S. Cl. CPC G03G 15/0233; G03G 9/09342; G03G 21/0011; G03G 21/1814

(57) ABSTRACT

An electrophotographic image forming apparatus is provided, which has a charging roller and toner. The surface of the charging roller has a plurality of protrusions. When a group of protrusions having a height of 10.0 μm to 40.0 μm among the plurality of protrusions is taken as a group of first protrusions, and the number of vertices of protrusions included in the group of first protrusions per unit area on the surface of the charging roller is denoted by Spd1, the Spd1 is 10/mm² to 300/mm². The number of vertices of protrusions having a height exceeding 40.0 μm per unit area on the surface of the charging roller is not more than 3.0/mm². The toner has a toner particle and titanium oxide fine particles. The titanium oxide fine particles have titanium oxide fine particles A that have specific major axis and aspect ratio.

### BACKGROUND

### Field of the Technology

The present disclosure relates to an electrophotographic image forming apparatus, a process cartridge, and an image forming method.

### Description of the Related Art

Electrophotographic image forming apparatuses (hereinafter also referred to as “image forming apparatuses”) are required to achieve higher image quality, faster speeds, smaller size, and longer life. These performance requirements have to be consistently met across a wide variety of operating environments and media used by users around the world. Furthermore, with the recent trend toward diversifying workspaces due to the increase in remote work, there is a demand for image forming apparatuses that can consistently output high-quality images in an even wider range of operating environments. To achieve this, further performance improvements are required for image forming apparatuses, process cartridges, and image forming methods.

For example, in cold regions, devices may be used for a long period of time in an environment with air temperatures lower than in the conventional low-temperature environment (ultra-low-temperature environment, which is referred to in the present disclosure as an environment with a temperature at or below 0° C.), and stable image quality needs to be demonstrated even in such an environment. However, when used for a long period of time in an ultra-low-temperature environment, charging rollers tend to become easily contaminated, which can result in the occurrence of white or black dot-shaped image defects (halftone spots) on halftone images, and improvements are needed.

Measures developed to address this problem include lowering the process speed, increasing the diameter of the charging roller to slow the rate of roller surface contamination, increasing the frequency of charging roller replacement, installing a member for cleaning the charging roller, and the like. However, these measures limit opportunities for increasing the speed, expanding the lifespan, and reducing the size of image forming apparatuses. Therefore, there is a need for improvements to charging rollers and toner without increasing the number of parts or size thereof.

For example, JP-A-2018-084653 discloses incorporating resin particles into a charging roller and adjusting the surface roughness, such as the arithmetic mean roughness, in order to stably charge a photosensitive drum when the charging roller is used for long periods of time.

In addition, JP-A-2008-139899 discloses a toner containing acicular titania as an external additive for the purpose of improving the scraping ability of toner from a developing blade and promoting the flow of toner to the developing roller.

### SUMMARY

The research conducted by the present inventors demonstrated that the charging roller disclosed in JP-A-2018-084653, which contains resin particles and has an adjusted surface roughness, such as the arithmetic mean roughness, was indeed effective in stably charging the photosensitive drum to a certain extent. However, when the charging roller is used for long periods of time in an ultra-low-temperature environment, which is a more severe environment in terms of cleaning property, contamination property of the charging roller, and charging performance, the charging roller may be contaminated. As a result, the photosensitive drum is difficult to charge uniformly and defects may occur in the halftone image.

Meanwhile, with the toner disclosed in JP-A-2008-139899, which contains acicular titania as an external additive, a certain effect is indeed achieved in terms of scraping ability of toner from the developing blade and the stability of toner supply to the developing roller. However, when the toner is used for a long period of time in an ultra-low-temperature environment, which is a more severe environment in terms of cleaning property, contamination property of the charging roller, and charging performance, defects may occur in the obtained halftone image.

The present disclosure provides an electrophotographic image forming apparatus, process cartridge, and image forming method that make it possible to stably output highly uniform halftone images even after durable use for a long period of time in an ultra-low-temperature environment.

To solve the above problem, the inventors conducted extensive research into the relationship between the resistance of the charging roller to contamination, the charging performance of the photosensitive drum, and the external additives in toner in durable use for a long period of time in an ultra-low-temperature environment. As a result, the inventors discovered that the above-mentioned problems can be solved by an image forming apparatus including a charging roller having a specific number of protrusions of a specific height on the surface, and a toner containing titanium oxide fine particles with a specific major axis and aspect ratio.

The present disclosure relates to an electrophotographic image forming apparatus comprising: a photosensitive drum; a charging roller for charging a surface of the photosensitive drum; an exposure means for exposing charged photosensitive drum to form an electrostatic latent image on the photosensitive drum; a developing means having toner and using the toner to develop the electrostatic latent image formed on the surface of the photosensitive drum, thereby forming a toner image; a transfer means for transferring the toner image to a transfer material, with or without an intermediate transfer member; and a fixing means for fixing the toner image on the transfer material, wherein a surface of the charging roller has a plurality of protrusions, when a group of protrusions having a height of 10.0 μm to 40.0 μm among the plurality of protrusions is taken as a group of first protrusions, and the number of vertices of the protrusions included in the group of first protrusions per unit area on the surface of the charging roller is denoted by Spd1, the Spd1 is 10/mm² to 300/mm², the number of vertices of the protrusions having a height exceeding 40.0 μm per unit area on the surface of the charging roller is not more than 3.0/mm², the toner comprises a toner particle and titanium oxide fine particles; the titanium oxide fine particles comprise titanium oxide fine particles A that satisfy all of conditions (i) to (ii) below, when the toner is observed using a scanning electron microscope, a proportion of the toner particle that can be confirmed to have the titanium oxide fine particles A on surfaces thereof is 80% by number to 99% by number: (i) The number-average value of major axis is 1.0 μm to 6.0 μm; (ii) The number-average value of aspect ratio is at least 5.0.

The present disclosure relates to a process cartridge comprising: a photosensitive drum; a charging roller for charging a surface of the photosensitive drum; and a developing means having toner and using the toner to develop an electrostatic latent image formed on the surface of the photosensitive drum, thereby forming a toner image, wherein a surface of the charging roller has a plurality of protrusions; when a group of protrusions having a height of 10.0 μm to 40.0 μm among the plurality of protrusions is taken as a group of first protrusions, and the number of vertices of the protrusions included in the group of first protrusions per unit area on the surface of the charging roller is denoted by Spd1, the Spd1 is 10/mm² to 300/mm²; the number of vertices of the protrusions having a height exceeding 40.0 μm per unit area on the surface of the charging roller is not more than 3.0/mm², the toner comprises a toner particle and titanium oxide fine particles; the titanium oxide fine particles comprise titanium oxide fine particles A that satisfy all of conditions (i) to (ii) below, and when the toner is observed using a scanning electron microscope, a proportion of the toner particle that can be confirmed to have, on the surface thereof, titanium oxide fine particles A is 80% by number to 99% by number: (i) The number-average value of major axis is 1.0 μm to 6.0 μm; (ii) The number-average value of aspect ratio is at least 5.0.

The present disclosure relates to an image forming method comprising: a charging step of charging a surface of a photosensitive drum by using a charging roller; an exposure step of exposing charged photosensitive drum to form an electrostatic latent image on the photosensitive drum; a development step of using toner to develop the electrostatic latent image formed on the surface of the photosensitive drum, thereby forming a toner image; a transfer step of transferring the toner image to a transfer material, with or without an intermediate transfer member; and a fixing step of fixing the toner image on the transfer material, wherein a surface of the charging roller has a plurality of protrusions, when a group of protrusions having a height of 10.0 μm to 40.0 μm among the plurality of protrusions is taken as a group of first protrusions, and the number of vertices of the protrusions included in the group of first protrusions per unit area on the surface of the charging roller is denoted by Spd1, the Spd1 is 10/mm² to 300/mm², the number of vertices of the protrusions having a height exceeding 40.0 μm per unit area on the surface of the charging roller is not more than 3.0/mm², the toner comprises a toner particle and titanium oxide fine particles; the titanium oxide fine particles comprise titanium oxide fine particles A that satisfy all of conditions (i) to (ii) below, when the toner is observed using a scanning electron microscope, a proportion of the toner particle that can be confirmed to have, on the surface thereof, titanium oxide fine particles A is 80% by number to 99% by number: (i) The number-average value of major axis is 1.0 μm to 6.0 μm; (ii) The number-average value of aspect ratio is at least 5.0.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic cross-sectional view of a charging roller.

FIG. 2 is an example of a spectrum obtained by liquid chromatography ESI/MS.

FIG. 3 is a schematic cross-sectional view of an image forming apparatus.

FIG. 4 is a schematic cross-sectional view of a process cartridge.

FIG. 5 is a diagram illustrating the contact relationship between a cleaning blade and a photosensitive drum.

FIG. 6 is a diagram illustrating a method for measuring a contact line pressure of the cleaning blade.

### DESCRIPTION OF THE EMBODIMENTS

In the present disclosure, expressions such as “from XX to YY” or “XX to YY” representing a numerical range mean a numerical range including the upper and lower limits, unless otherwise specified. When a numerical range is described in stages, the upper and lower limits of each numerical range can be arbitrarily combined. Furthermore, in the present disclosure, expressions such as “at least one selected from the group consisting of XX, YY, and ZZ” mean XX, YY, ZZ, a combination of XX and YY, a combination of XX and ZZ, a combination of YY and ZZ, or a combination of XX, YY, and ZZ. When XX is a group, multiple members of XX may be selected, and the same applies to YY and ZZ.

Embodiments of the present disclosure will be described hereinbelow in detail with reference to the drawings. However, the components described in the embodiments are merely exemplary and are not intended to limit the scope of the present disclosure.

In the electrophotographic process, an electrostatic latent image is formed using a laser beam on a photosensitive drum charged by a charging roller. The electrostatic latent image is then developed using charged toner to form a developer image. The developer image is then transferred to paper and fixed to form an image.

During this process, dirt such as toner and external additives that were not completely transferred to the paper, as well as paper dust and fillers contained in the printing paper that has migrated to the photosensitive drum (collectively referred to as dirt), remains on the photosensitive drum. To prevent the dirt remaining on the photosensitive drum from adhering to the charging member, the dirt is generally scraped off with a cleaning member, preventing any adverse effects on the image.

Dirt such as toner and external additives that remains on the photosensitive drum and slips through the cleaning blade migrates to the charging roller side at the contact area between the photosensitive drum and the charging roller. Every time the charging roller and photosensitive drum come into contact, the contaminants adhering to the charging roller surface are pressed against the photosensitive drum and adhere thereto as a result of contact with the photosensitive drum.

Furthermore, any dirt remaining on the photosensitive drum after the transfer process is charged by an electric discharge during the transfer process.

In addition, usually, a strong voltage of approximately −1000 V is applied to the charging roller, and a strong electric field is required between the charging roller and the photosensitive drum. Furthermore, because the polarity of the transfer process and the charging process is often reversed, contaminants migrate by flying to the surface of the charging roller due to electrostatic force.

As described above, there are many complex factors that cause dirt to adhere to the charging roller, making it difficult to prevent dirt from adhering over a long period of time.

The inventors conducted extensive research to provide an image forming apparatus that can stably form high-quality halftone images even in durable use for a long period of time in an ultra-low-temperature environment (at or below 0° C.).

The inventors have found that in an ultra-low-temperature environment, dirt easily slips through the contact area between the cleaning blade and the photosensitive drum during the cleaning step, making the charging roller susceptible to contamination over a short period of use.

Contaminants such as external additives, toner, and paper dust generally have a higher resistance than the charging roller. Therefore, excessive accumulation of dirt on the charging roller causes a difference in electric discharge between the contaminated and uncontaminated areas of the charging roller and the photosensitive drum, making it difficult to uniformly charge the surface of the photosensitive drum. In severe cases, abnormal electric discharge occurs near the contaminated areas of the charging roller, resulting in point-like defects in halftone images. In the present disclosure, these point-like defects are referred to as “halftone dots”.

Furthermore, the inventors have recognized that in an ultra-low-temperature environment or in durable use for a long period of time, the electric resistance of the charging roller itself tends to increase due to electrical degradation, and that in an ultra-low-temperature environment, an abnormal electric discharge is likely to occur between the charging roller and the photosensitive drum. Therefore, even if the degree of contamination of the charging roller is the same, the issue of halftone dots is likely to manifest itself.

Thus, while there is a need for an image forming apparatus that can suppress the occurrence of halftone dots during durable use for a long period of time in an ultra-low-temperature environment, a means for solving the problems has been difficult to find.

The inventors first investigated whether it would be possible to reduce contamination of the charging roller during durable use for a long period of time by improving the surface shape of the charging roller in an image forming apparatus. Then, the inventors attempted to reduce the contact area between the charging roller and the photosensitive drum by giving the surface of the charging roller a specific uneven shape. As a result, it was possible to make it more difficult for contaminants to migrate from the photosensitive drum to the surface of the charging roller, and a certain effect in reducing contamination of the charging roller during durable use for a long period of time could be confirmed.

However, it was found that in an operating environment where contaminants easily slip through during the cleaning step, such as an ultra-low-temperature environment, it is difficult to suppress contamination of the charging roller using the above-mentioned techniques alone. Specifically, contaminants tend to accumulate near the protrusions on the surface of the charging roller that contact the photosensitive drum, making it impossible to consistently suppress halftone dots.

The inventors therefore changed their perspective and investigated the possibility of suppressing halftone dots during durable use for a long period of time in an ultra-low-temperature environment by further improving the toner used in image forming apparatuses.

In addition to using a charging roller with a specific surface irregularity, the inventors investigated the use of toner containing titanium oxide fine particles A having a major axis and an aspect ratio within specific ranges as an external additive. The inventors have found that the synergistic effect of the charging roller and toner successfully suppresses halftone dots during durable use for a long period of time in an ultra-low-temperature environment.

The reason for this effect is unclear, but the inventors speculate that it can be explained as follows. In an ultra-low-temperature environment, titanium oxide fine particles A migrate to the photosensitive drum during the development step, slip through in the cleaning step, and migrate to the surface of the charging roller. As mentioned above, contaminants tend to accumulate near the protrusions on the surface of the charging roller. Therefore, titanium oxide fine particles A and other contaminants gather near the protrusions on the surface of the charging roller and coexist therein.

Titanium oxide fine particles A have lower electric resistance than other contaminants and have a long, thin shape, so they have the ability to assist the electric discharge near the protrusions on the surface of the charging roller. Therefore, even if the vicinity of the protrusions on the surface of the charging roller is contaminated with other contaminants, the coexistence of titanium oxide fine particles A can suppress the occurrence of a poor electric discharge in those areas, and it is believed that the occurrence of halftone dots can be stably suppressed even during durable use for a long period of time.

The research conducted by the inventors showed that the above-mentioned operational effects cannot be obtained simply by using toner containing titanium oxide fine particles A, and are synergistically achieved by also controlling the surface unevenness profile of the charging roller. This is supposedly because the specific surface shape of the charging roller makes it easier for titanium oxide fine particles A and other contaminants to coexist in specific areas on the surface of the charging roller, such as in the vicinity of the protrusions.

The electrophotographic image forming apparatus disclosed herein comprises: a photosensitive drum; a charging roller for charging the surface of the photosensitive drum; an exposure means for exposing the charged photosensitive drum to light to form an electrostatic latent image on the photosensitive drum; a developing means having toner and using the toner to develop the electrostatic latent image formed on the surface of the photosensitive drum to form a toner image; a transfer means for transferring the toner image to a transfer material with or without an intermediate transfer member; and a fixing means for fixing the toner image on the transfer material. In the electrophotographic image forming apparatus, the charging roller has a specific surface shape, and the toner contains a specific external additive.

A plurality of protrusions is present on the surface of the charging roller. Among the plurality of protrusions, a group of protrusions having a height of 10.0 μm to 40.0 μm is referred to as a group of first protrusions. When the charging roller has the group of first protrusions, and the number of vertices of the protrusions included in the group of first protrusions per unit area on the surface of the charging roller is denoted as Spd1, Spd1 is 10/mm² to 300/mm². The number of vertices of protrusions having a height exceeding 40.0 μm per unit area on the surface of the charging roller is 3.0/mm² or less. The unit “/mm²” indicates “number/mm²”.

Because of the presence of the group of first protrusions having the above-described protrusion height, and as a result of the number Spd1 of vertices of the first protrusions per unit area being within a specific range, the contact surface area between the photosensitive drum and the charging roller can be reduced, and the total amount of contaminants that migrate from the photosensitive drum to the charging roller can be reduced.

Furthermore, when titanium oxide fine particles A and other contaminants migrate from the photosensitive drum to the charging roller, they migrate around the protrusions that make up the group of first protrusions and coexist near the protrusions. Therefore, even if the area around the group of first protrusions is contaminated, titanium oxide fine particles A assist the electric discharge, making it easier to uniformly charge the photosensitive drum. This reduces halftone dots even after durable use for a long period of time in an ultra-low-temperature environment.

When the height of the protrusions is less than 10.0 μm, the spacer effect of the group of first protrusions is insufficient, making it impossible to reduce the contact surface area between the charging roller and the photosensitive drum. This results in a large amount of contaminant migrating from the photosensitive drum to the charging roller.

As a result, an abnormal electric discharge occurs in the contaminated area, preventing the photosensitive drum from being uniformly charged, which results in halftone dots after durable use for a long period of time in an ultra-low-temperature environment.

On the other hand, where the height of the protrusions exceeds 40.0 μm, the spacer height is too large, and the gap between the photosensitive drum and the area other than the protrusions becomes too wide at the contact portion between the charging roller and the photosensitive drum, thereby inducing an abnormal electric discharge. This makes halftone dots more likely to occur in an ultra-low-temperature environment.

Furthermore, when the number of vertices of the protrusions included in the group of first protrusions per unit area on the surface of the charging roller is denoted as Spd1, the Spd1 needs to be 10/mm² to 300/mm².

Where Spd1 is less than 10/mm², the spacer effect of the protrusion group at the contact point between the charging roller and the photosensitive drum is insufficient, making it impossible to reduce the contact area between the charging roller and the photosensitive drum. This results in a large amount of contaminants being transferred from the photosensitive drum to the charging roller.

As a result, abnormal electric discharge occurs in the contaminated area, preventing uniform charging of the photosensitive drum, which results in the occurrence of halftone dots during durable use for a long period of time in an ultra-low-temperature environment.

When Spd1 exceeds 300/mm², although the group of protrusions has a spacer effect, the contact surface area with the photosensitive drum rather becomes larger due to the excessive number of protrusions, resulting in a greater total amount of contaminants on the charging roller. Furthermore, because the number of protrusions in the group of protrusions is too large, the electric field applied per protrusion at the contact portion between the charging roller and the photosensitive drum becomes smaller, weakening the electric discharge. This makes it more likely that a poor electric discharge will occur due to contamination of the charging roller, and halftone dots will not be suppressed.

The charging roller is characterized in that the number of vertices of protrusions having a height exceeding 40.0 μm per unit area on the surface of the charging roller is 3.0/mm² or less. Where the number of vertices of protrusions having a height exceeding 40.0 μm exceeds 3.0/mm², contact between the group of first protrusions and the photosensitive drum is hindered at the contact portion between the charging roller and the photosensitive drum, making it impossible to uniformly charge the photosensitive drum and resulting in halftone spots in an ultra-low-temperature environment.

An image forming apparatus contains a toner that includes a toner particle and titanium oxide fine particles.

The titanium oxide fine particles include titanium oxide fine particles A that satisfy all of the following conditions (i) to (ii):
(i) The number-average value of major axis is 1.0 μm to 6.0 μm
(ii) The number-average value of aspect ratio is 5.0 or greater

Furthermore, when the toner is observed using a scanning electron microscope, the proportion of toner particles that can be confirmed to have titanium oxide fine particles A on surfaces thereof is 80% by number to 99% by number.

The titanium oxide particles A that satisfy the above (i) and (ii) have a large particle diameter and rod-like shape for an external additive contained in toner. Furthermore, titanium oxide has relatively low electric resistance as an external additive for toner applications.

Where the toner contains the titanium oxide particles A, the titanium oxide particles A migrate to the photosensitive drum during the development step, slip through the cleaning step, and migrate to the surface of the charging roller.

As described above, the charging roller has the group of first protrusions on the surface thereof, and thus, like other contaminants, the titanium oxide particles A tend to selectively adhere to the vicinity of the group of first protrusions.

When the proportion of toner particles that can be confirmed to have titanium oxide fine particles A on surfaces thereof is 80% by number to 99% by number, titanium oxide particles A tend to migrate to the surface of the charging roller.

The titanium oxide fine particles A have a rod-like shape with a major axis of 1.0 μm to 6.0 μm and an aspect ratio of 5.0 or greater. Therefore, an edge effect is generated by the titanium oxide fine particles A, and the particles exhibit an electric discharge-assisting effect near the group of first protrusions.

As a result, it is believed that the occurrence of halftone dots can be suppressed even after durable use for a long period of time in an ultra-low-temperature environment.

Where the number-average value of major axis of the titanium oxide fine particles A is less than 1.0 μm or the number-average value of aspect ratio thereof is less than 5.0, the edge effect of the titanium oxide fine particles A is less likely to occur, and the effect of assisting the electric discharge near the group of first protrusions is not fully exhibited. As a result, the occurrence of halftone dots cannot be suppressed after durable use for a long period of time in an ultra-low-temperature environment.

The number-average value of aspect ratio should be 5.0 or greater, but is preferably 6.0 or greater, and even more preferably 8.0 or greater. While the upper limit is not particularly specified, it is preferably 20.0 or less, and more preferably 16.0 or less, from the perspective of ease of manufacturing particles with a suitable particle diameter. The number-average value of aspect ratio is, for example, 5.0 to 20.0, preferably 6.0 to 20.0, and more preferably 8.0 to 16.0.

On the other hand, where the number-average major axis value of the titanium oxide fine particles A exceeds 6.0 μm, the titanium oxide fine particles A tend to become oriented, making it difficult for the titanium oxide fine particles A to migrate uniformly to the vicinity of the group of first protrusions on the charging roller during migration from the photosensitive drum to the charging roller. As a result, protrusions are created on the charging roller surface to which the contaminants have adhered but to which an insufficient supply of titanium oxide fine particles A is provided, resulting in abnormal electric discharge near the protrusions and the appearance of halftone spots.

In the present disclosure, the term “rod-shaped” may refer to particles having an irregular, elongated, or needle-like, rice-like, stick-like, butterfly-like, or bowtie-like shape. The titanium oxide fine particles A are not particularly limited as long as the above conditions (i) and (ii) are satisfied. However, from the viewpoint of facilitating the formation of the rod-like shape, it is preferable that rutile-type titanium oxide particles be contained.

Titanium oxide fine particles A may also be subjected to a conventional surface treatment for the purposes of imparting hydrophobicity or controlling charging performance.

The content of titanium oxide fine particles in the toner is preferably 0.1 parts by mass to 3.0 parts by mass, more preferably 0.2 parts by mass to 2.0 parts by mass, per 100 parts by mass of toner particles.

The content of titanium oxide fine particles A in the toner is preferably 0.1 parts by mass to 3.0 parts by mass, more preferably 0.5 parts by mass to 2.0 parts by mass, and even more preferably 0.7 parts by mass to 1.5 parts by mass, per 100 parts by mass of toner particles.

Furthermore, from the perspective of adjusting the flowability and charging performance of the toner, titanium oxide fine particles other than the titanium oxide fine particles A described above or other external additives can also be used in combination. For example, the toner may contain silica fine particles.

Preferably, the surface of the charging roller has a group of second protrusions, which is a group of protrusions having a height of 0.2 μm to 5.0 μm. The presence of the group of second protrusions is preferable because it makes it easier to maintain halftone image quality even when the charging roller is allowed to stand for an extended period of time after durable use for a long period of time in an ultra-low-temperature environment (the difference in the level of halftone dots is small).

While the reason for this effect is unclear, it is thought that as a result of the charging roller having the group of second protrusions, a filler effect is created by the group of second protrusions, even when the charging roller and the photosensitive drum are allowed to stand for an extended period of time in contact with each other. Therefore, it is thought that even if the area around the group of first protrusions is recessed due to contact pressure, it is easier to recover.

Even when the charging roller is allowed to stand for an extended period of time, the area around the group of first protrusions does not become too recessed, and an appropriate gap is maintained between the recessed portion and the photosensitive drum. This prevents the occurrence of a poor electric discharge and further suppresses halftone dots, even in this area.

Furthermore, the number of vertices of the protrusions included in the group of second protrusions per unit area on the surface of the charging roller is denoted by Spd2. Here, Spd2 is, for example, 3000/mm² to 50,000/mm², preferably 4000/mm² to 40,000/mm², more preferably 5000/mm² to 20,000/mm², and even more preferably 7000/mm² to 12,000/mm². Having Spd2 of 4000/mm² to 40,000/mm² more easily facilitates the development of the filler effect described above. The unit “/mm²” indicates “number/mm²”.

As a result, halftone image quality is more easily maintained (the difference in halftone dot levels is small) even when the charging roller is allowed to stand for an extended period of time after durable use for a long period of time in an ultra-low-temperature environment. Furthermore, contaminants are less likely to adhere to the surface of the charging roller even in areas where the group of first protrusions is not present, thereby improving uniform discharge ability of the charging roller and further reducing the occurrence of halftone dots.

Furthermore, by setting Spd2 to 4000/mm² or greater, the surface of the charging roller can be sufficiently roughened, the contact surface area with contaminants can be reduced, and the adhesion of contaminants can be reduced. This makes it easier to reduce halftone dots. Furthermore, by setting Spd2 to 40,000/mm² or less, the number of small-diameter particles contained in the binder resin can be reduced, and fractures at the interface between the particles and the binder resin can be suppressed.

Furthermore, the universal hardness of the protrusions included in the group of first protrusions of the charging roller, which is measured at an indentation depth of 0.4 μm, is denoted by HU1. In this case, HU1 is, for example, 0.5 N/mm² to 10.0 N/mm², preferably 1.0 N/mm² to 5.0 N/mm², more preferably 2.0 N/mm² to 5.0 N/mm², and even more preferably 3.0 N/mm² to 5.0 N/mm².

By having HU1 in the range of 1.0 N/mm² to 5.0 N/mm², the hardness of the group of first protrusions becomes more appropriate, thereby making it possible to prevent contaminants from being crushed and caused to adhere by the group of first protrusions at the contact nip between the charging roller and the photosensitive drum. Further, at the same time, a stable spacer effect can be achieved in the contact nip between the charging roller and the photosensitive drum. Therefore, even in the evaluation mode using thick paper, in which an uneven electric discharge due to a large transfer current is likely to be generated and halftone dots are likely to occur, halftone dots can be sufficiently suppressed.

By setting HU1 to 1.0 N/mm² or higher, depressions in the protrusions occurring when the photosensitive member contacts the charging roller can be suppressed, and a gap can be formed between the photosensitive member and the charging roller. Furthermore, by setting HU1 to 5.0 N/mm² or less, it is possible to prevent contaminants remaining on the photosensitive member from adhering to the vertices of the group of first protrusions.

When using thick paper and setting a thick paper mode to evaluate durability, the transfer current and transfer voltage tend to be set high when transferring toner to the paper, making it more likely that strong electric discharge will occur between the paper and the photosensitive drum during the transfer step. This results in a lower potential on the photosensitive drum before the charging step than in a usual paper mode, thereby making it necessary to induce a higher electric discharge to charge the photosensitive drum during the charging step. These stringent conditions make it more likely that a poor electric discharge will occur between the charging roller and the photosensitive drum.

Furthermore, the universal hardness of the protrusions included in the group of second protrusions, measured at an indentation depth of 0.4 μm, is denoted by HU2. In this case, HU2 is, for example, 0.5 N/mm² or greater but less than 2.0 N/mm², preferably 1.0 N/mm² or greater but less than 2.0 N/mm², and more preferably 1.3 N/mm² to 1.9 N/mm².

As a result of HU2 being 1.0 N/mm² or greater but less than 2.0 N/mm², the hardness of the group of second protrusions becomes more appropriate, and in the contact nip between the charging roller and the photosensitive drum, the pressure exerted when the group of first protrusions is compressed is transmitted also to the group of second protrusions arranged therearound, thereby causing micro-vibrations in the vicinity of the group of second protrusions.

This effect can make it even more difficult for contaminants to adhere to the vicinity of the group of second protrusions.

As mentioned above, when durability is evaluated using thick paper and setting the thick paper mode, these are stringent conditions that make it more likely that a poor electric discharge will occur between the charging roller and the photosensitive drum.

Therefore, by satisfying HU2 above, the occurrence of uneven halftone dots between the resulting images can be sufficiently suppressed even in the usage method in which thick paper is used and the thick paper mode is set to continuously output halftone images, which is a more stringent usage mode.

The number of vertices of protrusions having a height of 0.2 μm or more per unit area on the surface of the charging roller is denoted by Spda (number/mm²). In this case, it is preferable that the ratio of first protrusions and second protrusions, expressed as (Spd1+Spd2)/Spda×100, be 98.0% or greater.

The fact that the ratio of first protrusions and second protrusions satisfies the above range means that of the vertices of protrusions having a height of 0.2 μm or larger that are present on the surface of the charging roller, 98.0% by number of protrusions are composed of the group of first protrusions and the group of second protrusions.

Where protrusions higher than the second protrusions but lower than the first protrusions and protrusions higher than the first protrusions are defined as third protrusions, then (Spd1+Spd2)/Spda×100 being 98.0% or greater indicates that the number of third protrusions is small. As a result of reducing the number of third protrusions, only the first protrusions come into contact with the photosensitive drum, which makes it possible to minimize the number of contact points with the photosensitive drum and enables further reduction in the amount of dirt that adheres.

By setting (Spd1+Spd2)/Spda×100 to be 98.0% or greater, the group of first protrusions and the photosensitive drum can be brought into more stable contact at the contact nip between the charging roller and the photosensitive drum, and the contact surface area can be stably reduced throughout durable use. This is preferable because halftone dots can be sufficiently suppressed even in an image forming apparatuses that includes an exposure device before the contact between the charging roller and the photosensitive drum, such a configuration creating more severe conditions with respect to electric discharge.

(Spd1+Spd2)/Spda×100 is preferably 99.0% or greater. Since a higher (Spd1+Spd2)/Spda×100 is preferable, there is no particular upper limit, but examples include 98.0% to 100.0%, 99.0% to 100.0%, and 99.0% to 99.9%.

(Spd1+Spd2)/Spda×100 can be easily increased, for example, by sharpening the particle size distribution of the resin particles that can form the first and second protrusions.

The charging roller preferably has a conductive support, a base layer provided on the support, and a surface layer provided on the base layer. Details of the charging roller will be explained hereinbelow.

In the charging roller, the surface layer preferably contains a binder resin. The universal hardness of the binder resin measured at an indentation depth of 0.4 μm is denoted by HUb. In this case, HUb is, for example, 0.8 N/mm² to 11.0 N/mm², preferably 1.0 N/mm² to 5.0 N/mm², more preferably 2.0 N/mm² to 4.0 N/mm², and even more preferably 2.5 N/mm² to 3.5 N/mm².

With a HUb of 1.0 N/mm² or greater, unevenness in halftone image quality between images is less likely to occur after durable use for a long period of time, even when the printer is allowed to stand for an extended period of time, or when multiple halftone images are printed. In other words, there is less unevenness in halftone dots between sheets of paper.

On the other hand, by keeping HUb at 5.0 N/mm² or less, contaminants are less likely to be crushed and adhere within the contact nip between the charging roller and photosensitive drum, further reducing the number of occurring dots on halftone images, even in durable use for a long period of time in an ultra-low-temperature environment.

The value obtained by dividing the number-average value of the major axis of titanium oxide fine particles A contained in the toner by the average height of the protrusions contained in the group of first protrusions on the surface of the charging roller is preferably 0.03 to 0.40. The value obtained by dividing the number-average value of the major axis of titanium oxide fine particles A by the average height of the protrusions contained in the group of first protrusions is more preferably 0.07 to 0.30, and even more preferably 0.10 to 0.25.

By satisfying the above range, the titanium oxide fine particles A are more likely to remain evenly distributed on the base of the group of first protrusions when transferred from the photosensitive drum to the charging roller. Therefore, even when forming images under conditions of low development contrast, where dots are more noticeable on halftone images, the number of occurring halftone dots can be further reduced.

Furthermore, it is preferable that the number-average value of major axis of the titanium oxide fine particles A contained in the toner be greater than the average height of the protrusions contained in the group of second protrusions on the surface of the charging roller. The value of the difference “(number-average value of major axis of titanium oxide fine particles A)−(average height of the protrusions contained in the group of second protrusions)” is preferably 0.1 to 3.5, and more preferably 0.1 to 1.5.

By satisfying the above range, the titanium oxide fine particles A can be prevented from being buried in the gaps in the group of second protrusions and are more likely to be present in the vicinity of the group of first protrusions on the surface of the charging roller. This makes it possible to more efficiently utilize the edge effect of the titanium oxide particles. This is preferable because the unevenness in halftone image quality between multiple printed images can be prevented, even when continuously printing images under conditions of low development contrast, where dots are more noticeable on halftone images. In other words, there is less unevenness in halftone dots between sheets of paper.

The height of the protrusions can be measured by scanning the surface of the charging member using a laser microscope, confocal microscope, white light confocal microscope, or the like. In the present disclosure, a laser microscope is used. A specific procedure is described below.

Spd represents the number of peaks per unit area. A larger value indicates a greater number of contact points with other objects. (ISO 25178) Spd1 and Spd2 can be measured as follows.

The measurement procedure can use a method of scanning the surface of the charging member and calculating Spd1 and Spd2. Specific examples involve a laser microscope, confocal microscope, white light confocal microscope, and the like. After obtaining a field-surface profile of the charging roller using these devices, Spd1, which corresponds to the amount of the first protrusions present on the surface, and Spd2, which corresponds to the amount of the second protrusions present on the surface, can be calculated. In the present disclosure, a laser microscope is used. A specific procedure is described below.

The universal hardness of the protrusions present on the surface of the charging member is measured, for example, using a universal hardness tester (product name: FISCHERSCOPE HM2000XYp, manufactured by Fischer Instruments Inc.). Universal hardness is a physical property determined by pressing an indenter into the object to be measured while applying a load and is calculated as “(test load)/(surface area of the indenter under the test load) (N/mm²)”. An indenter such as a square pyramid is pressed into the object to be measured while applying a predetermined, relatively small test load. The surface area in contact with the indenter is determined from the indentation depth at a point of time when the predetermined indentation depth is reached, and the universal hardness is determined using the above formula. A specific procedure described later.

The universal hardness can be controlled by the chemical structure of the resin component (rubber material, binder resin) contained in the surface layer, the material of the particles forming the protrusions, and the type and amount of filler and vulcanizing agent added to the base layer material.

The surface hardness can also be controlled by surface treatment of the surface layer. Furthermore, in the case of a charging roller configuration provided with a conductive surface layer, the surface hardness can be controlled by the film thickness of the surface layer, additives, dispersants, and the like.

The adhesion rate of titanium oxide fine particles A to the toner particle is, for example, 50% by number or less, preferably 40% by number or less, more preferably 35% by number or less, and even more preferably 30% by number or less. The adhesion rate of titanium oxide fine particles A to the toner particle is, for example, 10% by number to 40% by number, 15% by number to 35% by number, or 15% by number to 30% by number.

As a result of keeping the adhesion rate of titanium oxide fine particles A at 40% or less, the amount of titanium oxide fine particles A supplied to the charging roller tends to increase. Therefore, even in durable use for a long period of time in a low-printing mode, the occurrence of halftone dots can be further suppressed. The adhesion rate of titanium oxide fine particles A can be controlled by adjusting, as appropriate, the content of titanium oxide fine particles A and the external addition conditions.

Furthermore, when the toner is observed using a scanning electron microscope, the proportion of toner particles that can be confirmed to have titanium oxide fine particles A on surfaces thereof is 80% by number or more, preferably 90% by number or more, and more preferably 93% by number or more. The proportion of the toner particles is 80% by number to 99% by number. The proportion of toner particles that can be confirmed to have titanium oxide fine particles A on surfaces thereof is preferably 90% by number to 99% by number, more preferably 93% by number to 99% by number.

When the proportion of toner particles that can be confirmed to have titanium oxide fine particles A on surfaces thereof is 90% by number or more, the amount of titanium oxide fine particles A supplied to the charging roller tends to increase. Therefore, even in durable use for a long period of time in a low-printing mode, the occurrence of halftone dots can be further suppressed.

Techniques for increasing the proportion of such toner particles include increasing the amount of titanium oxide fine particles A added, reducing the major axis of titanium oxide fine particles A, and setting a strong external additive strength. This makes it easier for titanium oxide fine particles A to be crushed and dispersed in the external addition process, making it easier for them to be uniformly added to the toner particles, which is preferable.

The electrophotographic image forming apparatus preferably has a cleaning means equipped with a cleaning blade that is brought into contact with the surface of the photosensitive drum to clean the surface of the photosensitive drum.

The contact line pressure of the cleaning blade against the photosensitive drum is, for example, 2 N/m to 300 N/m, preferably 3 N/m to 300 N/m, and more preferably 3 N/m to 100 N/m.

A contact line pressure of 3 N/m or greater makes it easier to remove deposits from the photosensitive drum during the cleaning process, making it more difficult for contaminants to slip through the charging roller, thereby further suppressing the occurrence of halftone dots. On the other hand, a contact line pressure of 300 N/m or less ensures a moderate contact pressure, preventing the cleaning blade from being torn off even during durable use for a long period of time. This allows for stable cleaning of contaminants, further suppressing the occurrence of halftone dots.

First, the charging roller will be described below.

### Charging Roller

The present disclosure will be described in detail below using the figures.

### Outline Configuration of Charging Roller

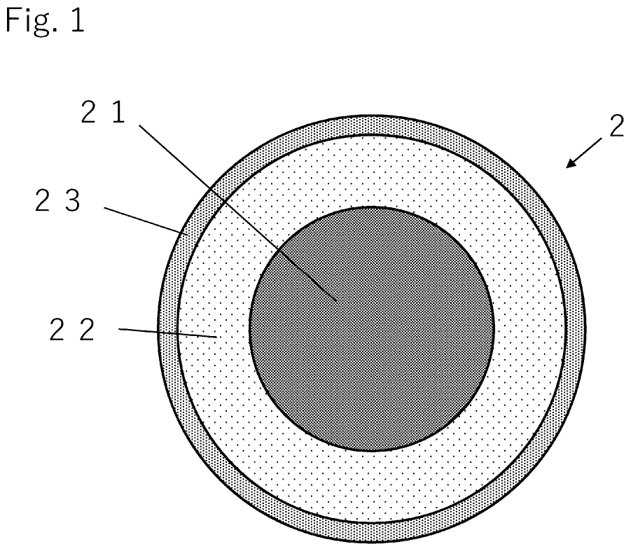

FIG. 1 is a schematic cross-sectional view of an example of a charging roller 2. The charging roller 2 may have a surface layer 23. The charging roller 2 may also have a conductive support (core bar, mandrel) 21 and a conductive base layer (elastic layer) 22 formed around the support 21. The conductive surface layer 23 may be provided on the surface (outer peripheral surface, outer surface) of the conductive elastic layer 22. The charging roller preferably includes a conductive support, a base layer provided on the support, and a surface layer provided on the base layer.

### Conductive Support

The support 21 used in the charging roller 2 is conductive and functions to support the elastic layer 22 etc. provided around the support. Examples of materials for the support 21 include metals such as iron, copper, stainless steel, aluminum, and nickel, as well as alloys thereof. The surfaces thereof may also be plated for the purpose of imparting scratch resistance. Furthermore, a mandrel provided with a conductive surface by coating the surface of a resin base material with a metal etc., or a mandrel made from a conductive resin composition can be also used as the support 21.

An adhesive layer (not shown) may also be provided between the conductive support 21 and the elastic layer 22. In this case, the adhesive is preferably conductive. To achieve conductivity, the adhesive can be selected, as appropriate, from known conductive agents (e.g., ionic conductive agents or electron conductive agents) that can be used alone or in combination of two or more types.

Examples of the adhesive include thermosetting resins and thermoplastic resins, such as urethane, acrylic, polyester, polyether, and epoxy resins. The adhesive can be exemplified by Metaloc N33 (manufactured by Toyokagaku Kenkyusho Co., Ltd.). Adhesive application methods include roll coating, sponge application, and spray application.

The adhesive layer between the conductive support 21 and the elastic layer 22 may be provided over the entire surface where the conductive support 21 and the elastic layer 22 contact, or it may be provided only in a partial area of that surface. For example, an adhesive layer can be provided only in a range of 5 mm to 20 mm wide at both ends of the surface where the conductive support 21 and the elastic layer 22 contact in the longitudinal direction (direction of the rotation axis) of the charging roller 2. When referring to a numerical range, “to” means that the range includes the preceding and following values. The thickness of the adhesive layer is preferably 1 μm to 10 μm from the viewpoint of adhesion between the support (mandrel) 21 and the elastic layer 22.

### Conductive Surface Layer

The charging roller 2 preferably has the conductive surface layer 23 on the surface of the conductive elastic layer 22 described above. FIG. 1 is a schematic cross-sectional view of the charging roller 2 provided with the surface layer 23 (showing a cross-section substantially perpendicular to the rotation axis of the charging roller 2). The provided conductive surface layer 23 improves the efficiency of charge transfer in the surface direction on the outermost surface. The conductive surface layer 23 may be formed by adding a conductive agent to the binder resin.

The volume resistivity of the conductive surface layer 23 is preferably from 1.0×10⁵ Ω·cm to 1.0×10⁹ Ω·cm.

### Binder Resin

The surface layer 23 may contain a binder resin and a conductive agent. Known binder resins can be used for the surface layer 23. Examples thereof include resins, natural rubber or vulcanized natural rubber, and synthetic rubber. Resins such as thermosetting resins and thermoplastic resins can be used. Among these, the binder resin is preferably at least one selected from the group consisting of fluororesins, polyamide resins, acrylic resins, polyurethane resins, silicone resins, and butyral resins. It is more preferable that the binder resin contain a polyurethane resin, and even more preferably is a polyurethane resin.

The surface layer 23 preferably contains a conductive substance. Examples of conductive substances that can be used include ionic conductive agents, electron conductive agents, and other conductive agents. Examples of ionic conductive agents include the following. Inorganic ionic substances such as lithium perchlorate, sodium perchlorate, and calcium perchlorate; cationic surfactants such as lauryltrimethylammonium chloride, stearyltrimethylammonium chloride, octadecyltrimethylammonium chloride, dodecyltrimethylammonium chloride, hexadecyltrimethylammonium chloride, trioctylpropylammonium bromide, and modified aliphatic dimethylethylammonium ethosulfate; amphoteric surfactants such as lauryl betaine, stearyl betaine, and dimethylalkyl lauryl betaine; quaternary ammonium salts such as tetraethylammonium perchlorate, tetrabutylammonium perchlorate, and trimethyloctadecylammonium perchlorate; and lithium salts of organic acids such as lithium trifluoromethanesulfonate. These can be used alone or in combination of two or more types.

Electron conductive agents include the following: fine particles and fibers based on metals such as aluminum, palladium, iron, copper, and silver; and metal oxides such as titanium oxide, tin oxide, and zinc oxide subjected to conductivity imparting treatment. Composite particles obtained by surface-treating the surfaces of the above metal-based fine particles, fibers, and metal oxides through electrolytic treatment, spray coating, or mixed shaking. Carbon black such as furnace black, thermal black, acetylene black, and ketjen black; carbon fibers such as PAN (polyacrylonitrile)-based carbon and pitch-based carbon. The conductive agent may contain carbon black.

Examples of furnace black are listed hereinbelow. SAF-HS, SAF, ISAF-HS, ISAF, ISAF-LS, I-ISAF-HS, HAF-HS, HAF, HAF-LS, T-HS, T-NS, MAF, FEF, GPF, SRF-HS-HM, SRF-LM, ECF, and FEF-HS. Examples of thermal black include FT and MT. These conductive agents can be used alone or in combination of two or more types.

Furthermore, the conductive agent preferably has an average particle diameter of 0.01 μm to 0.9 μm, and even more preferably 0.01 μm to 0.5 μm. This range makes it easier to control the volume resistivity of the matrix. An appropriate range of the amount of conductive agent added to the surface layer 23 is 2 parts by mass to 80 parts by mass, preferably 20 parts by mass to 60 parts by mass, per 100 parts by mass of binder resin.

The surface of the conductive agent may be subjected to surface treatment. Examples of surface treatment agents that can be used include organosilicon compounds such as alkoxysilanes, fluoroalkylsilanes, and polysiloxanes; various silane-, titanate-, aluminate-, and zirconate-based coupling agents; and oligomers or polymer compounds. One type or two or more types of these may be used. Preferred are organosilicon compounds such as alkoxysilanes and polysiloxanes, and various silane-, titanate-, aluminate-, and zirconate-based coupling agents, with organosilicon compounds being even more preferred.

The surface layer 23 may be subjected to a surface treatment. Examples of surface treatments include surface processing using UV or electron beams, and surface modification treatments that involve at least one of adhering and impregnating a compound or the like onto the surface. The thickness of the surface layer 23 is, for example, 2 μm to 25 μm, and preferably 2 μm to 20 μm.

A thickness of 2 μm or more allows large particles to be supported and prevented from falling off when forming the first protrusions with resin particles. Furthermore, a thickness of 20 μm or less allows the resin particles to form the protrusions without being buried when forming the first protrusions with resin particles. A more preferred thickness range for the surface layer 23 is 4 μm to 15 μm.

The average thickness of the surface layer in areas where the first resin particles and second resin particles are not present is preferably 4 μm to 15 μm, and more preferably 4 μm to 12 μm.

The thickness of the surface layer can be measured by cutting out a cross section of the roller with a sharp blade and observing it under an optical microscope or electron microscope.

Surface Layer Protrusions Originating from Electron Conductive Agent

In order to inject charge into contaminants, it is preferable that protrusions originating from exposed portions of the electron conductive agent (conductive particles) be present on the surface of the surface layer. The surface layer preferably has protrusions formed by the exposure of the electron conductive agent on the surface of the surface layer. The size of the protrusions originating from exposed portions of the conductive particles is preferably from 5.0 nm to 100.0 nm. This range prevents excessive charge injection into the photosensitive member.

The size of the protrusions refers to the average value of particle diameter (number-average particle diameter) of the conductive particles on the portion exposed from the binder resin. To measure the size of the protrusions, an SEM is used to capture an image of a 2 μm square area, and the number of conductive points is calculated from the binarized image. The particle diameters of 20 particles randomly selected from the resulting image are measured to determine the arithmetic mean particle diameter.

Furthermore, controlling the number of protrusions is effective for utilizing the protrusions originating from the conductive fine particles and injecting charge into contaminants.

The number of protrusions originating from exposed portions of the conductive fine particles is preferably 50 to 500 in an area 2.0 μm long and 2.0 μm wide (4.0 μm² area) as determined by observing the surface of the surface layer with a scanning electron microscope. The number of 50 or more ensures a sufficient number of protrusions that can serve as starting points for injecting charge into contaminants. Furthermore, keeping the number of protrusions to 500 or less suppresses the injection of charge into the photosensitive member.

The surface layer preferably contains carbon black, and the carbon black is preferably exposed on the surface of the surface layer. Furthermore, it is preferable that protrusions formed by exposed carbon black be present on the surface layer.

Next, a method for exposing conductive fine particles on the surface of the surface layer will be explained. When a surface layer is formed on a base layer (conductive elastic layer) of a conductive member by a dip coating method, a skin layer is usually formed on the outermost surface of the surface layer. Therefore, removing the outermost skin layer is effective in exposing the conductive particles on the surface of the surface layer and creating protrusions on the surface of the surface layer through these exposed portions.

For example, ultraviolet treatment, polishing, electrolytic polishing, chemical polishing, ion milling, etc. can be used to remove the surface skin layer formed by the binder resin and expose the conductive particles on the surface of the surface layer. Where the surface layer has a low hardness, ultraviolet treatment can also be used to sufficiently remove the skin layer and expose the conductive particles on the surface of the surface layer. Compared to polishing methods or the like, UV treatment is preferable because it can minimize damage to the surface layer while exposing the conductive particles on the surface of the surface layer.

The exposed state of the conductive particles can be confirmed using an electron force microscope (AFM). A height image is acquired using the AFM tapping mode. In this case, the portions originating from the exposed portions of the conductive particles are confirmed as protrusions. When a height image is acquired in a state in which a skin layer after dip coating is present, these protrusions are not confirmed. Furthermore, a phase image is acquired using the AFM tapping mode. In this case, the phase shift of the conductive particles is small, and due to the difference in hardness between the binder resin and the conductive particles, an image with a very large contrast between light and dark is obtained. When a phase image is acquired in a state in which a skin layer after dip coating is present, the phase difference is very small, resulting in an image with low contrast difference.

### Formation of Plurality of Protrusions on Charging Roller Surface

The surface of a charging roller has a plurality of protrusions that form, for example, a group of first protrusions and a group of second protrusions. For example, the surface layer may have a plurality of protrusions. The protrusions on the surface layer can be formed by adding coarse particles to the surface layer, adding coarse particles to the base layer, polishing the base layer, laser processing, etc.

Examples of coarse particles that form protrusions include the following. Resin particles such as (meth)acrylic resin, polyurethane resin, styrene resin, fluororesin, and silicone resin; and inorganic insulating particles such as titanium oxide, silica, alumina, magnesium oxide, strontium titanate, barium titanate, barium sulfate, calcium carbonate, mica, zeolite, and bentonite. One type or a combination of two or more types of these particles may be used.

The coarse particles are preferably resin particles. The group of first protrusions and the group of second protrusions are preferably formed by including first resin particles corresponding to the group of first protrusions and second resin particles corresponding to the group of second protrusions in the surface layer.

The first resin particles correspond, for example, to the protrusions included in the group of first protrusions and have a particle size corresponding to the protrusions. The group of first protrusions can be formed in the surface layer by adding the first resin particles to the binder resin. In other words, it is preferable that the protrusions included in the group of first protrusions be derived from the first resin particles. The material and average particle diameter of the particles may be selected so that the desired values of Spd1 and HU1 are achieved. The first resin particles preferably contain at least one selected from the group consisting of a (meth)acrylic resin and a polyurethane resin, and more preferably contain a polyurethane resin.

The second resin particles correspond, for example, to the protrusions included in the group of second protrusions and have a particle size corresponding to those protrusions. The group of second protrusions can be formed in the surface layer by adding the second resin particles to the binder resin. That is, it is preferable that the protrusions included in the group of second protrusions be protrusions derived from the second resin particles. The material and average particle diameter of the particles may be selected so that the desired values of Spd2 and HU2 are achieved. The second resin particles preferably contain a polyurethane resin.

The volume-average particle diameter Dv1 of the first resin particles is preferably 15 μm to 30 μm, and more preferably 18 μm to 30 μm.

The volume-average particle diameter Dv2 of the second resin particles is preferably 3 μm to 10 μm, and more preferably 4 μm to 9 μm.

By having the volume-average particle diameter within the above range, it is easier to form groups of first and second protrusions with the desired height, and it is easier to suppress halftone dots.

### Group of First Protrusions

The height of the group of first protrusions is 10 μm to 40 μm. A height of 10 μm or greater allows for the creation of a gap between the photosensitive member and the charging roller, preventing contaminants remaining on the photosensitive member from adhering to the charging roller surface. Furthermore, a height of 40 μm or less suppressed the occurrence of electric discharges greater than one dot, ensuring uniform charging of the photosensitive member surface.

The number Spd1 of vertices of the protrusions included in the group of first protrusions is 10/mm² to 300/mm². Having Spd1 of 10/mm² or greater disperses the load applied to the protrusions when they come into contact with and press against the photosensitive member, preventing recesses in the protrusions and making it easier to create a gap between the photosensitive member and the charging roller. Furthermore, the number of 300/mm² or less reduces the number of contact points with the photosensitive member, thereby reducing the total amount of contaminants adhering to the charging roller. Spd1 is preferably 30/mm² to 210/mm², and more preferably 30/mm² to 60/mm².

Spd1 can be adjusted by the number-average particle diameter and blended amount of resin particles that can form the group of first protrusions. Adding a large amount of resin particles with a particle size that can form the group of first protrusions tends to increase Spd1.

There are no particular limitations on the method for forming the group of first protrusions, but one method for forming the protrusions is to add resin particles to the surface layer. It is preferable to use resin particles containing a polyurethane as the resin particles to be added.

The average height of the protrusions in the group of first protrusions can be adjusted by the number-average particle diameter of the coarse particles to be added, such as resin particles. The average height of the protrusions of the group of first protrusions is, for example, 10.0 μm to 40.0 μm, preferably 12.0 μm to 30.0 μm, and more preferably 13.0 μm to 20.0 μm. By setting the average height of the protrusions to 10.0 μm or more, the group of first protrusions is formed well, a gap can be formed between the photosensitive drum and the charging roller, and adhesion of contaminants to the charging roller can be more easily suppressed. This makes it easier to suppress halftone dots. Furthermore, by setting the average height of the protrusions to 40.0 μm or less, the occurrence of electric discharges larger than one dot can be suppressed, enabling high-quality image formation.

The universal hardness HU1 of the protrusions included in the group of first protrusions can be adjusted, for example, by the elastic modulus E′1 of the resin particles forming the group of first protrusions.

The elastic modulus E′1 of the first resin particles forming the group of first protrusions is preferably 100 MPa to 2000 MPa, more preferably 500 MPa to 1500 MPa, and even more preferably 800 MPa to 1200 MPa. Setting E′1 to 100 MPa or greater suppresses deformation of the resin particles when pressed by contact with the photosensitive member, making it easier to form a gap between the photosensitive member and the charging roller. Furthermore, setting E′1 to 2000 MPa or less further suppresses adhesion of contaminants to the contact points of the charging roller with the photosensitive member, i.e., the vertices of the first protrusions. Therefore, halftone dots are further suppressed.

The number of vertices of protrusions having a height exceeding 40.0 μm per unit area on the surface of the charging roller is preferably 0/mm² to 3.0/mm², more preferably 0/mm² to 1.5/mm². Within the above ranges, vertical streaks are more easily suppressed. The number of vertices can be controlled, for example, by the particle diameter of the resin particles added to the surface layer.

### Group of Second Protrusions

The height of the group of second protrusions is preferably 0.2 μm to 5.0 am. Setting this height to 0.2 μm or greater reduces the contact surface area with contaminants and decreases adhesion, thereby making it possible to suppress adhesion of contaminants and further suppress halftone dots. Furthermore, setting the height to 5.0 μm or less makes it possible to avoid contact of the second protrusions with the photosensitive member and to inhibit adhesion of contaminants to the vertices. This further facilitates the suppression of halftone dots.

As mentioned above, the number Spd2 of vertices of the protrusions included in the second group of protrusions is preferably 4000/mm² to 40,000/mm².

As with Spd1, Spd2 can be adjusted by the number-average particle diameter and blending amount of the resin particles to be added. By adjusting Spd2 to 40,000/mm² or less, the amount of interface between the binder resin and resin particles can be reduced, making it easier to prevent breakage of the surface layer.

There are no particular limitations on the method for forming the group of second protrusions. One method for forming the protrusions is to add resin particles to the surface layer. For example, resin particles that can achieve HU2 and also resin particles that have a particle diameter that will result in the group of second protrusions can be added in an amount that satisfies Spd2.

The average height of the protrusions of the group of second protrusions is, for example, 0.1 μm to 7.0 μm, preferably 1.0 μm to 5.0 μm, and more preferably 1.5 μm to 3.0 μm. The average height of the protrusions of the group of second protrusions can be adjusted by the number-average particle diameter of the coarse particles to be added, such as resin particles.

The universal hardness HU2 of the protrusions included in the group of second protrusions can be adjusted, for example, by the modulus of elasticity E′2 of the resin particles forming the group of second protrusions. The modulus of elasticity E′2 of the second resin particles forming the group of second protrusions is, for example, 2 MPa to 50 MPa, preferably 10 MPa to 50 MPa, more preferably 20 MPa to 40 MPa, and even more preferably 25 MPa to 35 MPa.

### Method for Measuring Height of Protrusions

The height of protrusions can be measured by scanning the surface of the charging roller. Specific examples include laser microscopes, confocal microscopes, and white light confocal microscopes. After obtaining a surface profile of the charging roller using these instruments, the height of the protrusions can be measured using the analysis software provided with the instrument. Specific methods are described below.

Method for Measuring Spd1, Spd2, and Ratio of First Protrusions and Second Protrusions

Spd1 and Spd2 can be measured in the following manner. Spd represents the number of peaks per unit area. A larger value indicates a greater number of contact points with other objects. (ISO 25178)

A method by which the surface of the charging member can be scanned and Spd1 and Spd2 can be calculated may be used as a measurement means. Specific examples include laser microscopes, confocal microscopes, and white light confocal microscopes. After obtaining a surface profile of the charging member using these instruments, the density Spda of vertices of protrusions having a height of 0.2 μm or greater, the density Spd1 of vertices of first protrusions, and the density Spd2 of vertices of second protrusions can be measured using the analysis software provided with the instrument. Furthermore, the ratio (%) of first protrusions and second protrusions can be calculated from the measured Spda, Spd1, and Spd2 values using the following formula. Specific methods are described below.

$$( Spd 1 + Spd 2 ) / Sdpa \times 100 \qquad ( 1 )$$

### Method for Measuring Universal Hardness

Universal hardness can be measured using a means capable of measuring the surface of the charging member with an indenter. Specific methods are described below.

### Other Additives

The surface layer may contain other additives as needed, provided that the effects of the present disclosure are not impaired. Additives include chain extenders, crosslinking agents, pigments, silicone additives, and catalysts such as amines and tin complexes. Adding a silicone additive to the surface layer is particularly preferred because it increases the electric resistance of the surface layer, provides slipperiness to the surface layer, suppresses charge injection into the photosensitive member, and improves the abrasion resistance of the surface layer.

### Methods for Forming Surface Layer

The surface layer 23 can be formed by coating methods such as electrostatic spray coating and dipping. Alternatively, the surface layer 23 can be formed by adhering or covering a sheet- or tube-shaped layer that has been pre-formed to a predetermined thickness. Alternatively, the surface layer 23 can be formed by curing and molding a material into a predetermined shape in a mold. Among these methods, it is preferable to form a coating film by coating a coating material by a coating method.

When forming the layer by a coating method, the solvent to be used in the coating liquid can be any solvent capable of dissolving the binder resin. Specific examples include alcohols such as methanol, ethanol, and isopropanol; ketones such as acetone, methyl ethyl ketone, and cyclohexanone; amides such as N,N-dimethylformamide and N,N-dimethylacetamide; sulfoxides such as dimethyl sulfoxide; ethers such as tetrahydrofuran, dioxane, and ethylene glycol monomethyl ether; esters such as methyl acetate and ethyl acetate; and aromatic compounds such as xylene, ligroin, chlorobenzene, and dichlorobenzene. These solvents are selected, as appropriate, according to the binder resin to be used. Methods for dispersing the binder resin, particles, etc. in the coating liquid can use known solution dispersion means such as a ball mill, sand mill, paint shaker, dyno mill, and pearl mill.

The surface layer preferably contains a binder resin. The binder resin preferably contains a polyurethane resin. When forming the surface layer by a coating method, it is preferable to use a surface layer coating liquid containing a urethane raw material.

A polyurethane resin can be obtained from a urethane raw material containing a polyol and an isocyanate, and optionally a chain extender. Examples of polyols to be used as raw materials for polyurethane resins include polyether polyols, polyester polyols, polycarbonate polyols, polyolefin polyols, acrylic polyols, amine-based polyols, and mixtures thereof. Of the above, polyether polyols, polycarbonate polyols, and amine-based polyols are preferred.

Examples of isocyanates to be used as raw materials for urethane resins include the following. Tolylene diisocyanate (TDI), diphenylmethane diisocyanate (MDI), naphthalene diisocyanate (NDI), tolidine diisocyanate (TODI), hexamethylene diisocyanate (HDI), isophorone diisocyanate (IPDI), phenylene diisocyanate (PPDI), xylylene diisocyanate (XDI), tetramethylxylylene diisocyanate (TMXDI), cyclohexane diisocyanate, polymeric MDI, and mixtures thereof.

Among the above, polymeric MDI is preferred. Polymeric MDI is a mixture of monomeric MDI and a high-molecular-weight polyisocyanate, and is represented by the following formula (A). Preferably, n in formula (A) is from 0 to 4. Commercially available polymeric MDI may be used, including the Millionate MR series (manufactured by Tosoh Corporation) such as Millionate MR200 (product name).

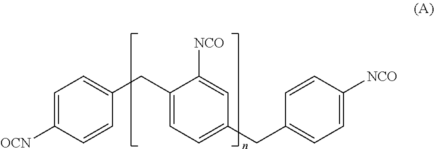

In addition, prepolymer-type isocyanate compounds that have an isocyanate group at the end and are obtained by pre-reacting the above-mentioned various isocyanate compounds with various polyols in a state with an excess of isocyanate groups can be used as the isocyanate.

Examples include isocyanate group-terminated isocyanate prepolymers using polymeric MDI and polyether polyols, and isocyanate group-terminated isocyanate prepolymers using polymeric MDI and polycarbonate polyols.

The urethane resin may contain a chain extender. Examples of chain extenders include difunctional low-molecular-weight diols such as ethylene glycol, 1,4-butanediol, and 3-methylpentanediol, trifunctional low-molecular-weight triols such as trimethylolpropane, and mixtures thereof.

In addition, monools such as polyether monools may be used as the urethane raw material.

Polyurethane resins can be obtained by reacting polyols with isocyanates through heating.

In forming the surface layer, the surface layer coating liquid preferably contains urethane raw materials, a conductive agent such as carbon black, and also first resin particles and second resin particles. This surface layer coating liquid facilitates the formation of the group of first protrusions and the group of second protrusions.

### Base Layer

The charging roller may have a base layer on a conductive support. There are no limitations on the configuration of the base layer (elastic layer) 22, and any material that can be used as an elastic layer in electrophotographic members may be used. The conductive elastic layer 22 can be made of one or two or more types of elastomers, such as rubber that have been used in the elastic layer (conductive elastomer layer) of charging rollers. Examples of rubber are listed hereinbelow. Urethane rubber, silicone rubber, butadiene rubber, isoprene rubber, chloroprene rubber, styrene-butadiene rubber, ethylene-propylene rubber, polynorbornene rubber, styrene-butadiene-styrene rubber, acrylonitrile rubber, epichlorohydrin rubber, and alkyl ether rubber.

Furthermore, the conductivity of the elastic layer 22 can be adjusted to a predetermined value by using, as appropriate, a conductive agent. The base layer (elastic layer) 22 preferably contains rubber and a conductive agent. The electrical resistance of the elastic layer 22 can be adjusted by selecting, as appropriate, the type and amount of conductive agent to be used. The suitable range is 10² Ω·cm to 10⁸ Ω·cm, and a more suitable range is 10³ Ω·cm to 10⁶ Ω·cm.

Conductive carbon such as Ketjen Black EC, acetylene black, rubber carbon, color (ink) carbon subjected to oxidation treatment, and pyrolytic carbon can also be used as the conductive agent for the elastic layer 22. Furthermore, graphite such as natural graphite and artificial graphite can also be used as the conductive agent for the elastic layer 22. Inorganic or organic fillers and crosslinking agents may also be added to the elastic layer 22.

### Toner

The toner is described hereinbelow in greater detail.

### Titanium Oxide Fine Particles A

As mentioned above, the toner is required to contain a toner particle and titanium oxide fine particles. The titanium oxide fine particles contain titanium oxide fine particles A that satisfy all of the following conditions (i) to (ii).
(i) The number-average value of major axis is 1.0 μm to 6.0 μm.
(ii) The number-average value of aspect ratio is 5.0 or greater.

When the toner is observed using a scanning electron microscope, the proportion of toner particles that can be confirmed to have titanium oxide fine particles A on surfaces thereof is 80% by number to 99% by number.

### Compound A

The toner preferably comprises a compound A having a structure represented by Formula (1) below.

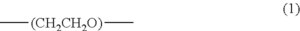

Then, the compound A is eluted in methanol when elution treatment is performed on the toner under the elution condition A. Moreover, a supernatant obtained by centrifuging the eluate obtained by eluting the compound A in methanol under the centrifugation condition A is analyzed within a range of m/z=50 to 1500 by liquid chromatograph ESI/MS. At this time, presence of a reference peak defined as follows is preferred. Also, average m/z defined as follows is preferably 300 to 1000.

Reference peak: in a mass analysis spectrum obtained by liquid chromatography ESI/MS of the supernatant, a relative abundance is determined by setting the abundance of the most intense peak at 100%. Peaks are selected in descending order of relative abundance, and the m/z value of the peak top of the selected peaks is denoted by P. Of the selected peaks that have a relative abundance of at least 10% and a peak top m/z value of P+44 or P−44, a selected peak with the highest relative abundance is designated as the reference peak.

Average m/z: The m/z value at the peak top of the reference peak defined as described above is defined as Ps, and the m/z value at the peak top=Ps+44n (n is an integer), and an average value of m/z at peak tops of peaks with a relative abundance of not less than 30% is defined as an average m/z.

As a result of including compound A in the toner, electric charges leak appropriately from strongly charged areas on the toner particle surface to weakly charged areas and the outside through the structure of compound A represented by formula (1). This makes the charge distribution on the toner particle surface more uniform, thereby reducing the number of strongly charged areas on the toner particle surface that have been excessively charged. It is believed that this makes it possible to suppress electrostatic adhesion to the charging roller and reduce contamination of the charging roller. Therefore, even in durable use for a long period of time in an ultra-low-temperature environment in a high-print-percentage printing mode in which untransferred toner is likely to be supplied to the cleaning step, toner adhesion on the charging roller can be further suppressed, and the occurrence of halftone dots can be reduced.

The present inventors consider the reason as follows. The structure represented by Formula (1) is considered to be likely to move the electric charge via the structure since alkyl groups having an electron-donating character and oxygen atoms having an electron-withdrawing character alternately continue therein. Also, the fact that it is eluted in methanol which is a highly polar solvent when the elution treatment is performed under the elution condition A means that the substance has a high polarity and is easily electrically charged.

Since the component is eluted on the side of methanol when the toner is immersed in methanol, it is considered that the component is destabilized in the toner and is in a state where it is likely to have a polarity regardless of whether it is located on the surface of the toner or inside the toner. Therefore, it is predicted that the structure represented by Formula (1) is in a state where the electric charge is likely to be taken from the strongly charged portion.

Additionally, having moderate average m/z in the liquid chromatograph ESI/MS means that ionization is likely to occur and the molecular weight is moderate with respect to the charge number. It is considered to have a characteristic that the electric charge is likely to be taken from the strongly charged portion by having the structure represented by Formula (1) due to the feature that ionization is likely to occur.

Also, it is considered that movement of the electric charge from the strongly charged portion to the weakly charged portion of the toner is likely to be promoted via mildly continuous connection that the compound A has inside the toner since the molecular weight is moderate with respect to the charge number, the electric charge is likely to move via molecular chains, and the compound A has the connection.

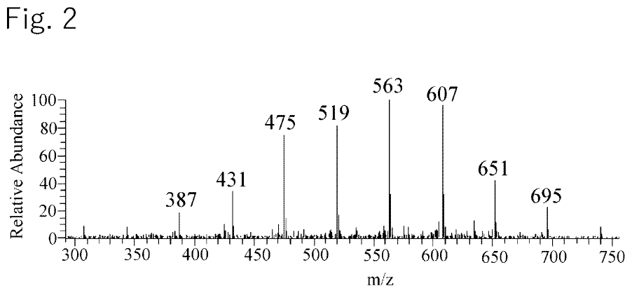

The presence of the structure represented by Formula (1) is checked by checking a peak with an m/z value of P+44 or P−44 with respect to P of the selected peaks. The fact that there are at least two or more peaks observed at equal intervals at a cycle of m/z=44 means that a plurality of compounds A in which only the number of repetitions of the structure represented by Formula (1) is different are included. Note that an example of the mass analysis spectrum of the liquid chromatograph ESI/MS is illustrated in FIG. 2.

It is considered that compounds in which the numbers of repetitions of the structure represented by Formula (1) are small are likely to act on each other and are thus likely to take electric charge from the strongly charged portion and compounds in which the numbers of repetitions are large are likely to promote movement of the electric charge. It is predicted that the effect is exhibited by the plurality of compounds A in which the numbers of repetitions of the structure represented by Formula (1) are different being included to satisfy average m/z.

To achieve this characteristic, the average m/z is preferably 300 to 1000. The average m/z is more preferably 400 to 900, even more preferably 450 to 800, and still more preferably 500 to 720.

An average m/z of 300 or greater strengthens the continuous bonds of compound A within the toner, promoting charge migration and making it easier to suppress the occurrence of strongly charged areas on the toner particle surface. Therefore, even in use in an ultra-low-temperature environment, such as in a high-print-percentage durability evaluation, where toner slippage is likely to occur in the cleaning step, contamination of the charging roller can be suppressed, and the occurrence of halftone dots can be suppressed, which is preferable.

On the other hand, having an average m/z of 1000 or less ensures appropriate charge migration and makes it possible to suppress the generation of inversely charged toner and also to suppress fogging even at the end of the lifespan when the average charge quantity tends to decrease.

Average m/z can be appropriately adjusted by changing a synthesis time, the type of aliphatic alcohol at the time of the synthesis, the number of parts of aliphatic alcohol, the number of parts of ethylene oxide, and the like.

In order to cause the toner to contain the compound A with such a feature, it is preferable to use a material that is not coupled to a binder resin of the toner and is independently present. For example, it is possible to use a surfactant having the structure of Formula (1) as follows.

Preferably, the compound A includes at least one compound selected from a group consisting of polyoxyethylene lauryl ether, polyoxyethylene hexdecyl ether, polyoxyethylene nonylphenyl ether, polyoxyethylene dodecyl ether, polyoxyethylene sorbitan monooleate ether, polyoxyethylene styrylphenyl ether, sodium polyoxyethylene (2) laurylether sulfate, sodium polyoxyethylene lurylether acetate, and the like.

Preferably, the compound A is at least one compound selected from a group consisting of an ethylene oxide adduct of linear aliphatic alcohol having 8 to 16 (preferably 10 to 14) carbon atoms and sodium polyoxyethylene laurylether acetate, and is more preferably an ethylene oxide additive of lauryl alcohol.

Examples of a way to cause the peaks with m/z values of P+44 or P−44 with respect to P of the selected peaks to be present include using a method of obtaining an ethylene oxide additive by causing condensation polymerization between an aliphatic alcohol and an ethylene oxide. In this manner, it is possible to cause the polymerization level to have distribution and to cause desired peaks to be present.

Although the addition method is not particularly limited, examples thereof include a method of adding the compound A having the structure of Formula (1) by any of the processes of producing the colorant dispersion, the release agent dispersion, the resin particle dispersion, and the like and a process of washing the toner in a case where the toner is manufactured by an emulsion aggregation method. It is preferable to add the compound A when each dispersion such as the colorant dispersion, the release agent dispersion, or the resin particle dispersion is produced. Also, it is preferable to add the compound A in the mixture solution (that is, in the dispersion process) when these aggregated particles are produced.

The toner manufacturing method is not particularly limited, and any method such as a suspension polymerization method, a dissolution suspension method, an emulsion aggregation method, or a grinding method may be used. The emulsion aggregation method in which a surfactant is typically used in the process of toner formation can be preferably used in terms of easiness in manufacturing.

The toner is preferably a negatively charged toner. Also, a supernatant obtained through treatment under the elution condition A and the centrifugation condition A is supplied to a liquid chromatograph ESI/MS analysis device and is analyzed under the analysis condition A. At this time, the compound A comprised in the supernatant is preferably detected in the ionized form as a cation.

Analysis condition A: under conditions of Sheath Gas: 10 (arb. unit), Aux Gas: 5 (arb. unit), spray voltage: 5 kV, and capillary temperature: 275° C., compounds ionized under conditions of capillary voltage: 35 V and tube lens voltage: 110 V are detected as cations, and compounds ionized under conditions of capillary voltage: −35 V and tube lens voltage: −110 V are detected as anions.

Having the property means that the compound A is likely to have positive charging performance. Therefore, since electric charge is more likely to be taken from the negatively charged strong charged portion generated in the negatively charged toner, the effect is further exhibited.

As the compound A having such a property, it is possible to use a cationic surfactant having the structure of Formula (1), a nonionic surfactant having the structure of Formula (1), or the like. As a specific illustrative example, it is possible to preferably use the compounds listed as illustrative examples of the surfactant having the structure of Formula (1) described above.

### Compound B

Also, the toner preferably comprises a compound B eluted in methanol when elution treatment is carried out on the toner under the elution condition A. Then, the supernatant obtained through the treatment on the toner under the elution condition A and the centrifugation condition A is supplied to a liquid chromatograph ESI/MS analysis device and is analyzed under the analysis condition A. At this time, the compound B comprised in the supernatant is preferably detected in the ionized form as anion.

Analysis condition A: under conditions of Sheath Gas: 10 (arb. unit), Aux Gas: 5 (arb. unit), spray voltage: 5 kV, and capillary temperature: 275° C., compounds ionized under conditions of capillary voltage: 35 V and tube lens voltage: 110 V are detected as cations, and compounds ionized under conditions of capillary voltage: −35 V and tube lens voltage: −110 V are detected as anions.

The combined use of compound B, which is likely to be negatively charged, and compound A, which is likely to be positively charged, is preferable because the charge quantity on the surface of toner particles can be stabilized at an appropriate value, even in an ultra-low-temperature environment where the toner charge quantity is likely to increase. It is presumed that the presence of both compounds allows compound A to be more uniformly dispersed on the toner surface and between toner particles due to electrical repulsion, thereby making it possible to further suppress the occurrence of strongly charged areas that have been excessively charged. As a result, the toner can be prevented from electrostatically adhering to the charging roller and contaminating the charging roller, and the occurrence of halftone dots is likely to be suppressed even in applications where toner is likely to slip through during the cleaning step, such as high-print-percentage durability evaluation in an ultra-low-temperature environment.

Also, a peak is preferably detected at m/z=325 in a case where the supernatant obtained through the treatment on the toner under the elution condition A and the centrifugation condition A is analyzed by the liquid chromatograph ESI/MS analysis device. Additionally, a peak is preferably detected at m/z=183 or m/z=197 in a case where the peak detected at m/z=325 is analyzed by a tandem mass spectrometer connected directly to the liquid chromatograph ESI/MS device under the analysis condition B.

Analysis condition B: Under conditions of Sheath gas: 10 (arb. unit.), Aux gas: 5 (arb. unit.), spray voltage: 5 kV, and capillary temperature: 275° C., the compound ionized under conditions of capillary voltage: −35 V and tube lens voltage: −110 V is detected as anion, and an ion detected at m/z=325 is selected as precursor ion, and an ion obtained by causing collision-induced dissociation with an inert gas: He at a collision energy: 35 eV is detected.

The fact that the detection of anion and the detection of the specific peak in tandem mass analysis are satisfied means that a compound having a dodecylbenzenesulfonic acid structure is contained as the compound B in the toner.

It is presumed that, as a result, compound B, which is likely to have a negative charge, is also easily ionized and has an appropriate molecular weight relative to the charge level, which allows for the appropriate exchange of charge between compounds A and B and makes it easier to maintain the desired charge quantity. This prevents the toner from electrostatically adhering to the charging roller and makes it easier to suppress the occurrence of halftone dots, even in applications where toner is likely to slip through during the cleaning step, such as high-print-percentage durability evaluation.

In order to cause the toner to contain the compound B, it is preferable to use a material that is independently present without being linked to a binder resin in the toner. For example, an anionic surfactant can be preferably used. Preferable examples of the compound B include at least one compounds selected from a group consisting of fatty soaps such as sodium stearate and sodium laurate, sodium lauryl sulfate, (linear or branched) sodium dodecylbenzene sulfonate, sodium polyoxyethylene (2) lauryl ether sulfonate, and the like. The compound B is preferably linear or branched sodium dodecylbenzene sulfonate.

Among these, a material having a dodecylbenzenesulfonic acid structure can be more preferably used in order to control a peak to be detected at m/z=183 or 197 in a case where a peak is detected at m/z=325 and analysis is performed under the analysis condition B.

Although the addition method is not particularly limited, examples thereof include a method of adding the compound described above by any of the processes of producing the colorant dispersion, the release agent dispersion, the resin particle dispersion, and the like and a process of washing the toner in a case where the toner is manufactured by an emulsion aggregation method, for example. It is preferable to add the compound B when each dispersion such as the colorant dispersion, the release agent dispersion, or the resin particle dispersion is produced. Also, it is preferable to add the compound B in the mixture solution (that is, in the dispersion process) when these aggregated particles are produced.

The toner manufacturing method is not particularly limited, and any method such as a suspension polymerization method, a dissolution suspension method, an emulsion aggregation method, or a grinding method may be used. The emulsion aggregation method in which a surfactant is typically used in the process of toner formation can be preferably used in terms of easiness in manufacturing.

The content proportion of the structure represented by Formula (1) contained in the compound A on the basis of the mass of the toner is preferably 50 to 1500 ppm by mass. The content proportion is more preferably 70 to 1200 ppm by mass and is further preferably 250 to 1060 ppm by mass.

When the content of the structure of Formula (1) is 1500 ppm by mass or less, charge leakage due to compound A is appropriate even in toners with a low charge quantity, making it easy to maintain the charge quantity. As a result, fogging can be suppressed. On the other hand, when the content is 50 ppm by mass or more, the occurrence of strongly charged areas on the surface of toner particles is likely to be suppressed. Even in use in an environment where toner particles are likely to be charged up, such as an ultra-low-temperature environment, and in high-print-percentage durability evaluation where toner slippage is likely to occur during the cleaning step, contamination of the charging roller can be prevented and halftone dots are likely to be suppressed.

The content of the structure represented by Formula (1) can be controlled by changing the amount of compound A to be added, washing strength of the toner, or the number of structures represented by Formula (1) contained in the molecules of the compound A. Examples of a method for changing the number of structures represented by Formula (1) in the molecules of the compound A include a method of changing the amount of precursor having the structures represented by Formula (1) and a polymerization condition when the compound A is produced and the like.

As a method for quantifying the structure represented by Formula (1), a method in which a peak originating from the structure of Formula (1) is specified by ¹H nuclear magnetic resonance spectrometry and quantification is performed by ¹H nuclear magnetic resonance spectrometry using an internal standard method can be used.

Also, chromatogram analyzed under the following analysis condition C is obtained in analysis under the analysis condition A of a supernatant obtained through treatment on the toner under the elution condition A and the centrifugation condition A.

Analysis condition C: When 10 μL of solution is poured into an apparatus configuration using methanol in a mobile phase and not using any stationary phase at a flow rate of 1 ml/min, a range of m/z=50 to 1500 is analyzed by setting an acquisition time to 5 min and using a UV detector as a detector, and chromatogram is acquired.

A value of ratio P/N of a peak area P of a cation containing the compound A with respect to a peak area N of anion containing the compound B is preferably 0.20 to 2.00 in the obtained chromatogram. The ratio value P/N is more preferably 0.25 to 1.20 and is further preferably 0.30 to 1.00.

Having this feature indicates that a material that is likely to be positively charged such as the compound A and a material that is likely to be negatively charged such as the compound B are contained in the toner with a moderate balance.

If the P/N ratio is equal to or greater than 0.20, developing ghost is more likely to be curbed, and this is predicted to be because excessive negative charging can be curbed by the positively charged components being moderately large in amount or by the negatively charged components being moderately small in amount.

On the other hand, if the P/N ratio is equal to or less than 2.00, fogging is more likely to be curbed, and this is predicted to be because generation of oppositely charged toner is likely to be curbed by the negatively charged components being moderately large in amount or by the positively charged components being moderately small in amount. The P/N ratio can be controlled by the amounts of the compound A and the compound B to be added.

P is preferably 300000 to 1500000 and is more preferably 500000 to 1100000, for example. N is preferably 400000 to 4000000 and is more preferably 800000 to 2000000, for example.

Hereinafter, each component configuring the toner and a method for manufacturing the toner will be described.

The toner particle contains a binder resin. The content of the binder resin is preferably equal to or greater than 50% by mass with respect to the total amount of the resin component in the toner particle.

Although the binder resin is not particularly limited, examples thereof include a styrene acrylic resin, an epoxy resin, a polyester resin, a polyurethane resin, a polyamide resin, a cellulose resin, a polyether resin, and mixed resins or composite resins thereof. The binder resin is preferably at least one selected from a group consisting of a styrene acrylic resin and a polyester resin.

Examples of the styrene acrylic resin include polymers composed of the following monofunctional polymerizable monomer or polyfunctional polymerizable monomer, copolymers obtained by combining two or more types thereof, and further mixtures thereof. The styrene acrylic resin is preferably a polymer of a monomer mixture containing styrene and at least one selected from a group consisting of an acrylic polymerizable monomer and a methacrylic polymerizable monomer. The monomer mixture may contain a (meth)acrylic acid.

Examples of the monofunctional polymerizable monomer include the following monofunctional polymerizable monomers.

Styrene; styrene derivatives such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylsyrene, p-n-decylsyrene, p-n-dodecylsyrene, p-methoxysyrene, and p-phenylsyrene; acrylic polymerizable monomers such as methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethyl phosphate ethyl acrylate, diethyl phosphate ethyl acrylate, dibutyl phosphate ethyl acrylate, and 2-benzoyloxyethyl acrylate; methacrylic polymerizable monomers such as methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, diethyl phosphate ethyl methacrylate, and dibutyl phosphate ethyl methacrylate; methylene aliphatic monocarboxylic acid ester; vinyl ester such as vinyl acetate, vinyl propionate, vinyl butyrate, vinyl benzoate, and vinyl formate; vinyl ether such as vinyl methyl ether, vinyl ethyl ether, and vinyl isobutyl ether; and vinyl ketone acrylic acids and methacrylic acids such as vinyl methyl ketone, vinyl hexyl ketone, and vinyl isopropyl ketone.

Examples of the polyfunctional polymerizable monomer include the following polyfunctional polymerizable monomers.

Diethylene glycol diacrylate, triethylene glycol diacrylate, tetraethylene glycol diacrylate, polyethylene glycol diacrylate, 1,6-hexanediol diacrylate, neopentyl glycol diacrylate, tripropyelen glycol diacrylate, polypropylene glycol diacrylate, 2,2′-bis(4-(acryloxy diethoxy)phenyl)propane, trimethylolpropane triacrylate, tetramethylolmethane tetraacrylate, ethylene glycol dimethacrylate, diethylene glycol dimethacrylate, triethylene glycol dimethacrylate, tetraethylene glycol dimethacrylate, polyethylene glycol dimethacrylate, 1,3-butylene glycol dimethacrylate, 1,6-hexanediol dimethacrylate, neopentyl glycol dimethacrylate, polypropylene glycol dimethacrylate, 2,2′-bis(4-(methacryloxy diethoxy)phenyl)propane, 2,2′-bis(4-(methacryloxy polyethoxy)phenyl)propane, trimethylolpropane trimethacrylate, tetramethylolmethane tetramethacrylate, divinylbenzene, divinylnaphthalene, divinylether, and the like.

As the polyester resin, it is possible to use a product of condensation polymerization of a carboxylic acid component and an alcohol component listed below. Examples of the carboxylic acid component include a terephthalic acid, an isophthalic acid, a phthalic acid, a fumaric acid, a maleic acid, a cyclohexanedicarboxylic acid, and a trimellitic acid. Examples of the alcohol component include bisphenol A, hydrogen-added bisphenol, an ethylene oxide adduct of bisphenol A, a propylene oxide adduct of bisphenol A, glycerin, trimethylolpropane, and pentaerythritol.

Also, the polyester resin may be a polyester resin containing a urea group. The polyester resin preferably does not cap a carboxyl group at a terminal or the like.

The toner particle may contain a colorant. As the colorant, it is possible to use a known pigment or dye. A pigment is preferably used as the colorant in terms of excellent weather resistance. Examples of a cyan colorant include copper phthalocyanine compounds and derivatives thereof, anthraquinone compounds, basic dye lake compounds, and the like. Specific examples include the following cyan colorants: C.I. Pigment Blue 1, 7, 15, 15:1, 15:2, 15:3, 15:4, 60, 62, and 66.

Examples of a magenta colorant include condensed azo compounds, diketopyrrolopyrrole compounds, anthraquinone compounds, quinacridone compounds, basic dye lake compounds, naphtol compounds, benzimidazolone compounds, thioindigo compounds, perylene compounds, and the like. Specific examples include the following magenta colorants: C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, and 254, and C.I. Pigment Violet 19.

Examples of a yellow colorant include condensed azo compounds, isoindolinone compounds, anthraquinone compounds, azo metal complexes, methine compounds, allylamide compounds, and the like. Specific examples include the following yellow colorants: C.I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, and 194.

Examples of a black colorant include carbon black and colorants with a black color adjusted by using the above yellow colorant, magenta colorant, and cyan colorant. These colorants can be used alone or as a mixture, or further, these can be used in a state of a solid solution. The colorant is preferably used in the amount of equal to or greater than 1.0 parts by mass and equal to or less than 20.0 parts by mass with respect to 100.0 parts by mass of binder resin. The toner is preferably a non-magnetic toner that does not contain a magnetic material.

The toner can be a magnetic toner by causing it to contain a magnetic material.

In this case, the magnetic material can also play a role as a colorant. Examples of the magnetic material include iron oxide, representative examples of which include magnetite, hematite, and ferrite; and metal, representative examples of which include iron, cobalt, and nickel, and alloys, mixtures, and the like of such metal with metal such as aluminum, cobalt, copper, lead, magnesium, tin, zinc, antimony, beryllium, bismuth, cadmium, calcium, manganese, selenium, titanium, tungsten, and vanadium.

The toner particle may contain a release agent. The release agent is not particularly limited, and a known wax may be used. Specific examples include the following release agents.

Petroleum wax, representative examples of which include a paraffin wax, a microcrystalline wax, and a peterolatum wax, and derivatives thereof, a montan wax and derivatives thereof, a hydrocarbon wax made by a Fischer-Tropsch process and derivatives thereof, a polyolefin wax, representative examples of which include polyethylene, and derivatives thereof, and a natural wax, representative examples of which include a carnauba wax and a candelilla wax, and derivatives thereof.

The derivatives also include oxides, block copolymers with a vinyl monomer, and graft modifications. Also, alcohols such as higher aliphatic alcohols; a fatty acid such as a stearic acid and a palmitic acid, acid amide, ester, and ketone thereof; and a hydrogenated castor oil and derivatives thereof, plant waxes, and animal waxes. These can be used alone or in combination.

Among these, polyolefin, a hydrocarbon wax made by a Fischer-Tropsch process, and a petroleum wax are preferably used since there is a trend that a developing property and a transfer property are improved. Note that an antioxidant may be added to these waxes within a range in which it does not affect the above effect.

The content of the release agent is preferably equal to or greater than 1.0 parts by mass and equal to or less than 30.0 parts by mass with respect to 100.0 parts by mass of binder resin or polymerizable monomer forming the binder resin. The melting point of the release agent is preferably equal to or greater than 30° C. and equal to or less than 120° C. and is more preferably equal to or greater than 60° C. and equal to or less than 100° C. The release effect is efficiently expressed, and a wider fixation region is secured by using the release agent exhibiting a heat property as described above.

It is necessary that the toner contain a toner particle and titanium oxide fine particles A. Titanium oxide fine particles A are preferably added externally to the toner. A known external addition device can be used for the external addition step.

When the above-mentioned titanium oxide fine particles A are externally added to the resulting toner particles, titanium oxide fine particles A may be externally added alone or in combination with other external additives such as various organic or inorganic fine particles. The adhesion rate of titanium oxide fine particles A to the toner can be controlled by adjusting, as appropriate, the amount of titanium oxide fine particles A added and the external addition conditions. Increasing the rotation speed, extending the external addition time, etc. are effective ways to further increase the adhesion rate.

Furthermore, the proportion of toner particles that can be confirmed to have titanium oxide fine particles A on surfaces thereof can be controlled by adjusting, as appropriate, the amount of titanium oxide fine particles A added and the external addition conditions.

Furthermore, organic or inorganic fine particles other than titanium oxide fine particles A can be used as external additives. Examples thereof are listed hereinbelow. Inorganic fine particles such as silica are preferred.
(1) Fluidity imparting agent: silica, alumina, titanium oxide, carbon black, and carbon fluoride.
(2) Abrasive: metal oxides (for example, strontium titanate, cerium oxide, alumina, magnesium oxide, and chromium oxide), nitrides (for example, silicon nitride), carbides (for example, silicon carbide), and metal salts (for example, calcium sulfate, barium sulfate, and calcium carbonate).
(3) Lubricant: fluorine resin powder (for example, vinylidene fluoride, polytetrafluoroethylene), and fatty acid metal salts (for example, zinc stearate and calcium stearate).
(4) Charge controlling particles: metal oxides (for example, tin oxide, titanium oxide, zinc oxide, silica, and alumina), and carbon black.

The surfaces of the organic or inorganic fine particles used as the other external additives may be subjected to hydrophobization treatment in order to improve fluidity of the toner and uniformize the charging of the toner particle. Examples of the treatment agent for the hydrophobization treatment of the organic or inorganic fine particles include an unmodified silicone varnish, various modified silicone varnish, an unmodified silicone oil, various modified silicone oil, silane compounds, a silane coupling agent, other organic silicon compounds, and organic titanium compounds. These treatment agents may be used alone or in combination.

In order to ensure durability when added to toner particles, the particle diameter of the other external additives, such as organic or inorganic fine particles, is preferably 1/10 or less of the weight-average particle diameter of the toner particles. The content of the other external additives (e.g., silica fine particles) is preferably 0.1 parts by mass to 2.0 parts by mass, and more preferably 0.3 parts by mass to 0.9 parts by mass, per 100 parts by mass of toner particles.

Although an example of a method for obtaining the toner particle will be described below, the method is not limited the following one. The manufacturing method of the toner particle is not particularly limited, and it is possible to use a suspension polymerization method, a dissolution suspension method, an emulsion aggregation method, a grinding method, and the like. A method for obtaining the toner particle by the emulsion aggregation method will be described below as an example.

### Method for Manufacturing Toner by Emulsion Aggregation Method

### Process for Preparing Resin Fine Particle Dispersion

Although a resin fine particle dispersion containing a binding resin can be prepared by known methods, the present invention is not limited to these methods. Examples thereof include an emulsion polymerization method, a self-emulsification method, a phase-transfer emulsification method of emulsifying a resin by adding a water-based medium to a resin solution dissolved in an organic solvent, and a forced emulsification method of forcibly emulsifying a resin by performing high-temperature treatment inside a water-based medium without using an organic solvent.

A method of preparing the resin fine particle dispersion by the phase-transfer emulsification method will be described below as an example. Resin components containing a binder resin are dissolved in an organic solvent which allows them to be dissolved therein, and a surfactant and a basic compound are added thereto. At this time, it is only necessary to dissolve the resin components by heating them to a temperature that is equal to or greater than a melting point when the resin components form a crystalline resin having the melting point. Subsequently, a water based medium is slowly added thereto while stirring is performed by using a homogenizer or the like to precipitate the resin fine particles. Thereafter, the solvent is removed by heating them or reducing the pressure, thereby producing a water-based dispersion of the resin fine particles.

Here, any organic solvent may be used to dissolve the resin components containing the binder resin as long as the organic solvent can dissolve them. Specific examples include toluene, xylene, and the like.

As the surfactant to be used in the preparation process, a surfactant containing at least one compound selected from a group consisting of the compound A and the compound B is preferably used. More preferably, a surfactant containing the compound A and the compound B is used.

It is possible to use another surfactant together within a range in which the above effect is not damaged, and examples thereof include anionic surfactants such as a sulfuric ester salt-based surfactant, a sulfonate-based surfactant, a carboxylate-based surfactant, a phosphoric acid ester, and a soap-based surfactant; cationic surfactants such as an amine salt-type surfactant and a quaternary ammonium salt-type surfactant; and non-ionic surfactants such as a polyethylene glycol-based surfactant, an alkylphenol ethylene oxide adduct-based surfactant, and a polyhydric alcohol-based surfactant, and the like.

Examples of the basic compound used in the preparation process include inorganic base such as sodium hydroxide and potassium hydroxide; and organic base such as ammonia, triethylamine, trimethylamine, dimethylaminoethanol, and diethylaminoethanol. One kind of basic compound may be used alone, or two or more kinds thereof may be used together.

### Preparation of Colorant Dispersion

For preparation of the colorant dispersion, a known dispersion method can be used, it is possible to use a general dispersion mechanism such as a homogenizer, a ball mill, a colloid mill, and an ultrasonic dispersing machine, for example, and the method is not limited at all. Also, examples of the surfactant used in the dispersion include the surfactants as described above, and it is possible to preferably use a surfactant containing at least one compound selected from the group consisting of the compound A and the compound B.

### Preparation of Release Agent Dispersion

For preparation of the release agent dispersion, a release agent is dispersed in water along with the surfactant, the basic compound, and the like, the mixture is then heated to a temperature that is equal to or greater than the melting point of the release agent, and dispersion treatment is performed by using a homogenizer or a dispersing machine to which a strong shear force is applied. A release agent dispersion is obtained through such treatment. Examples of the surfactant used in the dispersion include the surfactants described above, and it is possible to preferably use a surfactant containing at least one compound selected from the group consisting of the compound A and the compound B. Also, examples of the basic compound used in the dispersion include the basic compounds described above.

### Aggregated Particle Formation Process

In an aggregated particle formation process, the resin fine particle dispersion, the colorant dispersion, the release agent dispersion, and the like are mixed first, thereby obtaining a mixture solution (dispersion process). Then, the mixture solution is aggregated by adjusting pH to acid while the mixture is heated at a temperature that is equal to or less than the melting point of the resin fine particles, and aggregated particles containing the resin fine particles, the colorant particles, and the release agent particles are thus formed, thereby obtaining an aggregated particle dispersion.

### First Fusion Process

In a first fusion process, progress of the aggregation is stopped by raising pH of the aggregated particle dispersion under a stirring condition in accordance with the aggregated particle formation process, and heating is performed at a temperature that is equal to or greater than the melting point of the resin components, thereby obtaining a fusion particle dispersion.

### Filtration Process, Washing Process, Drying Process, Classification Process, and External Addition Process

Thereafter, a filtration process for filtering out the sold content of the toner particle, and if needed, a washing process, a drying process, and a classification process for adjusting granularity are performed, thereby obtaining a toner particle. The toner particle may be used as a toner as it is. It is also possible to mix the toner particle and an external additive such as inorganic fine particles by using a mixer, to cause them adhere to each other, and thereby to obtain a toner.

### Image Forming Apparatus

The image forming apparatus has the following features.

The image forming apparatus includes a photosensitive drum, a charging roller for charging the surface of the photosensitive drum, an exposure means for exposing the charged photosensitive drum to light and forming an electrostatic latent image on the photosensitive drum, a development means that has toner and uses the toner to develop the electrostatic latent image formed on the surface of the photosensitive drum to form a toner image, a transfer means for transferring the toner image to a transfer material with or without an intermediate transfer member, and a fixing means for fixing the toner image on the transfer material.

The toner and charging roller described above can be adopted in this image forming apparatus.

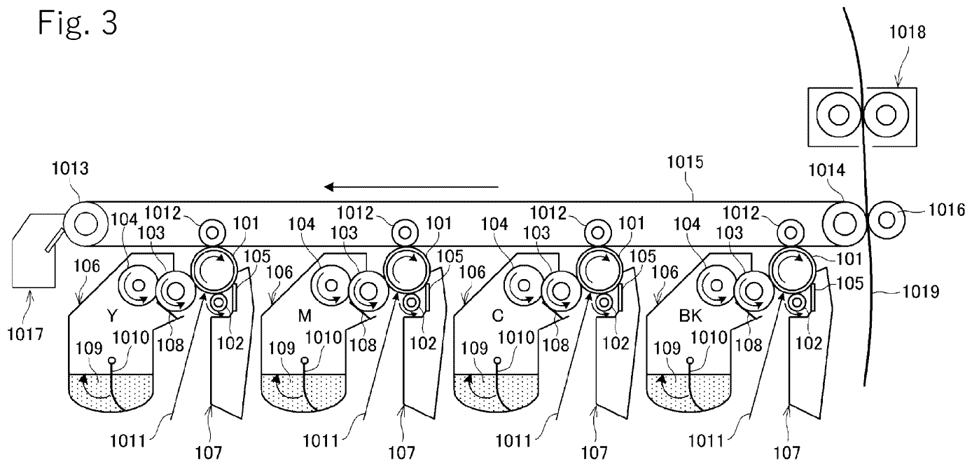

FIG. 3 is a schematic diagram of an image forming apparatus equipped with a charging roller. This image forming apparatus is a color image forming apparatus with four detachably mounted process cartridges. Each process cartridge uses toner of one of the colors: black, magenta, yellow, and cyan.

A photosensitive drum 101 rotates in the direction of the arrow and is uniformly charged by a charging roller 102, to which a voltage is applied from a charging bias power supply. An electrostatic latent image is formed on the photosensitive drum surface by exposure light 1011. Meanwhile, toner 109 stored in a toner container 106 is supplied to a toner supply roller 104 by an agitating blade 1010 and transported onto the developing roller 103.

Then, a developing blade 108, which is arranged to be in contact with the developing roller 103, uniformly coats the surface of the developing roller 103 with toner 109, and imparts an electric charge to the toner 109 through triboelectric charging. The electrostatic latent image is developed by the supply of toner 109 transported by the developing roller 103, which is arranged to be in contact with the photosensitive drum 101, and is visualized as a toner image.

The visualized toner image on the photosensitive drum is transferred to an intermediate transfer belt 1015, which is supported and driven by a tension roller 1013 and an intermediate transfer belt drive roller 1014, by a primary transfer roller 1012 to which voltage is applied from the primary transfer bias power supply. The toner images of each color are sequentially superimposed to form a color image on the intermediate transfer belt.

A transfer material 1019 is fed into the device by a paper feed roller and transported between the intermediate transfer belt 1015 and a secondary transfer roller 1016. A voltage is applied to the secondary transfer roller 1016 from a secondary transfer bias power supply, and the color image on the intermediate transfer belt 1015 is transferred to the transfer material 1019. The transfer material 1019 with the transferred color image is subjected to fixing treatment by a fixing unit 1018 and then discarded outside the device, completing the printing operation.

Meanwhile, any untransferred toner remaining on the photosensitive drum is scraped off by a cleaning blade 105 and stored in a waste toner container 107. The above-mentioned step is then repeated for the cleaned photosensitive drum 101. Any untransferred toner remaining on the primary transfer belt is also scraped off by the cleaning device 1017.

### Image Forming Method

The present disclosure also provides the following image forming method.

The image forming method includes: a charging step for charging the surface of a photosensitive drum using a charging roller; an exposure step for exposing the charged photosensitive drum to light to form an electrostatic latent image on the photosensitive drum; a development step for developing the electrostatic latent image formed on the surface of the photosensitive drum using toner to form a toner image; a transfer step for transferring the toner image to a transfer material with or without an intermediate transfer member; and a fixing step for fixing the toner image on the transfer material. The above-mentioned charging roller and toner are used in this image forming method.

The image forming method preferably includes a cleaning step for cleaning the surface of the photosensitive drum with a cleaning blade brought into contact with the surface of the photosensitive drum. The contact line pressure of the cleaning blade against the photosensitive drum is, for example, 2 N/m to 300 N/m, preferably 3 N/m to 300 N/m, and more preferably 3 N/m to 100 N/m.

### Process Cartridge

The process cartridge has the following features.

The process cartridge is detachably mountable on the main body of an image forming apparatus. The process cartridge has a photosensitive drum, a charging roller for charging the surface of the photosensitive drum, and toner, and also has a developing means for developing an electrostatic latent image formed on the surface of the photosensitive drum using the toner to form a toner image.

The toner and charging roller described above can be adopted in this process cartridge.

The process cartridge may also have a frame for supporting the charging roller and developing means.

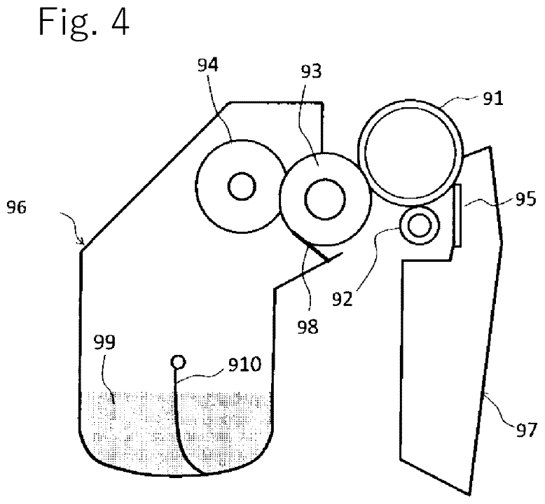

FIG. 4 is a schematic cross-sectional view of a process cartridge for an image forming apparatus equipped with a charging roller. This process cartridge integrates the developing means and charging roller and is configured to be detachably mountable on the main body of the image forming apparatus.

The developing means includes at least a developing roller 93 and contains toner 99. In the developing means, a toner supply roller 94, a toner container 96, a developing blade 98, and an agitating blade 910 may be integrated, as necessary.

The process cartridge is required to include at least a charging roller 92. The process cartridge may also include a cleaning blade 95 and a waste toner container 97. As long as the charging roller is positioned so as to be able to contact the photosensitive drum, a photosensitive drum 91 may be integrated with a charging device as a component of the process cartridge, or may be fixed to the main body as a component of the electrophotographic apparatus.

It is preferable that the process cartridge have a cleaning means including a cleaning blade that is brought into contact with the surface of the photosensitive drum to clean the surface of the photosensitive drum.

The contact line pressure of the cleaning blade against the photosensitive drum is, for example, 2 N/m to 300 N/m, preferably 3 N/m to 300 N/m, and more preferably 3 N/m to 100 N/m.

A respective voltage is applied to each of the charging roller 92, developing roller 93, toner supply roller 94, and developing blade 98.

### EXAMPLES

The present disclosure is described below based on Examples but is not limited to these. Note that “parts” and “%” in the following formulations are all by mass unless otherwise specified.

Methods for manufacturing the charging roller and toner, as well as methods for measuring each physical property, are described below.

### Methods for Measuring Charging Roller

### Method for Measuring Height of Protrusions on Surface of Charging Roller

The height of the protrusions on the surface of the charging roller can be measured by scanning the outer surface of the surface layer of the charging roller with a laser microscope (product name: VK-X150, manufactured by Keyence Corporation). The charging roller was positioned so that the circumferential vertex of the surface of the charging roller was directly below the lens of the laser microscope, and the axial direction of the charging roller was aligned with the longitudinal direction of the laser microscope observation field. The shape of the outer surface of the surface layer was then measured under the following conditions:
Mode: Shape Measurement Expert
Measurement Lens: 20×
Z-Axis Upper and Lower Limits: Range where reflected light is no longer visible in the laser field of view
Laser Brightness: Automatic
Measurement Mode: Surface Shape
Measurement Size: High Resolution (2048 pixels×1536 pixels)
Measurement Quality: High Precision
Pitch: 0.2 μm

The measurement results were then imported into the multi-file analysis application, which is the software provided with the laser microscope, and the imported image was corrected in the following order:
Surface Shape Correction:
   Correction Method: Quadratic Surface Correction, Designation Method: Area Designation
   Height Cut Level:
Cut Level: Strong
   Smoothing:
   Size: 7×7, Type: Simple Average

### Measurement of Height of Protrusions of Group of First Protrusions

First, protrusions with a height of 10.0 μm or more and protrusions with a height exceeding 40.0 μm were identified under the following conditions. Based on these identification results, protrusions with a height of from 10.0 μm to 40.0 μm were identified.
Measurement Mode: “Volume and Surface Area Measurement”
Height Threshold Setting: Values 10.0 μm above a reference and 40.0 μm above the reference, the reference being the most frequent value of the height profile
Ignore Microregions: ON (Lower Limit: 100 pixels)

Next, the heights of the identified protrusions with a height of from 10.0 μm to 40.0 μm were calculated from the profile measurement.

The above measurements were performed at nine locations: (3 evenly spaced in the axial direction of the charging roller)×(3 evenly spaced circumferentially) (three locations, one in the center in the axial direction of the charging roller and two at a distance of L/4 from both ends of the charging roller toward the center, where L is the axial length of the charging roller; and three locations in the circumferential direction (phases 0°, 120°, and 240°) for each of the aforementioned locations, for a total of nine locations). Protrusions with a height of from 10.0 μm to 40.0 μm were determined to be protrusions belonging to the group of first protrusions. The arithmetic mean value of the heights was then used as the average height of the protrusions in the group of first protrusions of the charging roller.

Method for Measuring the Number of Vertices of Protrusions with Height Exceeding 40.0 μm Per Unit Area

The number of vertices of protrusions having a height exceeding 40.0 μm per unit area was measured according to the method for measuring Spd1 described hereinbelow. Specifically, the most frequent value in the height profile was taken as a reference, and the height threshold was set to a value 40.0 μm above the reference.

### Measurement of Height of Protrusions of Group of Second Protrusions

First, protrusions having a height of from 0.2 μm to 5.0 μm were identified under the following conditions. The measurement method for the height of protrusions on the surface of the charging roller uses an axial pitch of 0.2 μm, so protrusions having a height of 0.2 μm to 5.0 μm were considered as objects for calculation. Therefore, protrusions having a height of less than 0.2 μm were not identified as protrusions.
Measurement Mode: “Volume and Surface Area Measurement”
Height Threshold Setting: Values 5.0 μm above a reference, the reference being the most frequent value of the height profile
Ignore Microregions: ON (Lower Limit: 100 pixels)

Next, the heights of the particles other than the particles of the protrusions having a height of higher than 5.0 μm that were identified in the image, in other words, the heights of all particles with a height of 5.0 μm or less, were calculated from the profile measurement.

The above measurements were performed at nine locations: (3 evenly spaced in the axial direction of the charging roller)×(3 evenly spaced circumferentially) (three locations, one in the center in the axial direction of the charging roller and two at a distance of L/4 from both ends of the charging roller toward the center, where L is the axial length of the charging roller; and three locations in the circumferential direction (phases 0°, 120°, and 240°) for each of the aforementioned locations, for a total of nine locations). Protrusions having a height of from 0.2 μm to 5.0 μm were determined to be protrusions belonging to the group of second protrusions. The arithmetic mean value of the heights was then used as the average height of the protrusions in the group of second protrusions of the charging roller.

### Method for Measuring the Vertex Density Spd1 of Group of First Protrusions

Spd1 can be determined by surface observation under a microscope in the same manner as the height of the protrusions. First, the shape of the outer surface of the charging roller was measured in the same manner as for the height of the protrusions. Next, the measurement results were imported into the multi-file analysis application, which is the software provided with the laser microscope. The imported image was corrected in the same way as the height of the protrusions described above.

Next, the number of protrusions having a height of 10.0 μm or larger and the number of protrusions having a height exceeding 40.0 μm were calculated using the following method, and the value obtained by dividing the difference therebetween by the measured surface area was calculated as Spd1.
Measurement Mode: “Volume and Surface Area Measurement”
Height Threshold Setting: Values 10.0 μm above a reference and values 40.0 μm above the reference, the reference being the most frequent value of the height profile
Ignore Microregions: ON (Lower Limit: 100 pixels)

The above measurements were performed at a total of nine locations (same as the nine locations described above): (3 locations evenly spaced in the axial direction of the charging roller)×(3 locations evenly spaced circumferentially). The arithmetic mean value thereof was used.

### Method for Measuring Vertex Density Spd2 of Group of Second Protrusions

Spd2 can be determined by surface observation under a microscope in the same manner as the height of the protrusions. First, the shape of the outer surface of the charging roller was measured in the same manner as for the height of the protrusions. Next, the measurement results were imported into the multi-file analysis application, which is the software provided with the laser microscope. The imported image was corrected in the same way as the height of the protrusions described above.

Next, the number of vertices of the protrusions having a height of 0.2 μm or larger per unit area and the number of vertices of the protrusions having a height exceeding 5.0 μm were calculated using the following method, and the difference therebetween was calculated as Spd2.

### Measurement of the Number of Vertices of Protrusions Having Height

Exceeding 0.2 μm Per Unit Area
Measurement Mode: “Surface Roughness”
Measurement Area: Entire area Measurement Value: Spda

### Measurement of the Number of Vertices of Protrusions Having Height Exceeding 5.0 μm Per Unit Area

The number of vertices of the protrusions having a height exceeding 5.0 μm was measured using the following method. The number of vertices of the protrusions having a height exceeding 5.0 μm was subtracted from the Spda count, and the resulting value was divided by the measurement surface area to obtain Spd2.
Measurement Mode: “Volume and Surface Area Measurement”
Height Threshold Setting: Values 5 μm above a reference, the reference being the most frequent value of the height profile
Ignore Microregions: ON (Lower Limit: 100 pixels)

The above measurements were performed at a total of nine locations (same as the nine locations described above): (3 locations evenly spaced in the axial direction of the charging roller)×(3 locations evenly spaced circumferentially). The arithmetic mean value thereof was used.

### Method for Measuring the Ratios of First and Second Protrusions to all Protrusions Having Height of 0.2 μm or Larger

The ratios of first protrusions and second protrusions to protrusions having a height of 0.2 μm or larger on the charging roller surface were calculated using the following formula (1) from Spd1, Spd2, and Spda calculated by the same methods as above.

$$( Spd 1 + Spd 2 ) / Spda \times 100 \qquad ( 1 )$$

### Method for Measuring Universal Hardness HU1 of Protrusions Included in the Group of First Protrusions

A universal hardness tester (product name: FISCHERSCOPE HM2000XYp, manufactured by Fischer Instruments Inc.) was used for the measurement. Specific measurement conditions are shown below.
Measurement indenter: Vickers indenter (face angle 136, Young's modulus 1140, Poisson's ratio 0.07, indenter material: diamond)
Measurement environment: Temperature 23° C., relative humidity 50%
Maximum test load: 1.0 mN
Load conditions: Load was applied in proportion to time, at a rate that reached the maximum test load in 30 sec
Measurement area: Vertice of the first protrusion

In this evaluation, the universal hardness was calculated by the following formula (2) using a load F when the indenter was pressed to a depth of 0.4 μm from the surface of the measurement area and a contact area A between the indenter and the surface layer at that time:

$$Universal hardness ( \text{N/} {mm}^{2} ) = F / A \qquad ( 2 )$$

The above measurements were performed on a total of 27 first protrusions at nine locations (same as the nine locations described above: (3 locations evenly spaced in the axial direction of the charging roller)×(3 locations evenly spaced circumferentially)). The arithmetic mean value was taken as HU1 for the charging roller.

### Method for Measuring Universal Hardness HU2 of Protrusions Included in the Group of Second Protrusions

Measurement was performed under the same conditions as for HU1 described above, except that the measurement area was the vertex of the second protrusion. The resulting value was taken as HU2 for the charging roller.

### Method for Measuring Universal Hardness HUb of Binder Resin in Surface Layer

Measurement was performed under the same conditions as for HU1 described above, except that the measurement area was the binder resin where the first protrusions and the second protrusion were not present. The resulting value was taken as HUb for the charging roller.

### Elastic Modulus

A scanning probe microscope (SPM) (product name: MFP-3D-Origin, manufactured by Oxford Instruments) was used for the measurement. The specific method is described below.

First, markings were applied to the outer surface of the charging roller so that the first protrusion and the second protrusion could be distinguished. Next, the charging roller was cooled to −150° C., and a cryomicrotome (UC-6, manufactured by Leica Microsystems) was used to cut out a rubber slice revealing a cross-section of the surface layer in the thickness direction.

The prepared rubber slice was allowed to stand for 24 h in an environment of room temperature 23° C. and a relative humidity of 50%. Next, the rubber slice was placed on a silicon wafer, and the silicon wafer was set on the stage of the scanning probe microscope. The cross-sectional portion of the outer surface layer of the rubber slice was then scanned with a probe (product name: AC160, manufactured by Olympus Corporation). The conditions relating to the probe were as follows: spring constant: 28.23 nN/nm, impulse constant: 82.59 nm/V, and resonant frequency: 282 kHz (primary), 1.59 MHz (high order).

Other measurement conditions were as follows: an AM-FM mode as an SPM measurement mode, a probe free amplitude of 3 V, and set-point amplitudes of 2 V (primary) and 25 mV (higher order). The field of view was 20 μm×20 μm, the scan rate was 1 Hz, and the number of scan points was 256 vertically and 256 horizontally.

The conditions during force curve acquisition were as follows. Thus, the force curves were acquired at a trigger value of 0.2 V to 0.5 V (varied depending on hardness), a force curve measurement distance of 500 nm, and a scan rate of 1 Hz (the speed at which the probe makes one round trip). Each force curve was then fitted based on Hertz theory. The arithmetic mean of the eight obtained results, excluding the highest and lowest values, was determined and used as the elastic modulus for each measurement area.

### Elastic Modulus E′1 of First Resin Particles

The elastic modulus E′1 of the first resin particles forming the group of first protrusions was measured using the following method.

The elastic modulus of the area near the center of the particle forming the first protrusion in the cross section of the rubber slice in the thickness direction of the surface layer was measured based on the above-mentioned measurement method. The above measurement was performed on a total of 45 first protrusions at nine locations (same as the nine locations described above: (3 locations evenly spaced in the axial direction of the charging roller)×(3 locations evenly spaced circumferentially)), and the arithmetic mean value thereof was calculated.

### Elastic Modulus E′2 of Second Resin Particles

The elastic modulus E′2 of the second resin particles forming the group of second protrusions was measured using the following method.

The elastic modulus of the area near the center of the particle forming the second protrusion in the cross section of the rubber slice in the thickness direction of the surface layer was measured based on the above-mentioned measurement method. The above measurement was performed on a total of 45 second protrusions at nine locations (same as the nine locations described above: (3 locations evenly spaced in the axial direction of the charging roller)×(3 locations evenly spaced circumferentially)), and the arithmetic mean value thereof was calculated.

### Volume-Average Particle Diameters Dv1 and Dv2 of Resin Particles Present in Surface Layer

The volume-average particle diameters Dv1 and Dv2 of the resin particles present in the surface layer were measured using the following method. First, the resin particles were classified as first resin particles forming the group of first protrusions and second resin particles forming the group of second protrusions based on the markings used in the elastic modulus measurement.

Furthermore, the arithmetic mean value Ds of the equal-area circle-equivalent diameter of the cross section of each resin particle was calculated from the cross-sectional area of each classified resin particle. Then, assuming that the equal-volume sphere-equivalent diameter of the resin particle is D, because each resin particle is spherical and the cross section is formed by randomly cutting the sphere, the distance x from the center of the particle to the center of the cross section can be considered to be uniformly distributed within the range of −D/2 to D/2. The equal-volume sphere-equivalent diameter D of the resin particle was calculated from the arithmetic mean value Ds of the equal-area circle-equivalent diameter of the cross section using the following formula (4).

$$Ds = \frac{1}{D} \times 2 \times {\int }_{- \frac{D}{2}}^{\frac{D}{1}} \sqrt{{( \frac{D}{2} )}^{2} - {x}^{2} dx} \\ From this , D = 4 / π \times Ds \qquad ( 4 )$$

x: Distance from the Center of the Particle to the Center of the Cross Section

The above measurements were performed for five first resin particles and five second resin particles (the total number of measured resin particles of each type is 45) at one location for each of nine locations (same as the nine locations described above: (3 locations evenly spaced in the axial direction of the charging roller)×(3 locations evenly spaced circumferentially)). The volume-average particle diameters Dv1 and Dv2 of the first resin particles and second resin particles were calculated using the equal-volume sphere-equivalent diameter D of each resin particle obtained in this manner and the volume value obtained by conversion using 4/3×π×(D/2)³.

### Thickness of Surface Layer

The thickness of the surface layer in the depth direction from the outer surface according to the present embodiment was measured using the following method.

First, a thin rubber slice encompassing a cross section of the surface layer in the depth direction from the outer surface was cut out with a utility knife. The cross section was then observed using an optical microscope, and the distance from the minimum point of the depressions between the protrusions present on the outer surface of the surface layer to the interface between the surface layer and the conductive elastic layer was measured. This measurement was performed at 5 points at a total of nine locations (same as the nine locations described above: (3 locations evenly spaced in the axial direction of the charging roller)×(3 locations evenly spaced circumferentially)), for a total of 45 points. The arithmetic mean value of the results was used as the thickness of the surface layer in a portion where the first resin particles and second resin particles were not present.

### Methods for Measuring Toner

### Method for Measuring Softening Point of Binder Resin

The softening point of the binder resin was measured using a constant-load extrusion capillary rheometer, “Flow Property Evaluation Device, Flow Tester CFT-500D” (manufactured by Shimadzu Corporation), according to the manual provided with the device. In this device, a constant load is applied from above a measurement sample by a piston while the measurement sample filled in a cylinder is heated and melted. The molten sample is then extruded from a die at the bottom of the cylinder, and a flow curve is obtained showing the relationship between the piston descent amount and temperature. In the present disclosure, the “melting temperature in the ½ method” described in the manual provided with the “Flow Property Evaluation Device, Flow Tester CFT-500D” is used as the softening point. The melting temperature in the ½ method is calculated as follows:

First, half the difference between the piston descent amount Smax at the end of the outflow and the piston descent amount Smin at the start of the outflow is calculated (this is referred to as X; X=(Smax−Smin)/2). The temperature on the flow curve when the piston descent amount is the sum of X and Smin is the melting temperature in the ½ method. The measurement sample was prepared by compression molding 1.0 g of sample at 10 MPa for 60 sec using a tablet molding press (NT-100H, manufactured by NPa System Co., Ltd.) at 25° C. to form a cylindrical shape with a diameter of 8 mm. The measurement conditions for the CFT-500D were as follows:
Test Mode: Temperature increase method
Temperature Increase Rate: 4° C./min
Start Temperature: 40° C.
Final Temperature: 200° C.
Measurement Interval: 1.0° C.
Piston Cross-Sectional Area: 1.000 cm²
Test Load (Piston Load): 10.0 kgf (0.9807 MPa)
Preheat Time: 300 sec
Die Hole Diameter: 1.0 mm
Die Length: 1.0 mm

### Method for Measuring Glass Transition Temperature (Tg) of Binder Resin

The glass transition temperature (Tg) of the binder resin is measured using a differential scanning calorimeter “Q2000” (TA Instruments) in accordance with ASTM D3418-82. The melting points of indium and zinc are used for temperature correction of the device detector, and the heat of fusion of indium is used for correcting the heat quantity. Specifically, 2.0 mg of sample is weighed out and placed in an aluminum pan. An empty aluminum pan is used as a reference, and measurements are performed at a temperature rise rate of 10° C./min over a measurement temperature range of −10° C. to 200° C.

In the measurement, the sample temperature is first raised from −10° C. to 200° C. at a temperature rise rate of 10° C./min, then the temperature is lowered from 200° C. to −10° C. at a temperature lowering rate of 10° C./min, and then the temperature is raised again. During this second temperature rise process, the specific heat change is obtained in the temperature range of 30° C. to 100° C. The temperature (° C.) at the point where the straight line equidistant in the vertical direction from the straight lines obtained by extending the baseline before and after the specific heat change intersects with the curve representing the stepwise change zone in glass transition is the glass transition temperature (Tg) of the binder resin.

### Method for Measuring Major Axis and Aspect Ratio of Titanium Oxide Fine Particles

The major axis and aspect ratio of titanium oxide fine particles are measured using a scanning electron microscope (“S-4800” (product name; manufactured by Hitachi, Ltd.)). The toner to which titanium oxide fine particles have been added is observed in a field of view with a magnification of up to 100,000 times, and the major axis and minor axis of 100 randomly selected primary particles of titanium oxide fine particles are measured.

The aspect ratio of titanium oxide fine particle A is calculated using the following formula.

Aspect ratio of titanium oxide fine particle A=major axis of titanium oxide fine particle A÷minor axis of titanium oxide fine particle A

The observation magnification is adjusted, as appropriate, depending on the size of the titanium oxide fine particles. The number-average value of 100 titanium oxide fine particles is used.

In addition, whether the particles are from titanium oxide can be determined by combining elemental analysis using energy dispersive X-ray spectroscopy (EDS). Specifically, the toner is observed in a field of view with a magnification of up to 100,000 times. The device is focused on the toner particle surface, and the external additive to be identified is observed. EDS analysis of the external additive to be identified is performed, and the elemental peaks indicate whether the particle is from titanium oxide.

Method for Measuring Proportion of Toner Particles that can be Confirmed to have Titanium Oxide Fine Particles a on Surfaces Thereof

The proportion of toner particles that can be confirmed to have titanium oxide fine particles A on surfaces thereof is determined using a scanning electron microscope (“S-4800” (product name; manufactured by Hitachi, Ltd.)). A total of 50 toner particles to which titanium oxide fine particles A have been added are randomly observed in a field of view with a magnification of approximately 3000 times so that 10 to 30 toner particles can be observed in one field of view. Among 50 toner particles, the numerical proportion of toner particles on which at least one titanium oxide particle A is present is calculated, and the result is taken as the proportion of toner particles that can be confirmed to have titanium oxide particles A present on the surfaces thereof. The observation magnification is adjusted, as appropriate, depending on the size of the toner and the size of the titanium oxide particles A.

Whether the particles are from titanium oxide can be determined by combining elemental analysis using energy dispersive X-ray spectroscopy (EDS). Specifically, the toner is observed in a field of view with a magnification of up to 100,000 times. The device is focused on the toner particle surface, and the external additive to be identified is observed. EDS analysis of the external additive to be identified is performed, and the elemental peaks indicate whether the particle is from titanium oxide.

### Method for Measuring Adhesion Rate of Titanium Oxide Particles A

The number of toner particles containing rod-shaped titania is observed by SEM observation before and after treatment with the toner dispersion liquid, and the results are compared. Specifically, the calculation is performed as follows.

Treatment with Toner Dispersion Liquid

A total of 160 g of sucrose (manufactured by Kishida Chemical Co., Ltd.) is added to 100 mL of ion-exchange water and dissolved while heating in a hot water bath to prepare a sucrose concentrate. A total of 31 g of the sucrose concentrate and 6 mL of Contaminon N (a 10% by mass aqueous solution of a pH 7 neutral detergent for cleaning precision measuring instruments; consists of a nonionic surfactant, anionic surfactant, and organic builder, manufactured by Wako Pure Chemical Industries, Ltd.) are placed in a tube for centrifugal separation (50 mL capacity) to prepare a dispersion liquid. A total of 1.0 g of toner is added to this dispersion liquid, and any toner lumps are broken up with a spatula or the like.

The tube for centrifugal separation is shaken in a shaker (manufactured by Iwaki Sangyo Co., Ltd. “KM Shaker”) at 350 strokes per minute (spm) for 20 min. After shaking, the solution is transferred to a swing rotor glass tube (50 mL capacity), and separation is performed in a centrifuge (H-9R, manufactured by Kokusan Co., Ltd.) and under the conditions of 3500 rpm for 30 min. Sufficient separation of the toner and aqueous solution is visually confirmed, and the toner that separated to the top layer is collected with a spatula or the like.

The collected toner-containing aqueous solution is filtered through a vacuum filter and then dried in a dryer at 40° C. for at least 12 h. The dried product is then pulverized with a spatula to obtain a toner treated with the dispersion liquid.

### Measurement of Adhesion Rate of Titanium Oxide Fine Particles A

For the toner treated with the dispersion liquid, the proportion of toner particles that can be confirmed to have titanium oxide fine particles A on surfaces thereof is calculated (proportion 2 of toner particles) using the same method as described above for measuring the proportion of toner particles that can be confirmed to have titanium oxide fine particles A on surfaces thereof.

The result obtained was divided by the above-described proportion of toner particles that can be confirmed to have titanium oxide fine particles A on surfaces thereof (proportion 1 of toner particles), and multiplied by 100 to determine the adhesion rate (% by number) of titanium oxide fine particles A.

Method for Checking that Compound a is Contained and that Compound a is Detected as Cation while Compound B is Detected as Anion

As a method for checking that the compound A having the structure represented by Formula (1) is contained, it is possible to use a method using liquid chromatograph ESI/MS (electrospray ionization mass spectrometry) or a known analysis method such as ¹H nuclear magnetic resonance spectrometry. In the present disclosure, the analysis method using liquid chromatograph ESI/MS is used. Hereinafter, the analysis method will be described.

As a sample, the toner is used, and the sample after being adjustment under the following elution condition A is separated into a solid content and a supernatant under the centrifugation condition A.

The supernatant obtained through the above adjustment is supplied to the following liquid chromatograph ESI/MS analysis device, and ESI/MS analysis is performed under the analysis condition A.

Elution condition A: Methanol (a product equivalent to JISK8891) in an amount of ten times that of the toner (10 g) by mass is used, and mixture thereof is stirred at 25° C. at a rotor rotation speed of 200 rpm for 10 hours with a multi-stirrer (KSS-8: manufactured by AS ONE Corporation) as a stirring apparatus. For stirring, a triangle rotor (001.440; manufactured by AS ONE Corporation) with a total length×a one-side length: 40×14 mm is used for the stirring.

Centrifugation condition A: Rotation is performed with a rotation radius of 10.1 cm and a rotation speed of 3500 rpm at 25° C. for 30 minutes. It is possible to use a centrifugal machine (H-9R; manufactured by Kokusan) as a centrifugal apparatus.
Measurement apparatus: Ultimate 3000 (manufactured by Thermo Fisher Scientific)
Mass spectrometer: LCQ Fleet (manufactured by Thermo Fisher Scientific)
Analysis condition A: Under the following condition, the compound ionized under the condition of the capillary voltage of 35 V and the tube lens voltage of 110 V is detected as a cation, the compound ionized under the condition of the capillary voltage of −35 V and the tube lens voltage of −110 V is detected as anion, and MS spectra of the cation and the anion are acquired.
Ionization method: Electrospray method (ESI)
Sheath Gas: 10 (arb. unit.)
Aux Gas: 5 (arb. unit.)
Spray voltage: 5 Kv
Capillary temperature: 275° C.
Mobile phase: Methanol (product equivalent to JISK8891 standard)
Column: Not used (stationary phase is not used)
Flow rate: 1 ml/min
Pouring amount: 10 μl
Chromatogram detector: UV detector
MS acquisition time: 5 min
MS Measurement range: 50 to 1500 m/z

A relative abundance is obtained on the assumption that an abundance of a peak of the highest strength in a obtained mass analysis spectrum is 100%. First, a peak of the highest relative abundance is chosen as a chosen peak.

Whether peaks with the relative abundance of not less than 10% and with m/z values having peak top m/z values of P+44 or P−44 are present when an m/z value at the peak top of the chosen peak is defined as P is checked. In a case where such peaks are present, the chosen peak is defined as a reference peak. In a case where such peaks are not present, whether there are peaks with peak top m/z values of P+44 or P−44 are present is similarly checked when a peak with the next highest relative abundance is defined as a chosen peak and the m/z value at the peak top is defined as P. The operation is repeated until the reference peak is defined. For example, the peak at m/z=563 is defined as the reference peak in FIG. 2.

In a case where the reference peak is defined, it is determined that the compound A having the structure represented by Formula (1) is contained.

### Calculation of Average m/z Value of Compound A Having Structure Represented by Formula (1)

After the aforementioned reference peak is defined, the m/z value of the reference peak at the peak top is defined as Ps. Then, an average value of m/z at the peak tops of the peaks with peak top m/z values=Ps+44n (n is an integer) and with a relative abundance of not less than 30% is calculated as an average m/z.

### Method for Calculating m/z Value of Compound B

An m/z value of the compound B is calculated by performing analysis by the MS/MS (mass/mass) method by using a tandem mass spectrometer connected directly to the liquid chromatograph ESI/MS analysis device.

The MS/MS method is a mass analysis method capable of detecting a fragment with a yet smaller molecular weight and capable of easily performing structure analysis of the sample by measuring a fragment extracted by a first analysis system in a second analysis system.

As a sample, the toner was used, and the sample after being subjected to adjustment under the elution condition A is separated into a solid content and a supernatant under the centrifugation condition A.

The supernatant obtained in the adjustment is supplied to the following measurement apparatus, and liquid chromatograph ESI/MS analysis is performed under the analysis condition B. A mass analysis spectrum of anion is obtained, and the fact that a peak is detected at m/z=325 is checked. Also, the ion detected as a peak at m/z=325 is supplied as a precursor ion to the tandem mass spectrometer, and an MS/MS spectrum is acquired under the analysis condition B.
Measurement apparatus: Ultimate 3000 (manufactured by Thermo Fisher Scientific)
Mass spectrometer: LCQ Fleet (manufactured by Thermo Fisher Scientific)
Analysis condition B: Under the following conditions, the compound ionized under conditions of capillary voltage: −35 V and tube lens voltage: −110 V is detected as anion, and an ion detected at m/z=325 is selected as precursor ion, and an ion obtained by causing collision-induced dissociation with an inert gas: He at collision energy: 35 eV is detected.
Ionization method: Electrospray method (ESI)
Sheath Gas: 10 (arb. unit.)
Aux Gas: 5 (arb. unit.)
Spray voltage: 5 Kv
Capillary temperature: 275° C.
Mobile phase: Methanol (product equivalent to JISK8891 standard)
Column: Not used (stationary phase is not used)
Flow rate: 1 ml/min
Pouring amount: 10 μl
Chromatogram detector: UV detector
MS acquisition time: 5 min
MS Measurement range: 50 to 1500 m/z
Collision inert gas: He (helium)
Collision energy: 35 eV

The fact that peaks are detected at m/z=183 or m/z=197 in the obtained mass analysis spectrum of the MS/MS method is checked.

Method for Analyzing area P of Chromatogram Peak of Cation and Area N of Chromatogram Peak of Anion

Chromatogram peak areas P and N are calculated by using a chromatogram of the UV detector of the liquid chromatograph obtained at the time of the analysis in the method of checking that the compound A is contained and that the compound A is detected as a cation while the compound B is detected as anion. Specifically, the chromatogram obtained under the analysis condition C is used in the analysis under the analysis condition A.

Analysis condition C: When 10 μL of solution is poured into an apparatus configuration using methanol in a mobile phase and not using any stationary phase at a flow rate of 1 ml/min, a range of m/z=50 to 1500 is analyzed by setting an acquisition time to 5 min and using a UV detector as a detector, and chromatogram is acquired.

Integration is performed using, as a base line, a line connecting points from 0.1 min to 1.0 min for the chromatogram of a cation and the chromatogram of anion obtained. The integrated value is calculated as the peak area value P of the cation and the peak area value N of the anion.

Also, a ratio value P/N of the peak area P of the cation containing the compound A with respect to the peak area N of anion containing the compound B is calculated from obtained P and N.

### Method for Measuring Content of Structure Represented by Formula (1)

To check the content of the structure represented by Formula (1), ¹H nuclear magnetic resonance spectrometry (¹H-NMR) is used.
Measurement apparatus: FT NMR apparatus JNM-EX 400 (manufactured by JEOL Ltd.)
Measurement frequency: 400 MHz
Pulse condition: 5.0 μs
Frequency range: 10500 Hz
Number of times of addition: 1024 times
Measurement temperature: 30° C.
Sample: In the method for checking that the compound having the structure represented by Formula (1) is contained, the amount of toner used under the elution condition A is set to 10 g, and the toner is eluted and is subjected to centrifugation under the centrifugation condition A, thereby obtaining a supernatant.

The total amount of obtained supernatant is evaporated, dried, and solidified under the following condensation condition A, thereby obtaining an eluate.

Condensation condition A: A sample flask with the supernatant placed therein is dipped into a constant-temperature water tank at the temperature of 50° C., and condensation is performed at a rotation speed of 50 rol and at a degree of vacuum of 80 mbar for 12 hours. As an apparatus, a rotary evaporator (ARE-V1200 1; manufactured by AS ONE Corporation) is used.

1 ml of heavy methanol (CD₃OD) as a solvent is added to the obtained eluate, thereby obtaining a heavy methanol dissolved solution. The total amount of heavy methanol dissolved solution is transferred to a sample tube, and further, 100 ppm of reference substance with reference to the mass of the heavy methanol dissolved solution is added thereto, thereby obtaining a measurement sample.

The used reference substance has a chemical shift that has a signal that is different from any of those detected when ¹H-NMR analysis is performed by using the heavy methanol dissolved solution and has a known number of protons, is soluble in the quantifiable amount in the heavy methanol dissolved solution, and has a boiling point of not less than 100° C. Here, hexamethyldisilazane having a boiling point of 127° C. and having a signal originating from (SiCH₃)₆ at a chemical shift of 0 ppm is used as a reference substance.

Phase correction is performed on the obtained ¹H-NMR spectrum such that all the detected NMR signals are directed upward and inclinations at both bottoms are the same in all the NMR signals. Next, a line connecting points at 0 ppm and 8 ppm with a straight line is defined as a base line.

An integrated value having a start point and an end point at the points corresponding to ±0.05 ppm around the peak top of the NMR signal of the reference substance after the above correction is performed is defined as an integrated value I1 of the reference substance, and an integrated value of signal intensity at 3.4 ppm to 3.6 ppm is calculated as an integrated value I2 of the structure of Formula (1) originating from the compound A. The structure of Formula (1) is quantified in consideration of the molecular weights, the numbers of protons, and the concentrations of the reference substance and the structure of Formula (1).

Specifically, the content of the structure represented by Formula (1) is quantified on the basis of the following calculation equation.

$$Content of structure represented by Formula ( 1 ) [ ppm by mass ] = \{ ( M \times m ) / ( T \times w 2 / w 1 ) \} \times ( n 1 / n 2 ) \times ( I 2 / I 1 ) \times 1 {0}^{6}$$

Note that the mass of the toner used for the elution is defined as T [g], the mass of methanol used for the elution is defined as w1 [mg], the mass of supernatant used for ¹H-NMR is defined as w2 [mg], the mol number of the reference substance used for the analysis is defined as m [mol], the molecular weight of the structure of Formula (1) is defined as M [g/mol], the number of hydrogens in the component to which the focused peak of the reference substance belongs is defined as n1, and the number of hydrogens in the structure of Formula (1) is defined as n2.

### Method for Measuring Weight Average Particle Diameter (D4) and Number Average Particle Diameter (D1)

The weight average particle diameter (D4) and the number average particle diameter (D1) of the toner are calculated as follows. As a measurement apparatus, a precise granularity distribution measurement apparatus “Coulter Counter Multisizer 3” (registered trademark, manufactured by Beckman Coulter Inc.) that includes an aperture tube of 100 μm and is based on a pore electric resistance method is used. For setting of the measurement condition and analyzing measurement data, an attached dedicated software “Beckman Coulter Multisizer 3 Version 3.51” (manufactured by Beckman Coulter Inc.) is used. Note that the measurement is performed by 25000 effective measurement channels.

As an electrolyte aqueous solution used for the measurement, an electrolyte aqueous solution obtained by dissolving special-grade sodium chloride in ion-exchanged water to have a concentration of about 1% by mass, for example, “ISOTON II” (manufactured by Beckman Coulter Inc.) can be used. Note that setting of the dedicated software is performed as follows before the measurement and the analysis are performed.

On the screen “Change standard measurement method (SOMME)” of the dedicated software, the total count in the control mode is set to 50000 particles, the number of times of measurement is set to once, and a value obtained by using “Standard particles of 10.0 μm” (manufactured by Beckman Coulter Inc.) is set as a Kd value. A threshold value and a noise level are automatically set by pressing the “Threshold/noise level measurement button”. Also, the current is set to 1600 μA, the gain is set to 2, the electrolytic solution is set to ISOTON II, and “Flush aperture tube after measurement” is checked.

On the “Conversion setting from pulse to particle diameter” screen of the dedicated software, the pin interval is set to a logarithmic particle diameter, the particle diameter bin is set to a 256-particle diameter bin, and the particle diameter range is set to 2 μm to 60 μm.

Specific measurement method is as follows.
(1) 200 ml of the electrolyte aqueous solution was put into a 250 ml round-bottomed flask made of glass and dedicated for Multisizer 3, the flask is set in a sample stand, and stirring with a stirrer rod is performed in the counterclockwise direction at 24 rotations/second. Also, contamination and air bubbles inside the aperture tube are removed in advance by using the function “Flush aperture tube” of the dedicated software.
(2) 30 ml of the electrolyte aqueous solution is put into a 100 ml flat-bottomed flask made of glass. 0.3 ml of diluted solution obtained by diluting “Contaminon N” (10% by mass of aqueous solution of a neutral detergent for a precise measurement machine with pH 7 including a non-ionic surfactant, an anionic surfactant, and an organic builder; manufactured by Wako Pure Chemicals, Ltd.) with ion-exchanged water to the amount that is about 3 times by mass is added thereto as a dispersant.
(3) An ultrasonic dispersing machine “Ultrasonic Dispersion System Tetra 150” (manufactured by Nikkaki Bios, Co., Ltd.) incorporating two oscillators with an oscillation frequency of 50 kHz in a state where the phases are shifted by 180 degrees and having an electric output of 120 W is prepared. 3.3 L of ion-exchanged water is put into a water tank of the ultrasonic dispersing machine, and 2 ml of Contaminon N is added to the water tank.
(4) The above flask in (2) is set at a flask fixing hole of the ultrasonic dispersing machine, and the ultrasonic dispersing machine is caused to operate. Then, the height position of the flask is adjusted such that the resonance state of the liquid surface of the electrolyte aqueous solution in the flask is maximized.
(5) 10 mg of toner is added little by little to the electrolyte aqueous solution and is dispersed therein in a state where the electrolyte aqueous solution inside the above flask in (4) is irradiated with ultrasonic waves. Then, ultrasonic dispersion treatment is further continued for sixty more seconds. Note that the water temperature in the water tank is appropriately adjusted to be equal to or greater than 10° C. and equal to or less than 40° C. for the ultrasonic dispersion.
(6) The above electrolyte aqueous solution in (5) with the toner dispersed therein is dropped into the above round-bottomed flask in (1) installed in the sample stand by using a pipette, and the measurement concentration is adjusted to 5%. Then, measurement is performed until the number of measurement particles reaches 50000.

(7) Measurement data is analyzed by the dedicated software attached to the apparatus, and the weight average particle diameter (D4) and the number average particle diameter (D1) are calculated. Note that the “Average diameter” on the “Analysis/volume statistical value (arithmetic mean)” screen when graph/% by volume is set in the dedicated software is the weight average particle diameter (D4), and the “Average diameter” on the “Analysis/number statistical value (arithmetic mean)” screen when graph/% by number is set in the dedicated software is the number average particle diameter (D1).

### Method for Measuring Contact Line Pressure of Cleaning Blade

The contact line pressure of the cleaning blade was measured using the following procedure.

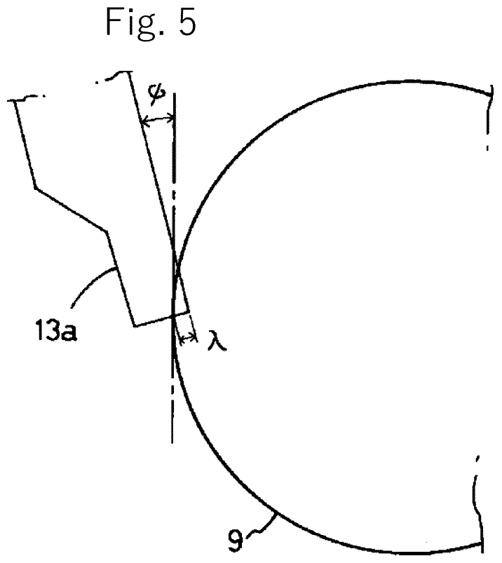

First, using FIG. 5, the penetration amount λ and set angle φ of a cleaning blade 13a with respect to a photosensitive drum 9 will be explained. The cleaning blade penetration amount λ is the hypothetical amount by which the tip of the cleaning blade 13a penetrates as is into the photosensitive drum 9 without deformation. The cleaning blade set angle φ is the angle between the cleaning blade 13a and the tangent at the point where the tip of the cleaning blade 13a intersects with the photosensitive drum 9.

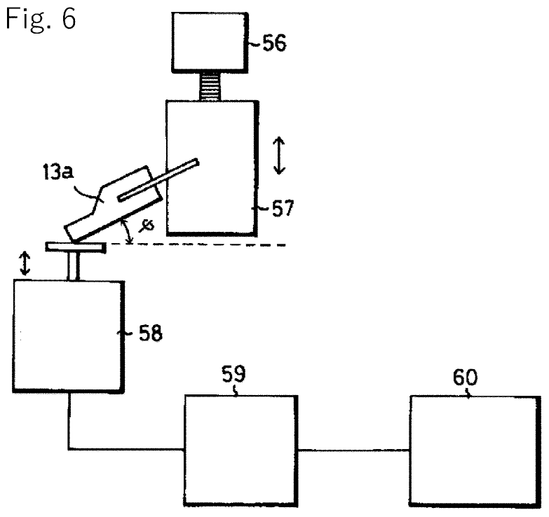

Based on the above, a method for measuring the contact line pressure of the cleaning blade will be explained using FIG. 6. First, to measure the linear pressure per unit centimeter, the cleaning blade 13a cut to a width of 1 cm is set on a blade base 57 that can be moved in the direction of the arrow in the figure by a motor 56. The blade 13a is set to set angle φ of 24° and brought into contact with a load sensor 58. Next, the blade base 57 is moved toward the load sensor by the desired penetration amount X, and the detected value of the load sensor 58 at that time is amplified by an amplifier 59 and read by a voltmeter 60. The measurement is performed by replacing the previously determined load per unit voltage with the linear pressure per unit centimeter. The value measured in this manner is the contact line pressure of the cleaning blade.

Explained hereinbelow are production examples of the charging roller, toner, and image forming apparatus according to Examples and Comparative Examples, but the present disclosure is not limited to these examples.

### Production Example of Charging Roller

Described below is a production example of a charging roller (CR1) used in Example 1.

### Preparation of Unvulcanized Rubber Composition for Forming Base Layer Used to Form Base Layer Roller (K-1)

An unvulcanized rubber composition (1) was obtained by mixing the ingredients in the blending amounts shown in Table 1-1 by using a 6-liter pressure kneader (product name: TD6-15MDX, manufactured by Toshin Co., Ltd.). The mixing conditions were as follows: a filling volume of 70 vol %, a blade rotation speed of 30 rpm, a kneader temperature of 100° C., and 16 min.

TABLE 1-1
Raw materials of unvulcanized rubber composition (1)

| | | Blending amount |
|---|---|---|
| | Raw material name | (parts by mass) |
| Base layer | Hydrin rubber (product name: Hydrin T3106, manufactured | 90 |
| rubber \textcircled{1} | by Nippon Zeon Corporation) | |
| Base layer | NBR rubber (product name: N237H, manufactured by JSR | 10 |
| rubber \textcircled{2} | Corporation) | |
| Filler | Calcium carbonate (product name: Nanox #30, | 20 |
| | manufactured by Maruo Calcium Co., Ltd.) | |
| Inorganic | Hydrocalcite (product name: DHT-4A ®-2, manufactured by | 1 |
| compound \textcircled{1} | Kyowa Chemical Industry Co., Ltd.) | |
| Inorganic | Zinc stearate (product name: SZ-2000, manufactured by | 1 |
| compound \textcircled{2} | Sakai Chemical Industry Co., Ltd.) | |
| Ion conductive | Quaternary phosphonium salt | 2 |
| agent | (product name: tetrabutylphosphonium = | |
| | bis(trifluoromethanesulfonyl)imide, manufactured by Wako | |
| | Pure Chemical Industries, Ltd.) | |

Next, the vulcanizing agent and vulcanization accelerator shown in Table 1-2 were added in the blending amounts shown in Table 1-2 to 100 parts by mass of unvulcanized rubber composition (1), and the components were mixed using an open roll to prepare the unvulcanized rubber composition for molding the base layer. An open roll with a roll diameter of 12 inches was used as the mixer. The mixing conditions were as follows: a total of 20 left-right reversals with a front roll rotation speed of 10 rpm, a rear roll rotation speed of 8 rpm, and a roll gap of 2 mm. Then, ten thin passes were performed with a roll gap of 1.0 mm.

TABLE 1-2
Unvulcanized rubber composition for forming base layer

| | | Blending amount |
|---|---|---|
| | Raw material name | (parts by mass) |
| Raw material | Unvulcanized rubber composition (1) | 100 |
| rubber | | |
| Vulcanizing | Sulfur (product name: Sulfax PMC, manufactured by | 1 |
| agent | Tsurumi Chemical Industry Co., Ltd.) | |
| Vulcanization | Dibenzothiazolyl sulfide (product name: Noxeller DM, | 1 |
| accelerator \textcircled{1} | manufactured by Ouchi Shinko Chemical Industrial | |
| | Co., Ltd.) | |
| Vulcanization | Tetramethylthiuram monosulfide (product name: Noxeller | 0.5 |
| accelerator \textcircled{2} | TS, manufactured by Ouchi Shinko Chemical Industrial | |
| | Co., Ltd.) | |

### Formation of Base Layer

A core bar having a total length of 252 mm and an outer diameter of 6 mm was prepared as a support. The core bar was obtained by subjecting the surface of free-cutting steel to electroless nickel plating treatment. This core was used as the support, which was a conductive shaft core. Next, using a roll coater, an adhesive (product name: Metalock U-20, manufactured by Toyo Kagaku Kenkyusho Co., Ltd.) was applied to the entire 230 mm circumference of the core bar, excluding 11 mm at each end. In this Example, the adhesive-coated core bar was used as the conductive support.

Next, a die with an inner diameter of 10.0 mm was attached to the tip of a crosshead extruder, which had a mechanism for supplying the conductive support and a mechanism for discharging the unvulcanized rubber roller. The temperature of the extruder and crosshead was set to 100° C., and the conveying speed of the conductive support was adjusted to 60 mm/sec. Under these conditions, the unvulcanized rubber composition for forming the base layer was supplied from the extruder, and the outer periphery of the conductive support was coated with the unvulcanized rubber composition for forming the base layer within the crosshead, thereby obtaining an unvulcanized rubber roller.

Next, the unvulcanized rubber roller was placed in a 170° C. hot-air vulcanizing oven and heated for 60 min to vulcanize the unvulcanized rubber composition, resulting in a conductive roller with a conductive base layer (elastic layer) formed on the outer periphery of the conductive support. Subsequently, 10 mm was cut off from both ends of the conductive resin layer, resulting in a length of 232 mm for the conductive resin layer in the longitudinal direction.

### Polishing of Base Layer

Next, the surface of the conductive roller was polished under the polishing conditions described in Polishing Conditions 1 below to obtain a crown-shaped base layer roller (K-1) with a central diameter of 8.5 mm and diameters of 8.40 mm at positions 90 mm from the center to both ends.

### Polishing Conditions 1

A cylindrical grindstone (manufactured by Teiken Co., Ltd.) with a diameter of 305 mm and a length of 235 mm was prepared. The abrasive grain type, grain size, bond strength, binder, and structure (abrasive grain ratio) are as follows:
Abrasive grain material: GC (green silicon carbide material) (JIS R6111-2002)
Abrasive grain size: #80 (average grain diameter 177 μm, JIS B4130)
Abrasive grain bond strength: HH (JIS R6210)
Binder: V4PO (vitrified)
Abrasive grain structure (Abrasive Grain Ratio): 23 (abrasive grain content ratio 16%, JIS R6242)

As the polishing conditions, the grindstone rotation speed was set to 2100 rpm, and the conductive member rotation speed was set to 250 rpm. In the coarse cutting step, the grindstone penetrated 0.24 mm after contacting the outer surface of the conductive member at a penetration speed into the conductive workpiece of 20 mm/sec.

For the precision polishing step, the penetration speed was changed to 0.5 mm/sec. After penetrating 0.01 mm, the grindstone was removed from the conductive member to complete the polishing.

The polishing method used was the uppercut method, in which the grindstone and the conductive member rotated in the same direction.

The charging roller (CR1) used in Example 1 was fabricated by forming a surface layer (1) on the base roller (K-1) using the following procedure.

### Preparation of Isocyanate Group-Terminated Prepolymer

The surface layer coating liquid for forming a surface layer 1 was prepared as follows. In a nitrogen atmosphere, 100 parts by mass of polyether polyol (product name: PTMG 3000, manufactured by Mitsubishi Chemical Corporation) was gradually added dropwise to 30 parts by mass of polymeric MDI (product name: Millionate MR200, manufactured by Tosoh Corporation) in a reactor, while maintaining the temperature inside the reactor at 65° C. After the dropwise addition was completed, the reaction was performed at 65° C. for 2 h. The resulting reaction mixture was cooled to room temperature, thereby obtaining an isocyanate group-terminated prepolymer B-1 with an isocyanate group content of 4.3%.

### Preparation of Surface Layer Coating Liquid S-1

A total of 58 parts by mass of isocyanate group-terminated prepolymer B-1, 42 parts by mass of polyether polyol (A-1) (product name: PTMG 2000, manufactured by Mitsubishi Chemical Corporation), and 25 parts by mass of carbon black (C-1) (product name: MA230, manufactured by Mitsubishi Chemical Corporation, number-average particle diameter: 30 nm) were dissolved in methyl ethyl ketone (MEK) to obtain a solids content of 25% by mass. Mixture 1 was thus produced.

A total of 270 g of mixture 1 and 200 g of glass beads with an average particle diameter of 0.8 mm were placed in a glass bottle having an inner volume of 450 mL and dispersed for 12 h using a paint shaker disperser. After dispersion, 5 parts by mass of urethane particles (D-1) (product name: Art Pearl CE-300, manufactured by Negami Chemical Industrial Co., Ltd.) having an average particle diameter of 22.0 μm and 10 parts by mass of urethane particles (E-1) (product name: Art Pearl C-800, manufactured by Negami Chemical Industrial Co., Ltd.) that have been classified using an air classifier (product name: Model EJ-L-3, manufactured by Nittetsu Mining Co., Ltd.) were added.

The volume-average particle diameter of the classified urethane particles (E-1) was measured using a particle size distribution analyzer (device name: Coulter Multisizer II, manufactured by Coulter Co., Ltd.) and was found to be 5.0 μm. The mixture was then further dispersed for 15 min, and the glass beads were removed to obtain a surface layer coating liquid S-1.

### Preparation of Surface Layer Coating Liquids S-2 to S-42

Surface layer coating liquids S-2 to S-42 were prepared in the same manner as the surface layer coating liquid S-1, except for the formulation changes represented in Table 1-3.

TABLE 1-3
Surface
layer

| coating | | | | | Conducive | | | First resin | | Second resin | | Third resin | |
|---|---|---|---|---|---|---|---|---|---|---|---|---|---|
| liquid | Polyol | | Isocyanate | | agent | | Solids | particles | | particles | | particles | |
| No. | No. | Parts | No. | Parts | No. | Parts | mass % | No. | Parts | No. | Parts | No. | Parts |
| S-1 | A-1 | 42 | B-1 | 58 | C-1 | 25 | 25% | D-1 | 5 | E-1 | 10 | — | — |
| S-2 | A-1 | 42 | B-1 | 58 | C-1 | 25 | 25% | D-1 | 5 | E-2 | 10 | — | — |
| S-3 | A-1 | 42 | B-1 | 58 | C-1 | 25 | 25% | D-1 | 5 | E-3 | 10 | — | — |
| S-4 | A-1 | 42 | B-1 | 58 | C-1 | 25 | 25% | D-1 | 5 | E-4 | 10 | — | — |
| S-5 | A-1 | 42 | B-1 | 58 | C-1 | 25 | 25% | D-2 | 5 | E-1 | 10 | — | — |
| S-6 | A-1 | 42 | B-1 | 58 | C-1 | 25 | 25% | D-3 | 5 | E-1 | 10 | — | — |
| S-7 | A-1 | 42 | B-1 | 58 | C-1 | 25 | 25% | D-13 | 5 | E-1 | 10 | — | — |
| S-8 | A-1 | 42 | B-1 | 58 | C-1 | 25 | 25% | D-1 | 1.5 | E-1 | 10 | — | — |
| S-9 | A-1 | 42 | B-1 | 58 | C-1 | 25 | 20% | D-1 | 30 | E-1 | 10 | — | — |
| S-10 | A-1 | 42 | B-1 | 58 | C-1 | 25 | 20% | D-1 | 50 | E-1 | 10 | — | — |
| S-11 | A-1 | 42 | B-1 | 58 | C-1 | 25 | 25% | D-9 | 5 | E-1 | 10 | — | — |
| S-12 | A-1 | 42 | B-1 | 58 | C-1 | 25 | 25% | D-4 | 5 | E-1 | 10 | — | — |
| S-13 | A-1 | 42 | B-1 | 58 | C-1 | 25 | 25% | D-5 | 5 | E-1 | 10 | — | — |
| S-14 | A-1 | 42 | B-1 | 58 | C-1 | 25 | 25% | D-10 | 5 | E-1 | 10 | — | — |
| S-15 | A-1 | 42 | B-1 | 58 | C-1 | 25 | 25% | D-11 | 5 | E-1 | 10 | — | — |
| S-16 | A-1 | 42 | B-1 | 58 | C-1 | 25 | 25% | D-1 | 5 | E-8 | 10 | — | — |
| S-17 | A-1 | 42 | B-1 | 58 | C-1 | 25 | 25% | D-1 | 5 | E-9 | 10 | — | — |
| S-18 | A-1 | 42 | B-1 | 58 | C-1 | 25 | 25% | D-1 | 5 | — | — | — | — |
| S-19 | A-1 | 42 | B-1 | 58 | C-1 | 25 | 25% | D-1 | 5 | E-1 | 1 | — | — |
| S-20 | A-1 | 42 | B-1 | 58 | C-1 | 25 | 25% | D-1 | 5 | E-1 | 60 | — | — |
| S-21 | A-1 | 42 | B-1 | 58 | C-1 | 25 | 25% | D-1 | 5 | E-1 | 70 | — | — |
| S-22 | A-1 | 42 | B-1 | 58 | C-1 | 25 | 25% | D-1 | 5 | E-1 | 1 | — | — |
| S-23 | A-1 | 42 | B-1 | 58 | C-1 | 25 | 25% | D-1 | 5 | E-1 | 80 | — | — |
| S-24 | A-1 | 42 | B-1 | 58 | C-1 | 25 | 25% | D-1 | 5 | E-1 | 10 | D-2 | 10 |
| S-25 | A-2 | 42 | B-2 | 58 | C-1 | 25 | 25% | D-1 | 5 | E-1 | 10 | — | — |
| S-26 | A-3 | 42 | B- 1 | 58 | C-1 | 25 | 25% | D-1 | 5 | E-1 | 10 | — | — |
| S-27 | A-4 | 65 | B- 1 | 35 | C-1 | 25 | 25% | D-1 | 5 | E-1 | 10 | — | — |
| S-28 | A-3 | 6 | B-1 | 94 | C-1 | 20 | 25% | D-1 | 5 | E-1 | 10 | — | — |
| S-29 | A-1 | 42 | B-1 | 58 | C-1 | 25 | 25% | D-1 | 5 | E-5 | 10 | — | — |
| S-30 | A-1 | 42 | B-1 | 58 | C-1 | 25 | 25% | D-1 | 5 | E-6 | 10 | — | — |
| S-31 | A-1 | 42 | B-1 | 58 | C-1 | 25 | 25% | D-1 | 5 | E-10 | 10 | — | — |
| S-32 | A-1 | 42 | B-1 | 58 | C-1 | 25 | 25% | D-1 | 5 | E-11 | 10 | — | — |
| S-33 | A-1 | 42 | B-1 | 58 | C-1 | 25 | 22% | D-1 | 5 | E-1 | 10 | — | — |
| S-34 | A-1 | 42 | B-1 | 58 | C-1 | 25 | 28% | D-1 | 5 | E-1 | 10 | — | — |
| S-35 | A-1 | 42 | B-1 | 58 | C-1 | 25 | 25% | — | — | — | — | — | — |
| S-36 | Nylon resin FR-104 | | | | C-1 | 5 | 20% | D-12 | 20 | — | — | — | — |
| S-37 | A-1 | 42 | B-1 | 58 | C-1 | 25 | 20% | D-1 | 60 | E-1 | 10 | — | — |
| S-38 | A-1 | 42 | B-1 | 58 | C-1 | 25 | 35% | D-1 | 1 | E-1 | 10 | — | — |
| S-39 | A-1 | 42 | B-1 | 58 | C-1 | 25 | 25% | — | — | E-1 | 10 | — | — |
| S-40 | A-1 | 42 | B-1 | 58 | C-1 | 25 | 22% | D-8 | 5 | E-1 | 10 | — | — |
| S-41 | A-1 | 42 | B-1 | 58 | C-1 | 25 | 35% | D-2 | 3 | E-1 | 10 | — | — |

| | | | | | | | | | | |
|---|---|---|---|---|---|---|---|---|---|---|
| S-42 | 6-Nylon, Trijind F-30K | HS 100 | 18 | 10% | D-7 | 10 | E-7 | 10 | — | — |

The raw materials listed in the “No.” columns in Table 1-3 are detailed in Tables 1-4 and 1-5. “Parts” indicates “Parts by mass” ~. “Nylon resin FR-104” indicates “Nylon resin, “Fine Resin FR-104”, manufactured by Namariichi Co., Ltd.” “HS100” indicate “Denka Black HS100”. The preparation method for isocyanate (isocyanate group-terminated prepolymer) “B-1” in Tables 1-4 and 1-5 is described above. The preparation methods for isocyanate “B-2”, urethane particles D-3, 4, 5, 9, and 10, and E-1, 5, 6, 8, and 11 are described after Table 1-5.

TABLE 1-4

| | No. | Compound name |
|---|---|---|
| Polyol | A-1 | Polyether polyol |
| | | (hydroxyl value: 56.1 mg KOH/g, product name: |
| | | PTMG 2000, manufactured by Mitsubishi |
| | | Chemical Corporation) |
| | A-2 | Polycarbonate polyol |
| | | (hydroxyl value: 55.7 mg KOH/g, product name: |
| | | Duranol T5652, manufactured by Asahi |
| | | Kasei Corporation) |
| | A-3 | Polyether polyol |
| | | (hydroxyl value: 17.5 mg KOH/g, product name: |
| | | PTMG 3000, manufactured by Mitsubishi |
| | | Chemical Corporation) |
| | A-4 | Amine-based polyol |
| | | (hydroxyl value: 701 mg KOH/g, product name: |
| | | NP-400, manufactured by Sanyo Chemical |
| | | Industries, Ltd.) |
| Isocyanate | B-1 | Polyether-based polyol |
| | | (NCO content 4.3%, product name: PTMG 3000, |
| | | manufactured by Mitsubishi Chemical |
| | | Corporation)/polymeric MDI |
| | | (product name: Millionate MR200, manufactured |
| | | by Tosoh Corporation) |
| | B-2 | Polycarbonate-based polyol |
| | | (NCO content 4.3%, product name: Duranol |
| | | T5652, manufactured by Asahi Kasei |
| | | Corporation)/polymeric MDI |
| | | (product name: Millionate MR200, manufactured |
| | | by Tosoh Corporation) |
| Conductive | C-1 | Carbon black |
| agent | | (product name: MA 100, average primary |
| | | particle diameter 24 nm, manufactured by |
| | | Mitsubishi Chemical Corporation) |

TABLE 1-5

| | | |
|---|---|---|
| First resin | D-1 | Urethane particles |
| particles | | (product name: Art Pearl CE300 Transparent, average particle diameter 22 μm) |
| | D-2 | Urethane particles |
| | | (product name: Art Pearl CE400 Transparent, average particle diameter 15 μm) |
| | D-3 | Urethane particles (classified product) |
| | | (product name: Art Pearl CE300 Transparent, average particle diameter 30 μm) |
| | D-4 | Urethane particles (A-4 × B-1, average particle diameter 22 μm) |
| | D-5 | Urethane particles (classified product) |
| | | (product name: Art Pearl U400 Transparent, average particle diameter 22 μm) |
| | D-7 | Nylon particles |
| | | (product name: Orgasol series, average particle diameter 20 μm, manufactured |
| | | by Arkema Inc.) |
| | D-8 | Urethane particles (classified product) |
| | | (product name: Art Pearl CE300 Transparent, average particle diameter 40 μm) |
| | D-9 | Urethane particles (classified product) |
| | | (product name: Art Pearl JB400 Transparent, average particle diameter 22 μm) |
| | D-10 | Urethane particles (classified product) |
| | | (product name: Art Pearl JC-800TR, average particle diameter 12 μm) |
| | D-11 | Acrylic particles |
| | | (product name: Ganzpearl GM-2201, average particle diameter 22 μm, |
| | | manufactured by Aica Kogyo Co., Ltd.) |
| | D-12 | Nylon particles |
| | | (product name: Orgasol 2002ES3NAT3, average particle diameter 30 μm, |
| | | manufactured by Arkema Inc.) |
| | D-13 | Urethane particles (classified product) |
| | | (product name: Art Pearl CE300 Transparent, average particle diameter 18 μm) |
| Second | E-1 | Urethane particles (classified product) |
| resin | | (product name: Art Pearl C800 Transparent, average particle diameter 5 μm) |
| particles | E-2 | Urethane particles |
| | | (product name: Art Pearl C800 Transparent, average particle diameter 7 μm) |
| | E-3 | Urethane particles |
| | | (product name: Art Pearl C1000 Transparent, average particle diameter 3 jum) |
| | E-4 | Urethane particles |
| | | (product name: Art Pearl C600 Transparent, average particle diameter 10 μm) |
| | E-5 | Urethane particles (classified product) |
| | | (product name: Art Pearl JB800 Transparent, average particle diameter 5 μm) |
| | E-6 | Urethane particles (A-3 × B-2, average particle diameter 5 μm) |
| | E-7 | Nylon particles |
| | | (product name: Orgasol series, average particle diameter 10 μm, manufactured |
| | | by Arkema Inc.) |
| | E-8 | Urethane particles (classified product) |
| | | (product name: Art Pearl C1000 Transparent, average particle diameter 1 μm) |
| | E-9 | Urethane particles (classified product) |
| | | (product name: Art Pearl C400 Transparent, average particle diameter 12 μm) |
| | E-10 | Urethane particles |
| | | (product name: Art Pearl JB800 Transparent, average particle diameter 7 μm) |
| | E-11 | Urethane particles (classified product) |
| | | (product name: Art Pearl CE400 Transparent, average particle diameter 5 μm) |

In the table, the average particle diameter indicates the volume-average particle diameter. The “Art Pearl” product series is manufactured by Negami Chemical Industrial Co., Ltd.

### Production Example of Isocyanate Group-Terminated Isocyanate Prepolymer B-2

A total of 100 parts by mass of polycarbonate polyol (Duranol T5652, manufactured by Asahi Kasei Corporation) was slowly added dropwise to 33 parts by mass of polymeric MDI (product name: Millionate MR200, manufactured by Tosoh Corporation) in a reaction vessel under a nitrogen atmosphere. The temperature inside the reaction vessel was maintained at 65° C. After the addition was completed, the components were allowed to react at 65° C. for 2 h. The resulting reaction mixture was cooled to room temperature, yielding isocyanate group-terminated prepolymer B-2 with an isocyanate group content of 4.3% by mass.

### Production Example of Urethane Particles D-3

Urethane particles D-1 (product name: Art Pearl CE300, transparent, volume-average particle diameter: 22.0 μm, manufactured by Negami Chemical Industrial Co., Ltd.) were classified using an air classifier (product name: Model EJ-L-3, manufactured by Nittetsu Mining Co., Ltd.). The volume-average particle diameter of the urethane particles was measured using a particle size distribution analyzer (product name: Coulter Multisizer II, manufactured by Coulter Co., Ltd.) and found to be 30.0 μm. These particles were designated as urethane particles D-3.

### Production Example of Urethane Particles D-4

A total of 3 parts by mass of amine-based polyol A-4 and 97 parts by mass of isocyanate group-terminated prepolymer B-1 were added to water containing a suspension stabilizer (calcium phosphate) and stirred to form a suspension. The suspension was then heated to initiate the reaction, which was then allowed to advance sufficiently to produce urethane particles. The urethane particles were then recovered by solid-liquid separation, washed to remove the suspension stabilizer and dried. The resulting urethane particles were classified using an air classifier (product name: EJ-L-3, manufactured by Nittetsu Mining Co., Ltd.). The volume-average particle diameter of the urethane particles was measured using a particle size distribution analyzer (product name: Coulter Multisizer II, manufactured by Coulter Co., Ltd.) and found to be 22.0 μm. These particles were designated as urethane particles D-4.

### Production Example of Urethane Particles D-5

Urethane particles D-5 (volume-average particle diameter 22.0 μm) were produced in the same manner as urethane particles D-3, except that “Art Pearl U400 Transparent” (product name, volume-average particle diameter 15.0 μm, manufactured by Negami Chemical Industrial Co., Ltd.) was used as the urethane particles.

### Production Example of Urethane Particles D-9

Urethane particles D-9 (volume-average particle diameter 22.0 μm) were produced in the same manner as urethane particles D-3, except that “Art Pearl P400 Transparent” (product name, volume-average particle diameter 15.0 μm, manufactured by Negami Chemical Industrial Co., Ltd.) was used as the urethane particles.

### Production Example of Urethane Particles D-10

Urethane particles D-10 (volume-average particle diameter 12 μm) were produced in the same manner as urethane particles D-3, except that “Art Pearl JC-800TR” (product name, volume-average particle diameter 6.0 μm, manufactured by Negami Chemical Industrial Co., Ltd.) was used as the urethane particles.

### Production Example of Urethane Particles E-1

Urethane particles E-1 (volume-average particle diameter 5.0 μm) were produced in the same manner as urethane particles D-3, except that “Art Pearl C800 Transparent” (product name, volume-average particle diameter 8.0 μm, manufactured by Negami Chemical Industrial Co., Ltd.) was used as the urethane particles.

### Production Example of Urethane Particles E-5

Urethane particles E-5 (volume-average particle diameter 5.0 μm) were produced in the same manner as urethane particles D-3, except that “Art Pearl JB800 Transparent” (product name, volume-average particle diameter 8.0 μm, manufactured by Negami Chemical Industrial Co., Ltd.) was used as the urethane particles.

### Production Example of Urethane Particles E-6

Urethane particles E-6 (volume-average particle diameter 5.0 km) were produced in the same manner as urethane particles D-4, except that the polyol was changed to 35 parts by mass of polycarbonate-based polyol A-2, the isocyanate was changed to 65 parts by mass of isocyanate group-terminated prepolymer B-2, and the stirring speed of the suspension and the classification conditions of the urethane particles were changed.

### Production Example of Urethane Particles E-8

Urethane particles E-8 (volume-average particle diameter 1.0 km) were produced in the same manner as urethane particles D-3, except that “Art Pearl C1000 Transparent” (product name, volume-average particle diameter 3.0 μm, manufactured by Negami Chemical Industrial Co., Ltd.) was used as the urethane particles.

### Production Example of Urethane Particles E-11

Urethane particles E-11 (volume-average particle diameter 5.0 km) were produced in the same manner as urethane particles D-3, except that “Art Pearl CE400 Transparent” (product name, volume-average particle diameter 16.0 μm, manufactured by Negami Chemical Industrial Co., Ltd.) was used as the urethane particles.

### Production Example of Charging Roller CR1

The base layer roller (K-1) was immersed (dipped) in the surface layer coating liquid S-1 while holding the upper end of the roller so that the longitudinal direction thereof was vertical. The dipping time for the dip coating was 9 sec, and the roller pull-up speed was adjusted so that the initial speed was 20 mm/sec and the final speed was 2 mm/sec. The speed was changed linearly with time between 20 mm/sec and 2 mm/sec. After coating, the roller was air-dried for 30 min at 23° C. Subsequent drying in a hot air circulation dryer at 80° C. for 1 h and then at 160° C. for 1 h formed a dried film of the coating film of the surface layer coating liquid S-1 on the conductive layer.

Furthermore, as a surface treatment, the surface of the dried film was irradiated with ultraviolet light at a wavelength of 254 nm to an integrated light quantity of 9000 mJ/cm², thereby removing the outermost skin layer of the dried film and forming a surface layer in which the conductive particles (conductive carbon black) in the dried film were exposed to the outer surface. A low-pressure mercury lamp (manufactured by Toshiba Lighting & Technology Corporation) was used as the ultraviolet light source. In this way, the charging roller CR1 of Example 1 was fabricated.

### Production Examples of Charging Rollers CR2 to CR42

Charging rollers CR2 to CR42 were produced in the same manner as in the production example of charging roller CR1, except for changing, as shown in Table 1-6, the type of surface layer coating liquid and whether the surface treatment was performed.

The physical properties of charging rollers CR1 to CR42 are shown in Table 1-7.

TABLE 1-6

| Charging | Base | Surface layer | Surface |
|---|---|---|---|
| roller No. | layer No. | coating liquid No. | treatment |
| CR1 | K-1 | S-1 | Yes |
| CR2 | K-1 | S-2 | Yes |
| CR3 | K-1 | S-3 | Yes |
| CR4 | K-1 | S-4 | Yes |
| CR5 | K-1 | S-5 | Yes |
| CR6 | K-1 | S-6 | Yes |
| CR7 | K-1 | S-7 | Yes |
| CR8 | K-1 | S-8 | Yes |
| CR9 | K-1 | S-9 | Yes |
| CR10 | K-1 | S-10 | Yes |
| CR11 | K-1 | S-11 | Yes |
| CR12 | K-1 | S-12 | Yes |
| CR13 | K-1 | S-13 | Yes |
| CR14 | K-1 | S-14 | Yes |
| CR15 | K-1 | S-15 | Yes |
| CR16 | K-1 | S-16 | Yes |
| CR17 | K-1 | S-17 | Yes |
| CR18 | K-1 | S-18 | Yes |
| CR19 | K-1 | S-19 | Yes |
| CR20 | K-1 | S-20 | Yes |
| CR21 | K-1 | S-21 | Yes |
| CR22 | K-1 | S-22 | Yes |
| CR23 | K-1 | S-23 | Yes |
| CR24 | K-1 | S-24 | Yes |
| CR25 | K-1 | S-25 | Yes |
| CR26 | K-1 | S-26 | Yes |
| CR27 | K-1 | S-27 | Yes |
| CR28 | K-1 | S-28 | No |
| CR29 | K-1 | S-29 | Yes |
| CR30 | K-1 | S-30 | Yes |
| CR31 | K-1 | S-31 | Yes |
| CR32 | K-1 | S-32 | Yes |
| CR33 | K-1 | S-33 | Yes |
| CR34 | K-1 | S-34 | Yes |
| CR35 | K-1 | S-35 | Yes |
| CR36 | K-1 | S-36 | Yes |
| CR37 | K-1 | S-37 | Yes |
| CR38 | K-1 | S-38 | Yes |
| CR39 | K-1 | S-39 | Yes |
| CR40 | K-1 | S-40 | Yes |
| CR41 | K-1 | S-41 | Yes |
| CR42 | K-1 | S-42 | Yes |

TABLE 1-7

| Charging | AH1 | Spd1/ | HU1 | AH2 | Spd2/ | HU2 | Over | X | Two-layer | HUb | Dv1 | Dv2 | E′1 | E′2 | T |
|---|---|---|---|---|---|---|---|---|---|---|---|---|---|---|---|
| roller No. | [μm] | mm2 | N/mm2 | [μm] | mm2 | N/mm2 | 40/mm2 | [%] | roller | N/mm2 | [μm] | [μm] | [MPa] | [MPa] | [μm] |
| CR1 | 14.0 | 50 | 4.0 | 2.0 | 10000 | 1.5 | 0.3 | 99.6 | ◯ | 3.0 | 22 | 5 | 1000 | 30 | 8 |
| CR2 | 14.0 | 50 | 4.0 | 2.8 | 8000 | 1.5 | 0.3 | 99.4 | ◯ | 3.0 | 22 | 7 | 1000 | 30 | 8 |
| CR3 | 14.0 | 50 | 4.0 | 0.2 | 18000 | 1.5 | 0.6 | 99.5 | ◯ | 3.0 | 22 | 3 | 1000 | 30 | 8 |
| CR4 | 14.0 | 50 | 4.0 | 5.0 | 6000 | 1.5 | 0.6 | 99.4 | ◯ | 3.0 | 22 | 10 | 1000 | 30 | 8 |
| CR5 | 10.3 | 50 | 4.0 | 2.0 | 10000 | 1.5 | 0 | 99.6 | ◯ | 3.0 | 15 | 5 | 1000 | 30 | 8 |
| CR6 | 39.1 | 50 | 4.0 | 2.0 | 10000 | 1.5 | 3.0 | 99.5 | ◯ | 3.0 | 40 | 5 | 1000 | 30 | 8 |
| CR7 | 13.3 | 50 | 4.0 | 2.0 | 10000 | 1.5 | 0.3 | 99.4 | ◯ | 3.0 | 18 | 5 | 1000 | 30 | 8 |
| CR8 | 14.0 | 10 | 4.0 | 2.0 | 10000 | 1.5 | 0.6 | 99.6 | ◯ | 3.0 | 22 | 5 | 1000 | 30 | 8 |
| CR9 | 14.0 | 200 | 4.0 | 2.0 | 10000 | 1.5 | 0.9 | 99.5 | ◯ | 3.0 | 22 | 5 | 1000 | 30 | 8 |
| CR10 | 14.0 | 300 | 4.0 | 2.0 | 10000 | 1.5 | 0.6 | 99.5 | ◯ | 3.0 | 22 | 5 | 1000 | 30 | 8 |
| CR11 | 14.0 | 50 | 1.0 | 2.0 | 10000 | 1.5 | 0.9 | 99.4 | ◯ | 3.0 | 22 | 5 | 10 | 30 | 8 |
| CR12 | 14.0 | 50 | 2.0 | 2.0 | 10000 | 1.5 | 0.9 | 99.6 | ◯ | 3.0 | 22 | 5 | 100 | 30 | 8 |
| CR13 | 14.0 | 50 | 5.0 | 2.0 | 10000 | 1.5 | 0.6 | 99.5 | ◯ | 3.0 | 22 | 5 | 2000 | 30 | 8 |
| CR14 | 11.0 | 50 | 0.5 | 2.0 | 10000 | 1.5 | 0.9 | 99.4 | ◯ | 3.0 | 12 | 5 | 5 | 30 | 4 |
| CR15 | 14.0 | 50 | 10.0 | 2.0 | 10000 | 1.5 | 0.9 | 99.6 | ◯ | 3.0 | 22 | 5 | 1000 | 30 | 8 |
| CR16 | 14.0 | 50 | 4.0 | — | 0 | 1.5 | 0.6 | 98.0 | ◯ | 3.0 | 22 | 1 | 1000 | 30 | 8 |
| CR17 | 14.0 | 50 | 4.0 | — | 0 | 1.5 | 0.6 | 6.5 | ◯ | 3.0 | 22 | 12 | 1000 | 30 | 8 |
| CR18 | 14.0 | 50 | 4.0 | — | — | — | 0.9 | 98.0 | ◯ | 3.0 | 22 | — | 1000 | — | 8 |
| CR19 | 14.0 | 50 | 4.0 | 2.0 | 4000 | 1.5 | 0.6 | 99.5 | ◯ | 3.0 | 22 | 5 | 1000 | 30 | 8 |
| CR20 | 14.0 | 50 | 4.0 | 2.0 | 30000 | 1.5 | 0.6 | 98.0 | ◯ | 3.0 | 22 | 5 | 1000 | 30 | 8 |
| CR21 | 14.0 | 50 | 4.0 | 2.0 | 40000 | 1.5 | 0.9 | 98.0 | ◯ | 3.0 | 22 | 5 | 1000 | 30 | 8 |
| CR22 | 14.0 | 50 | 4.0 | 2.0 | 3000 | 1.5 | 1.5 | 99.5 | ◯ | 3.0 | 22 | 5 | 1000 | 30 | 8 |
| CR23 | 14.0 | 50 | 4.0 | 2.0 | 50000 | 1.5 | 0.6 | 99.5 | ◯ | 3.0 | 22 | 5 | 1000 | 30 | 8 |
| CR24 | 14.0 | 50 | 4.0 | 2.0 | 10000 | 1.5 | 0.9 | 97.0 | ◯ | 3.0 | 22 | 5 | 1000 | 30 | 8 |
| CR25 | 14.0 | 50 | 4.0 | 2.0 | 10000 | 1.5 | 0.9 | 99.4 | ◯ | 5.0 | 22 | 5 | 1000 | 30 | 8 |
| CR26 | 14.0 | 50 | 4.0 | 2.0 | 10000 | 1.5 | 0.6 | 99.6 | ◯ | 1.0 | 22 | 5 | 1000 | 30 | 8 |
| CR27 | 14.0 | 50 | 4.0 | 2.0 | 10000 | 1.5 | 0.9 | 99.5 | ◯ | 10.0 | 22 | 5 | 1000 | 30 | 8 |
| CR28 | 14.0 | 50 | 4.0 | 2.0 | 10000 | 1.5 | 0.6 | 99.4 | ◯ | 0.8 | 22 | 5 | 1000 | 30 | 8 |
| CR29 | 14.0 | 50 | 4.0 | 2.0 | 10000 | 1 | 0.6 | 99.6 | ◯ | 3.0 | 22 | 5 | 1000 | 10 | 8 |
| CR30 | 14.0 | 50 | 4.0 | 2.0 | 10000 | 1.9 | 0.9 | 99.5 | ◯ | 3.0 | 22 | 5 | 1000 | 50 | 8 |
| CR31 | 14.0 | 50 | 4.0 | 2.0 | 10000 | 0.5 | 0.6 | 99.4 | ◯ | 3.0 | 22 | 7 | 1000 | 10 | 8 |
| CR32 | 14.0 | 50 | 4.0 | 2.0 | 10000 | 3 | 0.6 | 99.6 | ◯ | 3.0 | 22 | 5 | 1000 | 1000 | 8 |
| CR33 | 14.0 | 50 | 4.0 | 2.0 | 10000 | 1.5 | 1.9 | 99.4 | ◯ | 3.0 | 22 | 5 | 1000 | 30 | 4 |
| CR34 | 14.0 | 50 | 4.0 | 2.0 | 8000 | 1.5 | 0.3 | 99.6 | ◯ | 3.0 | 22 | 5 | 1000 | 30 | 15 |
| CR35 | — | — | — | — | — | — | 0 | — | ◯ | 3.0 | — | — | — | — | 8 |
| CR36 | 25.0 | 330 | 50.0 | — | — | — | 5.9 | 99.4 | ◯ | 25.0 | 30 | — | 3000 | — | 10 |
| CR37 | 14.0 | 330 | 4.0 | 2.0 | 10000 | 1.5 | 0.9 | 99.6 | ◯ | 3.0 | 22 | 5 | 1000 | 30 | 8 |
| CR38 | 14.0 | 5 | 4.0 | 2.0 | 10000 | 1.5 | 0 | 99.5 | ◯ | 3.0 | 22 | 5 | 1000 | 30 | 25 |
| CR39 | — | — | — | 2.0 | 10000 | 1.5 | 0 | 99.4 | ◯ | 3.0 | — | 5 | — | 30 | 8 |
| CR40 | — | 0 | 4.0 | 2.0 | 10000 | 1.5 | 18.1 | 99.2 | ◯ | 3.0 | 40 | 5 | 1000 | 30 | 4 |
| CR41 | — | 0 | 4.0 | 2.0 | 10000 | 1.5 | 0 | 99.2 | ◯ | 3.0 | 10 | 5 | 1000 | 30 | 25 |
| CR42 | 15.0 | 15 | 25.6 | 2.0 | 10000 | 24.8 | 5.9 | 99.4 | ◯ | 25.0 | 20 | 5 | 3000 | 3000 | 1 |

“AH1” indicates “Average height of group of first protrusions”, and “AH2” indicates “Average height of group of second protrusions”. The unit “/mmv” indicates “number/mm²”. “Over 40” indicates “Number of vertices (number/mm²) of protrusions having a height exceeding 40 μm”. “X” is the “Ratio of first protrusions and second protrusions” and indicates the value of (Spd1+Spd2)/Spda×100. In the “Two-layer roller” column, the reference symbol ◯ indicates that the charging roller has a base layer and a surface layer. “T” indicates “Thickness of surface layer”.

At CR40, protrusions exceeding the height of the first protrusions were formed, and at CR41, no protrusions of 10.0 μm or more that would constitute first protrusions could be confirmed, resulting in a Spd1 of 0. Furthermore, at CR16, no protrusions having a height of 0.2 μm to 5.0 μm that would constitute second protrusions could be confirmed. At CR17, protrusions exceeding 5.0 μm but less than 10.0 μm were observed.

### Production Example of Toner

### Production Example of Titanium Oxide Fine Particles A (T1)

Metatitanic acid obtained by the sulfuric acid method was added with 50% NaOH aqueous solution as NaOH in an amount of 4 times the molar amount of TiO₂, followed by heating at 95° C. for 2 h. After thorough washing, 31% HCl was added to obtain the HCl/TiO₂ ratio of 0.26, followed by heating at the boiling point for 1 h. After cooling, the neutralization to pH 7 was performed with 1N-NaOH, followed by washing and drying to produce rutile-type titanium oxide fine particles.

A total of 100 parts of the rutile-type titanium oxide fine particles were added with 100 parts of NaCl and 25 parts of Na₂P₂O₇·10H₂O, mixing was then performed in a vibrating ball mill for 2 h, and the mixture was fired in an electric furnace at 850° C. for 4 h. The resulting fired product was placed in pure water, heated at 80° C. for 8 h, and then washed to remove soluble salts.

A slurry was prepared by adding 100 g each of methyltrimethoxysilane and trimethoxyfluorosilane and 5 kg of toluene to 1000 kg of each of these base materials. Thorough mixing was then performed using a stirrer, followed by processing using a horizontal continuous sand grinder mill. The processed slurry was then placed in a kneader and dried under reduced pressure to obtain hydrophobic titanium oxide fine particles A (T1). The physical properties of the resulting titanium oxide fine particles A (T1) are shown in Table 2-1-1.

TABLE 2-1-1

| | Major axis | |
|---|---|---|
| Titanium oxide fine | length | Aspect ratio |
| particles A | [μm] | [-] |
| T1 | 2.9 | 13.8 |
| T2 | 1.7 | 13.1 |
| T3 | 1.1 | 11.7 |
| T4 | 1.0 | 5.1 |
| T5 | 5.9 | 15.1 |
| T6 | 5.2 | 19.3 |

The major axis length and aspect ratio are number-average values.

### Production Examples of Titanium Oxide Fine Particles A (T2 to T6)

Titanium oxide fine particles A (T2 to T6) were obtained in the same manner as in the production example of titanium oxide fine particles A (T1), except that the production conditions were changed so that the physical properties of the resulting titanium oxide fine particles A were as shown in Table 2-1-1. The physical properties of titanium oxide fine particles A (T2 to T6) are shown in Table 2-1-1.

### Production Example of Titanium Oxide Fine Particles (t7 to t9)

Titanium oxide fine particles (t7 to t9) were obtained in the same manner as in the production example of titanium oxide fine particles A (T1), except that the production conditions were changed so that the physical properties of the resulting titanium oxide fine particles were as shown in Table 2-1-2. The physical properties of titanium oxide fine particles (t7 to t9) are shown in Table 2-1-2.

TABLE 2-1-2

| | Major axis | |
|---|---|---|
| Titanium oxide fine | length | Aspect ratio |
| particles | [μm] | [-] |
| t7 | 0.15 | 5.0 |
| t8 | 0.08 | 2.7 |
| t9 | 7.0 | 6.0 |

### Production Method of Aliphatic Alcohol Alkylene Oxide Adduct 1

A total of 190 parts of lauryl alcohol and 0.06 parts of aluminum perchlorate nonahydrate were added to a glass autoclave equipped with stirring and temperature control functions. The inside of the mixing system was then purged with nitrogen and dewatered at 95° C. under reduced pressure (approximately 20 mmHg) for 1 h. Next, 90 parts of ethylene oxide (first-stage addition) was added at 95° C. to achieve a gauge pressure of 1 kgf/cm² to 3 kgf/cm².

To this adduct, 0.3 parts of potassium hydroxide was added, and 220 parts (5 moles) of ethylene oxide (second-stage addition) was introduced at 150° C. to maintain a gauge pressure of 1 kgf/cm² to 3 kgf/cm². A total of 3 parts of “Kyoward 600 (manufactured by Kyowa Chemical Industry Co., Ltd.)” was added to the reaction mixture, and the catalyst was adsorbed at 90° C. After filtration, aliphatic alcohol alkylene oxide adduct 1 was obtained.

TABLE 2-2

| | | Number of | Number of |
|---|---|---|---|
| | | parts of | parts of |
| | Type of | aliphatic alcohol | ethylene oxide |
| | aliphatic alcohol | (parts) | (parts) |
| Aliphatic alcohol | lauryl alcohol | 190 | 310 |
| alkylene | | | |
| oxide adduct 1 | | | |
| Aliphatic alcohol | lauryl alcohol | 190 | 440 |
| alkylene | | | |
| oxide adduct 2 | | | |

### Production Method of Aliphatic Alcohol Alkylene Oxide Adduct 2

Aliphatic alcohol alkylene oxide adduct 2 was obtained in the same manner as in the production method of aliphatic alcohol alkylene oxide adduct 1, except that the type of aliphatic alcohol, the number of parts of aliphatic alcohol, and the number of parts of ethylene oxide used were changed as shown in Table 1.

In each production method, ethylene oxide was added in the first and second addition stages in the same proportions by mass as in the production method of aliphatic alcohol alkylene oxide adduct 1.

### Preparation of Resin Particle Dispersion Liquid 1

A total of 78.0 parts of styrene, 20.7 parts of butyl acrylate, 1.3 parts of acrylic acid as a carboxyl group-imparting monomer, and 3.2 parts of n-lauryl mercaptan were mixed and dissolved. The entire amount of an aqueous solution prepared by dissolving 1.0 part of aliphatic alcohol alkylene oxide adduct 1 as compound A and 1.5 part of linear sodium alkylbenzene sulfonate (linear sodium dodecylbenzene sulfonate) (product name: Neogen RK (manufactured by Dai-ichi Kogyo Seiyaku Co., Ltd.)) as compound B in 150 parts of ion-exchanged water was the added to the solution, followed by dispersing.

While stirring slowly for an additional 10 min, an aqueous solution of 0.3 parts of potassium persulfate and 10 parts of ion-exchanged water was added. After purging with nitrogen, emulsion polymerization was carried out at 70° C. for 6 h. After polymerization was completed, the reaction liquid was cooled to room temperature, and ion-exchanged water was added to obtain resin particle dispersion liquid 1 with a solids concentration of 12.5% by mass and a volume-based median diameter of 0.2 μm.

TABLE 2-3

| Resin | | | | |
|---|---|---|---|---|
| particle | | | | |
| dispersion | | Compound | | Compound B |
| liquid No. | Type of compound A | A (parts) | Type of compound B | (parts) |
| 1 | Aliphatic alcohol alkylene | 1.0 | Linear sodium alkylbenzene | 1.5 |
| | oxide adduct 1 | | sulfonate | |
| 2 | Aliphatic alcohol alkylene | 0.8 | Linear sodium alkylbenzene | 1.5 |
| | oxide adduct 2 | | sulfonate | |
| 3 | Aliphatic alcohol alkylene | 1.0 | Branched sodium alkylbenzene | 1.5 |
| | oxide adduct 1 | | sulfonate | |
| 4 | Aliphatic alcohol alkylene | 1.0 | Sodium stearate | 1.2 |
| | oxide adduct 1 | | | |
| 5 | Aliphatic alcohol alkylene | 2.0 | — | — |
| | oxide adduct 1 | | | |
| 6 | — | — | Linear sodium alkylbenzene | 3.0 |
| | | | sulfonate | |

### Preparation of Resin Particle Dispersion Liquids 2 to 6

Resin particle dispersion liquids 2 to 6 were obtained in the same manner as resin particle dispersion liquid 1, except that the types and amounts of compound A and compound B were as shown in Table 2-3. The compounds used are listed in Table 2-3.

The branched sodium dodecylbenzene sulfonate (branched sodium alkylbenzene sulfonate) shown in Table 2-3 was manufactured by Kanto Chemical Co., Inc., product number 37202-11, and the sodium stearate used was manufactured by Kanto Chemical Co., Inc., product number 37275-01.

### Preparation of Release Agent Dispersion Liquid 1

A total of 100 parts of a release agent (behenyl behenate, melting point: 72.1° C.) and 15 parts of aliphatic alcohol alkylene oxide adduct 1 were mixed with 385 parts of ion-exchanged water and dispersed for approximately 1 h using a wet jet mill JN100 (manufactured by Joko Co., Ltd.) to obtain a release agent dispersion liquid. The concentration of the release agent dispersion liquid was 20% by mass.

### Preparation of Release Agent Dispersion Liquid 2

Release agent dispersion liquid 2 was obtained in the same manner as in the preparation of release agent dispersion liquid 1, except that aliphatic alcohol alkylene oxide adduct 1 was replaced with the linear sodium alkylbenzene sulfonate.

### Preparation of Colorant Dispersion Liquid 1

A total of 100 parts of carbon black “Nipex 35 (manufactured by Orion Engineered Carbons LLC)” as a colorant and 15 parts of aliphatic alcohol alkylene oxide adduct 1 were mixed with 885 parts of ion-exchanged water and dispersed for approximately 1 h using a wet jet mill JN100 to obtain a colorant dispersion liquid.

### Preparation of Colorant Dispersion Liquid 2

Colorant dispersion liquid 2 was obtained in the same manner as in the preparation of colorant dispersion liquid 1, except that aliphatic alcohol alkylene oxide adduct 1 was replaced with the linear sodium alkylbenzene sulfonate.

### Production Example of Toner Particles 1

### Dispersion Step

A total of 265 parts of resin particle dispersion liquid 1, 10 parts of release agent dispersion liquid 1, 10 parts of colorant dispersion liquid 1, 2.9 parts of aliphatic alcohol alkylene oxide adduct 1, and 0.6 parts of linear sodium alkylbenzene sulfonate (Neogen RK) were dispersed using a homogenizer (Ultra-Turrax T50, manufactured by IKA Works, Inc.). The temperature inside the container was adjusted to 30° C. under stirring, and a 1 mol/L aqueous sodium hydroxide solution was added to adjust the pH to 8.0.

### Aggregation Step

As a flocculant, an aqueous solution obtained by dissolving 0.08 parts of aluminum chloride in 10 parts of ion-exchange water was added at 30° C. over 10 min under stirring. After allowing the mixture to stand for 3 min, the temperature was raised to 50° C. to form associated particles. The particle size of the associated particles was measured using a Coulter Counter Multisizer 3 (registered trademark, manufactured by Beckman Coulter, Inc.). When the weight-average particle diameter reached 7.0 μm, 0.9 parts of sodium chloride and 5.0 parts of aliphatic alcohol were added to stop particle growth.

After adjusting the pH to 9.0 with a 1 mol/L aqueous sodium hydroxide solution, the temperature was raised to 95° C. to spheroidize the aggregated particles. When the average circularity reached 0.980, the temperature was lowered and the mixture was cooled to room temperature, yielding toner particle dispersion liquid 1.

### Washing Step

The resulting toner particle dispersion liquid 1 was adjusted to a pH of 1.5 or less by adding hydrochloric acid. The liquid was stirred and allowed to stand for 1 h and then subjected to solid-liquid separation using a pressure filter to obtain a toner cake. The toner cake was then reslurried with ion-exchanged water to form a dispersion liquid again, which was then subjected to solid-liquid separation using the same filter. The reslurrying and solid-liquid separation were repeated until the electrical conductivity of the filtrate reached 5.0 S/cm or less, after which final solid-liquid separation was performed to obtain a toner cake. The resulting toner cake was dried and further classified using a classifier to obtain toner particles 1. The number-average particle diameter of the primary particles of toner particles 1 was 7.0 μm.

### Production Examples of Toner Particles 2 to 7

Toner particles 2 to 7 were obtained in the same manner as in the production example of toner particles 1, except that the resin particle dispersion liquid, release agent dispersion liquid, colorant dispersion liquid, and the types and amounts of compound A and compound B added during the dispersion step were changed as shown in Table 2-4-1.

TABLE 2-4-1

| | Resin | Release | | Compound A | | Compound B | |
|---|---|---|---|---|---|---|---|
| Toner | particle | agent | Colorant | | Amount | | Amount |
| particle | dispersion | dispersion | dispersion | | added | | added |
| No. | liquid | liquid | liquid | Name | (parts) | Name | (parts) |
| 1 | Resin | Release | Colorant | Aliphatic alcohol | 2.9 | Linear sodium | 0.6 |
| | particle | agent | dispersion | alkylene oxide | | alkylbenzene | |
| | dispersion | dispersion | liquid 1 | adduct 1 | | sulfonate | |
| | liquid 1 | liquid 1 | | | | | |
| 2 | Resin | Release | Colorant | Aliphatic alcohol | 1.0 | Linear sodium | 2.6 |
| | particle | agent | dispersion | alkylene oxide | | alkylbenzene | |
| | dispersion | dispersion | liquid 1 | adduct 2 | | sulfonate | |
| | liquid 2 | liquid 1 | | | | | |
| 3 | Resin | Release | Colorant | Aliphatic alcohol | 0.4 | Linear sodium | 0.6 |
| | particle | agent | dispersion | alkylene oxide | | alkylbenzene | |
| | dispersion | dispersion | liquid 1 | adduct 2 | | sulfonate | |
| | liquid 2 | liquid 1 | | | | | |
| 4 | Resin | Release | Colorant | Aliphatic alcohol | 3.7 | — | — |
| | particle | agent | dispersion | alkylene oxide | | | |
| | dispersion | dispersion | liquid 1 | adduct 1 | | | |
| | liquid 5 | liquid 1 | | | | | |
| 5 | Resin | Release | Colorant | — | — | Linear sodium | 1.6 |
| | particle | agent | dispersion | | | alkylbenzene | |
| | dispersion | dispersion | liquid 2 | | | sulfonate | |
| | liquid 6 | liquid 2 | | | | | |
| 6 | Resin | Release | Colorant | Aliphatic alcohol | 3.4 | Branched | 0.6 |
| | particle | agent | dispersion | alkylene oxide | | sodium | |
| | dispersion | dispersion | liquid 1 | adduct 1 | | alkylbenzene | |
| | liquid 3 | liquid 1 | | | | sulfonate | |
| 7 | Resin | Release | Colorant | Aliphatic alcohol | 3.4 | Sodium | 2.8 |
| | particle | agent | dispersion | alkylene oxide | | stearate | |
| | dispersion | dispersion | liquid 1 | adduct 1 | | | |
| | liquid 4 | liquid 1 | | | | | |

### Production Example of Toner Particles 8

### Binder Resin

In the production of toner particles 8, the resin in Table 2-4-2 was used as the binder resin.

TABLE 2-4-2

| | Composition |
|---|---|
| Binder | Polyoxypropylene (2.2)-2,2-bis(4-hydroxyphenyl)propane:polyoxyethylene (2.2)- |
| resin 1 | 2,2-bis(4-hydroxyphenyl)propane:ethylene glycol:terephthalic acid:isophthalic |
| | acid:trimellitic acid = 44:7:17:26:1:5, Tg = 60° C., softening point = 100° C. |
| Binder | Polyoxypropylene (2.2)-2,2-bis(4-hydroxyphenyl)propane:polyoxyethylene (2.2)- |
| resin 2 | 2,2-bis(4-hydroxyphenyl)propane:terephthalic acid:trimellitic acid = 41:9:40: |
| | 10, Tg = 59° C., softening point = 140° C. |

The ratios of monomers in the table are molar ratios.
Binder resin 1: 40 parts by mass
Binder resin 2: 60 parts by mass
Paraffin wax (HNP51, manufactured by Nippon Seiro Co., Ltd.): 2.0 parts by mass
Monoazo dye iron complex (T-77, manufactured by Hodogaya Chemical Co., Ltd.): 2.0 parts by mass
Carbon black “Nipex 35 (manufactured by Orion Engineered Carbons LLC)”: 7.0 parts by mass

The above materials were mixed using a Henschel mixer (FM-75, manufactured by Mitsui Mining Co., Ltd.) at a rotation speed of 20 s⁻¹ for a rotation time of 5 min, and then kneaded in a twin-screw kneader (PCM-30, manufactured by Ikegai Corporation) set to a temperature of 140° C. The resulting kneaded mixture was cooled to 25° C. and coarsely pulverized to 1 mm or less using a hammer mill to obtain a coarsely pulverized product. The resulting coarsely pulverized product was then finely pulverized using a mechanical pulverizer (T-250, manufactured by Turbo Kogyo Co., Ltd.). Classification was performed using a multi-division classifier utilizing the Coanda effect to obtain toner particles 8 with a weight-average particle diameter (D4) of 7.0 μm.

### Production Example of Toner 1

### External Addition Step

Toner particles 1 (100.00 parts) obtained above and 0.8 parts of silica fine particles 1 (RY300: manufactured by Nippon Aerosil Co., Ltd.) and 1.0 part of titanium oxide fine particles A (T1) as external additives were loaded in an FM mixer (FM10C model, manufactured by Nippon Coke and Engineering Co., Ltd.) in which water at 7° C. was flowing through the jacket.

After the water temperature inside the jacket stabilized at 7° C.±1° C., mixing was performed for 3 min at a rotating blade speed of 3200 rpm to obtain toner mixture 1. During this process, the amount of water passing through the jacket was adjusted, as appropriate, to prevent the temperature inside the FM mixer tank from exceeding 25° C.

The resulting toner mixture 1 was sieved through a 75 μm mesh to obtain toner 1. The production conditions for toner 1 are shown in Table 2-5, and the physical properties of (the toner are shown in Table 2-6.

### Production Examples of Toners 2 to 20

Toners 2 to 20 were obtained in the same manner as in the production example of toner 1, except that the type and quantity of toner particles and titanium oxide fine particles A, as well as the external addition conditions, were changed to those shown in Table 2-5. The physical properties of the toners are shown in Table 2-6.

TABLE 2-5

| | Toner | | Silica fine | | Titanium oxide | | Titanium oxide | | External addition | |
|---|---|---|---|---|---|---|---|---|---|---|
| | particle | | particles | | fine particles A | | fine particles | | condition | |
| | | Amount | | Amount | | Amount | | Amount | Rotation | |
| Toner | | added | | added | | added | | added | speed | Time |
| No. | No. | (parts) | No. | (parts) | No. | (parts) | No. | (parts) | [rpm] | (min) |
| 1 | 1 | 100 | 1 | 0.8 | T1 | 1.0 | — | — | 3200 | 3 |
| 2 | 2 | 100 | 1 | 0.8 | T1 | 1.5 | — | — | 3200 | 3 |
| 3 | 3 | 100 | 1 | 0.8 | T2 | 1.0 | — | — | 3200 | 3 |
| 4 | 1 | 100 | 1 | 0.8 | T3 | 1.0 | — | — | 3200 | 3 |
| 5 | 1 | 100 | 1 | 0.8 | T4 | 1.0 | — | — | 3200 | 3 |
| 6 | 1 | 100 | 1 | 0.8 | T5 | 1.0 | — | — | 3200 | 3 |
| 7 | 3 | 100 | 1 | 0.8 | T3 | 1.0 | — | — | 3200 | 3 |
| 8 | 1 | 100 | 1 | 0.8 | T6 | 1.0 | — | — | 3200 | 3 |
| 9 | 1 | 100 | 1 | 0.8 | T1 | 1.0 | — | — | 3500 | 5 |
| 10 | 1 | 100 | 1 | 0.8 | T1 | 1.0 | — | — | 4000 | 10 |
| 11 | 1 | 100 | 1 | 0.8 | T1 | 0.7 | — | — | 3200 | 3 |
| 12 | 1 | 100 | 1 | 0.8 | T1 | 0.5 | — | — | 3200 | 3 |
| 13 | 4 | 100 | 1 | 0.8 | T1 | 1.0 | — | — | 3200 | 3 |
| 14 | 5 | 100 | 1 | 0.8 | T1 | 1.0 | — | — | 3200 | 3 |
| 15 | 6 | 100 | 1 | 0.8 | T1 | 1.0 | — | — | 3200 | 3 |
| 16 | 7 | 100 | 1 | 0.8 | T1 | 1.0 | — | — | 3200 | 3 |
| 17 | 8 | 100 | 1 | 0.8 | T1 | 1.0 | — | — | 3200 | 3 |
| 18 | 1 | 100 | 1 | 0.8 | — | — | t7 | 1.0 | 3200 | 3 |
| 19 | 1 | 100 | 1 | 0.8 | — | — | t8 | 1.0 | 3200 | 3 |
| 20 | 1 | 100 | 1 | 0.8 | — | — | t9 | 1.0 | 3200 | 3 |

TABLE 2-6

| | | | | | (1) | m/z = | m/z = 183 | | |
|---|---|---|---|---|---|---|---|---|---|
| Toner | AA | PTA | Average | | Content | 325, | or 197, | | P/N |
| No. | [%] | [%] | M/Z | P value | [ppm] | peak | peak | N value | ratio |
| 1 | 25 | 95 | 542 | 992068 | 976 | Present | Present | 1071553 | 0.93 |
| 2 | 25 | 97 | 680 | 618547 | 284 | Present | Present | 1702341 | 0.36 |
| 3 | 30 | 97 | 679 | 393213 | 57 | Present | Present | 510322 | 0.77 |
| 4 | 35 | 98 | 542 | 992068 | 976 | Present | Present | 1071553 | 0.93 |
| 5 | 35 | 99 | 542 | 992068 | 976 | Present | Present | 1071553 | 0.93 |
| 6 | 20 | 93 | 542 | 992068 | 976 | Present | Present | 1071553 | 0.93 |
| 7 | 30 | 98 | 679 | 393213 | 57 | Present | Present | 510322 | 0.77 |
| 8 | 25 | 94 | 542 | 992068 | 976 | Present | Present | 1071553 | 0.93 |
| 9 | 40 | 97 | 542 | 992068 | 976 | Present | Present | 1071553 | 0.93 |
| 10 | 50 | 99 | 542 | 992068 | 976 | Present | Present | 1071553 | 0.93 |
| 11 | 25 | 90 | 542 | 992068 | 976 | Present | Present | 1071553 | 0.93 |
| 12 | 25 | 80 | 542 | 992068 | 976 | Present | Present | 1071553 | 0.93 |
| 13 | 25 | 95 | 563 | 1216920 | 1108 | Present | Present | — | — |
| 14 | 25 | 95 | — | — | — | Present | Present | 3914599 | — |
| 15 | 25 | 95 | 563 | 929885 | 918 | Present | Present | 1472911 | 0.63 |
| 16 | 25 | 95 | 542 | 991368 | 988 | Present | Present | 1190032 | 0.83 |
| 17 | 25 | 95 | — | — | — | — | — | — | — |
| 18 | — | — | 542 | 992068 | 976 | Present | Present | 1071553 | 0.93 |
| 19 | — | — | 542 | 992068 | 976 | Present | Present | 1071553 | 0.93 |
| 20 | — | — | 542 | 992068 | 976 | Present | Present | 1071553 | 0.93 |

In the Table 2-6, “AA” indicates “Adhesion rate of titanium oxide fine particles A”, and “PTA” indicates “Proportion of toner particles containing titanium oxide fine particles A”. (1) The content is the content ratio (ppm by mass) of the structure represented by formula (1) contained in compound A. Column of “m/z=325, peak” indicates presence/absence of peak detected at m/z=325 in ESI/MVS analysis. Column of “m/z=183 or 197, peak” indicates presence/absence of peak detected at m/z=183 or m/z=197.

Toners 1 to 18 had a reference peak in their mass spectrometry spectra.

Furthermore, in analysis under analysis condition A, for toners 1 to 18, except for toner 14 (1 to 13 and 15 to 18), compound A was detected as an ionized cation.

In analysis under analysis condition A, for toners 1 to 18, except for toner 13 (1 to 12 and 14 to 18), compound B was detected as an ionized anion.

### Example 1

The following evaluation was conducted using toner 1 and charging roller CR1 in an ultra-low-temperature environment (air temperature 0° C., humidity 20%).

A modified version of the commercially available Canon laser beam printer “hp LaserJet Enterprise 670ldn” was used for the evaluation. The modification involved changing the software for the evaluation machine to increase the process speed by a factor of 1.3, thereby making it possible to perform printing tests by using only the black station. As for the cartridge, the volume of the toner container was also doubled to enable evaluation. This made it possible to perform durability evaluation for a longer life in the machine with a higher speed than in the conventional printers. The cartridge was filled with 400 g of the test toner for the evaluation.

Evaluation 1. Number of Occurring Halftone Dots after Durability Evaluation in Ultra-Low-Temperature Environment

A printer body and a toner cartridge filled with 400 g of the example toner were allowed to stand in an ultra-low-temperature environment (air temperature 0° C., relative humidity 20%) for 24 h with an object of controlling the temperature and humidity in the evaluation environment. After that, a durability evaluation was conducted in the same ultra-low-temperature environment by using letter-size “vitality” paper (LTR 75 g/m²; manufactured by XEROX Corp.) and printing 40,000 sheets with a horizontal line image with a print percentage of 1.5% and a margin of 5 mm, with two sheets per one job.

Then, as the 40,001st sheet, one halftone image with a print percentage of 23%, a margin of 23% and a margin of 5 mm was printed (halftone image 1).

Halftone image 1 was observed using a magnifying glass, and the number of portions on the halftone image on which no toner was present and which appeared as white dots (white spots) against the surrounding area, and the number of areas on the halftone image on which too much toner was present and which appeared as black dots (black spots) against the surrounding area were counted, and the total number of these was counted as halftone dots.

The less likely it is that a poor electric discharge will occur with respect to the photosensitive drum due to contamination of the charging roller, the smaller the number of halftone dots will be after a durability evaluation in an ultra-low-temperature environment. For this reason, the evaluation was conducted according to the following criteria.

(Halftone Dots after Durability Evaluation in Ultra-Low-Temperature Environment)
A. The number of halftone dots after durability evaluation is 3 or less.
B. The number of halftone dots after durability evaluation is from 4 to 6.
C. The number of halftone dots after durability evaluation is from 7 to 9.
D. The number of halftone dots after durability evaluation is from 10 to 12.
E. The number of halftone dots after durability evaluation is 13 or more.
   Evaluation 2. Change in the Number of Occurring Halftone Dots Before and After the Printer and Cartridge are Allowed to Stand for a Long Time after Durability Evaluation

After printing halftone image 1 in Evaluation 1, the printer and the durability-evaluated cartridge were allowed to stand in the same ultra-low-temperature environment (air temperature 0° C., relative humidity 20%) for 7 days.

After that, as the 40,002nd sheet, one halftone image with a print percentage of 23%, a margin of 23%, and a margin of 5 mm (halftone image 2) was printed using letter-size “vitality” paper (LTR 75 g/m²; manufactured by XEROX Corp.) in an ultra-low-temperature environment.

Halftone image 2 was observed using a magnifying glass, and the number of portions on the halftone image on which no toner was present and which appeared as white dots (white spots) against the surrounding area, and the number of areas on the halftone image on which too much toner was present and which appeared as black dots (black spots) against the surrounding area were counted, and the total number of these was counted as halftone dots.

The less likely it is that a poor electric discharge will occur with respect to the photosensitive drum due to contamination of the charging roller, the smaller the number of halftone dots will be after a durability evaluation in an ultra-low-temperature environment. The evaluation was performed according to the following criteria.

The more uniform charging of the photosensitive drum by the charging roller is maintained, even after allowing to stand for a long time in an ultra-low-temperature environment, the smaller the change in the number of occurring halftone dots. For this reason, the evaluation was conducted according to the following criteria.

Change in the Number of Occurring Halftone Dots Before and After Printer and Cartridge are Allowed to Stand for Long Time after Durability Evaluation
A. The change in the number of occurring halftone dots before and after the printer and cartridge are allowed to stand for a long time after a durability evaluation is 2 or less.
B. The change in the number of occurring halftone dots before and after the printer and cartridge are allowed to stand for a long time after a durability evaluation is from 3 to 5.
C. The change in the number of occurring halftone dots before and after the printer and cartridge are allowed to stand for a long time after a durability evaluation is from 6 to 8.
D. The change in the number of occurring halftone dots before and after the printer and cartridge are allowed to stand for a long time after a durability evaluation is from 9 to 11.
E. The change in the number of occurring halftone dots before and after the printer and cartridge are allowed to stand for a long time after a durability evaluation is 12 or more.
   Evaluation 3. Number of Occurring Halftone Dots after Durability Evaluation Using Thick Paper

The printer and the toner cartridge filled with 400 g of example toner were allowed to stand in an ultra-low-temperature environment (air temperature 0° C., relative humidity 20%) for 24 h to control the temperature and humidity in the evaluation environment. After that, a durability evaluation was conducted in the same ultra-low-temperature environment by using Red Label (A4 80 g/m², manufactured by Canon Inc.), which is paper thicker than in Evaluation 1, and printing 40,000 sheets with a horizontal line image with a print percentage of 1.5% and a margin of 5 mm, with two sheets per one job in the same manner as in Evaluation 1, except that a thick paper mode was selected.

Then, as the 40,001st sheet, one halftone image with a print percentage of 23%, a margin of 23% and a margin of 5 mm was printed (halftone image 3).

Halftone image 3 was observed using a magnifying glass, and the number of portions on the halftone image on which no toner was present and which appeared as white dots (white spots) against the surrounding area, and the number of areas on the halftone image on which too much toner was present and which appeared as black dots (black spots) against the surrounding area were counted, and the total number of these was counted as halftone dots.

When using thick paper and setting the thick paper mode to evaluate durability, the transfer current and transfer voltage when transferring toner to the paper are set high. This makes it easier for strong electric discharge to occur between the paper and the photosensitive drum during the transfer step, resulting in a lower potential on the photosensitive drum before the charging step than in a usual paper mode. This requires a higher electric discharge to charge the photosensitive drum during the charging step, which creates harsh conditions under which electric discharge failures between the charging roller and the photosensitive drum are more likely to occur. Even under such harsh conditions, the less likely it is that a poor electric discharge will occur with respect to the photosensitive drum due to contamination of the charging roller, the smaller the number of halftone dots. The evaluation was conducted using the following criteria.

Number of Occurring Halftone Dots after Durability Evaluation Using Thick Paper
A. The number of halftone dots after durability evaluation using thick paper is 3 or less.
B. The number of halftone dots after durability evaluation using thick paper is from 4 to 6.
C. The number of halftone dots after durability evaluation using thick paper is from 7 to 9.
D. The number of halftone dots after durability evaluation using thick paper is from 10 to 12.
E. The number of halftone dots after durability evaluation using thick paper is 13 or more.
   Evaluation 4. Difference in the Number of Occurring Halftone Dots Between Sheets after Durability Evaluation Using Thick Paper

After printing halftone image 3 in Evaluation 3, ten consecutive halftone images with a print percentage of 23%, a margin of 23%, and a margin of 5 mm were printed in one job (halftone image set 4) in the same ultra-low-temperature environment (air temperature 0° C., relative humidity 20%).

Halftone image set 4 (10 sheets in total) was observed using a magnifying glass, and the number of dots was counted for each halftone image in the same manner as in Evaluation 1. The difference in the number of dots between the image with the largest number and the image with the smallest number of halftone dots in halftone image set 4 was then calculated and used as the difference in the number of occurring halftone dots between sheets.

Using thick paper and setting the thick paper mode for a durability evaluation, as described in Evaluation 3, create harsh conditions under which electric discharge failures between the charging roller and the photosensitive drum are more likely to occur. Even when printing 10 images continuously under these harsh conditions, the less likely it is that a poor electric discharge will occur with respect to the photosensitive drum due to contamination of the charging roller, the smaller the difference in the number of occurring halftone dots between sheets after durability evaluation using thick paper. The evaluation was conducted using the following criteria.

Difference in the Number of Occurring Halftone Dots Between Sheets after Durability Evaluation Using Thick Paper
A. The difference in the number of occurring halftone dots between sheets is 2 or less.
B. The difference in the number of occurring halftone dots between sheets is from 3 to 5.
C. The difference in the number of occurring halftone dots between sheets is from 6 to 8.
D. The difference in the number of occurring halftone dots between sheets is from 9 to 11.
E. The difference in the number of occurring halftone dots between sheets is 12 or more.
   Evaluation 5. Number of Occurring Halftone Dots after Durability Evaluation in Image Forming Apparatus with Pre-Exposure Means

Durability evaluation of 40,001 sheets was conducted in the same manner as in Evaluation 1, except that the modified hp LaserJet Enterprise 670ldn used for the evaluation in Evaluation 1 was equipped with a means for performing exposure before charging the photosensitive drum with the charging roller, and the software was modified to adjust the surface potential of the photosensitive drum after passing the charging roller to the same level as before the pre-exposure unit was installed.

Subsequently, as the 40,001st sheet, one halftone image with a print percentage of 23%, a margin of 23%, and a margin of 5 mm was printed (halftone image 5).

The number of halftone dots was counted for halftone image 5 in the same manner as in Evaluation 1. When using an image forming apparatus with a pre-exposure means, the potential on the photosensitive drum is completely reset and then charging is performed to a desired drum potential with a charging roller, which tends to result in a larger electric discharge amount when charging with the charging roller. Since a higher electric discharge amount increases the likelihood of electric discharge failure due to contamination of the charging roller, this evaluation is more stringent than Evaluation 1 in terms of generation of halftone dots. The evaluation was based on the following criteria:

Number of Occurring Halftone Dots after Durability Evaluation in Image Forming Apparatus with Pre-Exposure Means
A. The number of halftone dots after a durability evaluation is 3 or less.
B. The number of halftone dots after a durability evaluation is from 4 to 6.
C. The number of halftone dots after a durability evaluation is from 7 to 9.
D. The number of halftone dots after a durability evaluation is from 10 to 12.
E. The number of halftone dots after a durability evaluation is 13 or more.
   Evaluation 6. Number of Occurring Halftone Dots after Durability Evaluation at Low Development Light Quantity Settings

Durability evaluation of 40,000 sheets was conducted in the same manner as in Evaluation 1, except that the software was modified and the light quantity was changed so that the light quantity of the laser beam radiated onto the photosensitive drum during the development step became ⅔ the original amount.

Subsequently, as the 40,001st sheet, one halftone image with a print percentage of 23%, a margin of 23%, and a margin of 5 mm was printed (halftone image 6).

The number of halftone dots was counted for halftone image 6 in the same manner as in Evaluation 1. The lower the laser light quantity radiated onto the photosensitive drum during the development step, the more likely it is that even slight electric discharge failure caused by contamination of the charging roller will manifest itself as halftone dots. Therefore, this evaluation is more stringent than Evaluation 1 in terms of the generation of halftone dots. For this reason, the evaluation was conducted according to the following criteria.

Number of Occurring Halftone Dots after Durability Evaluation at Low Development Light Quantity Settings
A. The number of halftone dots after durability evaluation is 3 or less.
B. The number of halftone dots after durability evaluation is from 4 to 6.
C. The number of halftone dots after durability evaluation is from 7 to 9.
D. The number of halftone dots after durability evaluation is from 10 to 12.
E. The number of halftone dots after durability evaluation is 13 or more.
   Evaluation 7. Difference in the Number of Occurring Halftone Dots Between Sheets after Durability Evaluation at Low Development Light Quantity Settings

After printing halftone image 6 in Evaluation 6, ten consecutive halftone images with a print percentage of 23%, a margin of 23%, and a margin of 5 mm were printed in one job (halftone image set 7) in the same ultra-low-temperature environment (air temperature 0° C., relative humidity 20%).

Halftone image set 7 (10 sheets in total) was observed using a magnifying glass, and the number of dots was counted for each halftone image in the same manner as in Evaluation 1. The difference in the number of dots between the image with the largest number and the image with the smallest number of halftone dots in halftone image set 7 was then calculated and used as the difference in the number of occurring halftone dots between sheets.

The lower the laser light quantity radiated onto the photosensitive drum during the development process, the more likely it is that even slight electric discharge failure occurring due to contamination of the charging roller will manifest itself as halftone dots. Even when printing 10 images continuously under these harsh conditions, the less likely it is that a poor electric discharge will occur with respect to the photosensitive drum due to contamination of the charging roller, the smaller the difference in the number of halftone dots between sheets after a durability evaluation at a low development light quantity setting. The evaluation was conducted based on the following criteria.

Difference in the Number of Halftone Dots Between Sheets after Durability Evaluation at Low Development Light Quantity Setting
A. The difference in the number of halftone dots between sheets is 2 or less.
B. The difference in the number of halftone dots between sheets is from 3 to 5.
C. The difference in the number of halftone dots between sheets is from 6 to 8.
D. The difference in the number of halftone dots between sheets is from 9 to 11.
E. The difference in the number of halftone dots between sheets is 12 or more.
   Evaluation 8. Number of Occurring Halftone Dots after Durability Evaluation at a Low Print Percentage in an Ultra-Low-Temperature Environment

The durability evaluation was conducted in the same manner as in Evaluation 1, except that in Evaluation 1, 40,000 sheets with a horizontal line image were printed with a print percentage of 0.5% rate and a margin of 5 mm, with two sheets per job.

Subsequently, as the 40,001st sheet, one halftone image with a print percentage of 23%, a margin of 23%, and a margin of 5 mm was printed (halftone image 8).

Halftone image 8 was observed using a magnifying glass, and the number of portions on the halftone image on which no toner was present and which appeared as white dots (white spots) against the surrounding area, and the number of areas on the halftone image on which too much toner was present and which appeared as black dots (black spots) against the surrounding area were counted, and the total number of these was counted as halftone dots.

During the durability evaluation at a low print percentage, toner is not easily supplied from the toner on the developing roller to the photosensitive drum, making it difficult for titanium oxide particles A to be supplied to the charging roller via the photosensitive drum and cleaning blade. This creates stringent evaluation conditions under which a poor electric discharge is likely to occur when the charging roller is contaminated. For this reason, the evaluation was conducted according to the following criteria.

Number of Halftone Dots after Durability Evaluation at Low Print Percentage
A. The number of halftone dots after durability evaluation is 3 or less.
B. The number of halftone dots after durability evaluation is from 4 to 6.
C. The number of halftone dots after durability evaluation is from 7 to 9.
D. The number of halftone dots after durability evaluation is from 10 to 12.
E. The number of halftone dots after durability evaluation is 13 or more.
   Evaluation 9. Number of Halftone Dots Occurring after High-Print-Percentage Durability Evaluation in Ultra-Low-Temperature Environment

The durability evaluation was conducted in the same manner as in Evaluation 1, except that in Evaluation 1, 5000 solid images with a print percentage of 100% (all black) and a margin of 5 mm were printed, with two sheets per job.

Subsequently, as the 5001st sheet, one halftone image with a print percentage of 23%, a margin of 23%, and a margin of 5 mm was printed (halftone image 9).

Halftone image 9 was observed using a magnifying glass, and the number of portions on the halftone image on which no toner was present and which appeared as white dots (white spots) against the surrounding area, and the number of areas on the halftone image on which too much toner was present and which appeared as black dots (black spots) against the surrounding area were counted, and the total number of these was counted as halftone dots.

In high-print-percentage durability evaluation, a large amount of toner is supplied from the toner on the developing roller to the photosensitive drum. Therefore, the untransferred toner easily slips through the cleaning step, thereby creating stringent conditions under which the charging roller is likely to be contaminated with toner and a poor electric discharge is likely to occur. For this reason, evaluation was conducted under stringent conditions.

Number of Halftone Dots Occurring after High-Print-Percentage Durability Evaluation
A. The number of halftone dots after durability evaluation is 3 or less.
B. The number of halftone dots after durability evaluation is from 4 to 6.
C. The number of halftone dots after durability evaluation is from 7 to 9.
D. The number of halftone dots after durability evaluation is from 10 to 12.
E. The number of halftone dots after durability evaluation is 13 or more.

Table 3-1 shows the relationship between the combination of charging roller and toner, the physical properties of the charging roller, and the physical properties of the toner and also the contact line pressure of the cleaning blade in Example 1.

The evaluation results for Example 1 are shown in Table 3-2.

### Examples 2 to 49 and Comparative Examples 1 to 11

An image forming apparatus was prepared in the same manner as Example 1, except that the charging roller and toner in Example 1 were changed as shown in Table 3-1. Table 3-1 also lists the physical properties of the charging roller, the physical properties of the toner, and the contact line pressure of the cleaning blade for each Example and Comparative Example.

The evaluation results for Examples 1 to 49 and Comparative Examples 1 to 11 are shown in Table 3-2.

TABLE 3-1

| | | | Average major axis of | Average major axis of | |
|---|---|---|---|---|---|
| | | | titanium oxide fine | titanium oxide fine | Contact line |
| | | | particles/average height | particles − average | pressure of |
| Example | Charging | Toner | of group of first | height of group of | cleaning blade |
| No. | roller No. | No. | protrusions | second protrusions | N/m |
| 1 | CR1 | 1 | 0.21 | 0.9 | 25 |
| 2 | CR2 | 2 | 0.21 | 0.1 | 25 |
| 3 | CR1 | 3 | 0.12 | −0.3 | 25 |
| 4 | CR3 | 4 | 0.08 | 0.9 | 25 |
| 5 | CR3 | 5 | 0.07 | 0.8 | 25 |
| 6 | CR4 | 6 | 0.42 | 0.9 | 25 |
| 7 | CR5 | 1 | 0.28 | 0.9 | 25 |
| 8 | CR6 | 1 | 0.07 | 0.9 | 25 |
| 9 | CR6 | 3 | 0.04 | −0.3 | 25 |
| 10 | CR6 | 7 | 0.04 | −0.3 | 25 |
| 11 | CR7 | 8 | 0.39 | 3.2 | 25 |
| 12 | CR5 | 8 | 0.50 | 3.2 | 25 |
| 13 | CR8 | 1 | 0.21 | 0.9 | 25 |
| 14 | CR9 | 1 | 0.21 | 0.9 | 25 |
| 15 | CR10 | 1 | 0.21 | 0.9 | 25 |
| 16 | CR11 | 1 | 0.21 | 0.9 | 25 |
| 17 | CR12 | 1 | 0.21 | 0.9 | 25 |
| 18 | CR13 | 1 | 0.21 | 0.9 | 25 |
| 19 | CR14 | 1 | 0.21 | 0.9 | 25 |
| 20 | CR15 | 1 | 0.21 | 0.9 | 25 |
| 21 | CR16 | 4 | 0.08 | — | 25 |
| 22 | CR17 | 6 | 0.42 | — | 25 |
| 23 | CR18 | 1 | 0.21 | — | 25 |
| 24 | CR19 | 1 | 0.21 | 0.9 | 25 |
| 25 | CR20 | 1 | 0.21 | 0.9 | 25 |
| 26 | CR21 | 1 | 0.21 | 0.9 | 25 |
| 27 | CR22 | 1 | 0.21 | 0.9 | 25 |
| 28 | CR23 | 1 | 0.21 | 0.9 | 25 |
| 29 | CR24 | 1 | 0.21 | 0.9 | 25 |
| 30 | CR25 | 1 | 0.21 | 0.9 | 25 |
| 31 | CR26 | 1 | 0.21 | 0.9 | 25 |
| 32 | CR27 | 1 | 0.21 | 0.9 | 25 |
| 33 | CR28 | 1 | 0.21 | 0.9 | 25 |
| 34 | CR1 | 9 | 0.21 | 0.9 | 25 |
| 35 | CR1 | 10 | 0.21 | 0.9 | 25 |
| 36 | CR1 | 11 | 0.21 | 0.9 | 25 |
| 37 | CR1 | 12 | 0.21 | 0.9 | 25 |
| 38 | CR1 | 1 | 0.21 | 0.9 | 3 |
| 39 | CR1 | 1 | 0.21 | 0.9 | 2 |
| 40 | CR1 | 1 | 0.21 | 0.9 | 70 |
| 41 | CR1 | 13 | 0.21 | 0.9 | 25 |
| 42 | CR1 | 14 | 0.21 | 0.9 | 25 |
| 43 | CR1 | 17 | 0.21 | 0.9 | 25 |
| 44 | CR29 | 1 | 0.21 | 0.9 | 25 |
| 45 | CR30 | 1 | 0.21 | 0.9 | 25 |
| 46 | CR31 | 1 | 0.21 | 0.9 | 25 |
| 47 | CR32 | 1 | 0.21 | 0.9 | 25 |
| 48 | CR33 | 15 | 0.21 | 0.9 | 25 |
| 49 | CR34 | 16 | 0.21 | 0.9 | 25 |
| C.E. 1 | CR35 | 1 | — | — | 25 |
| C.E. 2 | CR36 | 1 | 0.12 | — | 25 |
| C.E. 3 | CR37 | 1 | 0.21 | 0.9 | 25 |
| C.E. 4 | CR38 | 1 | 0.21 | 0.9 | 25 |
| C.E. 5 | CR39 | 1 | — | 0.9 | 25 |
| C.E. 6 | CR40 | 1 | — | 0.9 | 25 |
| C.E. 7 | CR41 | 1 | — | 0.9 | 25 |
| C.E. 8 | CR42 | 1 | — | — | 25 |
| C.E. 9 | CR9 | 18 | — | — | 25 |
| C.E. 10 | CR9 | 19 | — | — | 25 |
| C.E. 11 | CR9 | 20 | — | — | 25 |

In the Table 3-1, “Average major axis of titanium oxide fine particles/average height of group of first protrusions” is the value obtained by dividing the number-average value of the major axis of titanium oxide fine particles A by the average height of the protrusions contained in the group of first protrusions. “Average major axis of titanium oxide fine particles−average height of group of second protrusions” is the value of the difference “(number-average value of major axis of titanium oxide fine particles A)−(average height of the protrusions contained in the group of second protrusions)”. “C.E.” indicates “Comparative Example”.

TABLE 3-2

| Example | Evaluation 1 | | Evaluation 2 | | Evaluation 3 | | Evaluation 4 | | Evaluation 5 | | Evaluation 6 | | Evaluation 7 | | Evaluation 8 | | Evaluation 9 | |
|---|---|---|---|---|---|---|---|---|---|---|---|---|---|---|---|---|---|---|
| No. | Rank | No. | Rank | No. | Rank | No. | Rank | No. | Rank | No. | Rank | No. | Rank | No. | Rank | No. | Rank | No. |
| 1 | A | 0 | A | 0 | A | 0 | A | 0 | A | 0 | A | 0 | A | 0 | A | 0 | A | 0 |
| 2 | A | 0 | A | 0 | A | 1 | A | 1 | A | 1 | A | 3 | B | 3 | A | 1 | A | 1 |
| 3 | A | 0 | A | 0 | A | 1 | A | 1 | A | 1 | B | 5 | C | 6 | A | 2 | A | 2 |
| 4 | B | 4 | B | 3 | B | 5 | B | 4 | B | 5 | B | 5 | B | 4 | B | 4 | A | 2 |
| 5 | B | 5 | B | 3 | B | 6 | B | 4 | B | 6 | B | 6 | B | 4 | B | 6 | A | 3 |
| 6 | B | 4 | B | 3 | B | 5 | B | 4 | B | 5 | B | 5 | B | 4 | B | 4 | A | 2 |
| 7 | B | 4 | A | 0 | B | 5 | A | 1 | B | 5 | B | 5 | B | 4 | B | 4 | A | 2 |
| 8 | B | 4 | A | 0 | B | 5 | A | 1 | B | 5 | B | 5 | B | 4 | B | 4 | A | 2 |
| 9 | B | 4 | A | 0 | B | 5 | A | 1 | B | 5 | B | 5 | C | 6 | B | 4 | A | 2 |
| 10 | B | 5 | A | 0 | B | 6 | A | 1 | B | 6 | C | 9 | C | 8 | B | 6 | A | 3 |
| 11 | A | 0 | A | 0 | A | 1 | A | 1 | A | 2 | B | 4 | A | 2 | A | 1 | A | 1 |
| 12 | B | 4 | A | 0 | B | 5 | A | 1 | B | 5 | C | 7 | B | 4 | B | 4 | A | 3 |
| 13 | B | 4 | A | 0 | B | 5 | A | 1 | B | 5 | B | 5 | B | 4 | B | 4 | A | 3 |
| 14 | A | 0 | A | 0 | A | 1 | A | 1 | A | 2 | A | 1 | A | 2 | A | 1 | A | 1 |
| 15 | B | 4 | A | 0 | B | 5 | A | 1 | B | 5 | B | 5 | A | 2 | B | 4 | A | 3 |
| 16 | A | 0 | A | 0 | B | 5 | A | 1 | B | 5 | A | 3 | A | 2 | A | 3 | A | 1 |
| 17 | A | 0 | A | 0 | A | 1 | A | 1 | A | 2 | A | 1 | A | 2 | A | 1 | A | 1 |
| 18 | A | 0 | A | 0 | B | 5 | A | 1 | B | 5 | A | 3 | A | 2 | A | 3 | A | 1 |
| 19 | A | 2 | A | 0 | C | 8 | A | 1 | B | 6 | B | 5 | A | 2 | B | 5 | A | 2 |
| 20 | A | 2 | A | 0 | C | 8 | A | 1 | B | 6 | B | 5 | A | 2 | B | 5 | A | 2 |
| 21 | B | 4 | C | 6 | B | 5 | C | 7 | B | 6 | B | 6 | C | 7 | B | 5 | A | 3 |
| 22 | B | 4 | C | 6 | B | 5 | C | 7 | C | 9 | B | 6 | C | 7 | B | 5 | A | 3 |
| 23 | B | 4 | C | 6 | B | 5 | C | 7 | B | 6 | B | 6 | C | 7 | B | 5 | A | 3 |
| 24 | A | 0 | B | 3 | A | 1 | B | 4 | B | 6 | A | 2 | B | 4 | A | 3 | A | 2 |
| 25 | A | 0 | A | 0 | A | 1 | A | 1 | B | 6 | A | 2 | A | 1 | A | 3 | A | 2 |
| 26 | A | 0 | B | 3 | A | 1 | B | 4 | B | 6 | A | 2 | B | 4 | A | 3 | A | 2 |
| 27 | A | 0 | C | 6 | A | 1 | B | 5 | B | 6 | A | 2 | B | 5 | A | 3 | A | 2 |
| 28 | A | 0 | C | 6 | A | 1 | B | 5 | B | 6 | A | 2 | B | 5 | A | 3 | A | 2 |
| 29 | A | 2 | A | 0 | B | 5 | A | 1 | C | 9 | A | 2 | A | 1 | B | 5 | A | 3 |
| 30 | A | 0 | A | 0 | A | 1 | A | 1 | A | 2 | A | 2 | A | 1 | A | 2 | A | 1 |
| 31 | A | 0 | A | 0 | A | 1 | A | 1 | A | 2 | A | 2 | A | 1 | A | 2 | A | 1 |
| 32 | B | 4 | A | 0 | B | 5 | A | 1 | B | 5 | B | 5 | A | 1 | B | 5 | A | 2 |
| 33 | A | 0 | B | 3 | A | 1 | B | 4 | A | 2 | A | 2 | B | 4 | A | 2 | A | 1 |
| 34 | A | 0 | A | 0 | A | 1 | A | 1 | A | 2 | A | 2 | A | 1 | B | 5 | A | 1 |
| 35 | A | 0 | A | 0 | A | 1 | A | 1 | A | 2 | A | 2 | A | 1 | C | 8 | A | 1 |
| 36 | A | 0 | A | 0 | A | 1 | A | 1 | A | 2 | A | 2 | A | 1 | B | 5 | A | 1 |
| 37 | A | 0 | A | 0 | A | 1 | A | 1 | A | 2 | A | 2 | A | 1 | C | 7 | A | 1 |
| 38 | A | 2 | A | 0 | A | 3 | A | 1 | A | 3 | A | 3 | A | 1 | A | 3 | A | 1 |
| 39 | B | 5 | A | 2 | B | 6 | A | 2 | B | 6 | B | 6 | A | 2 | B | 6 | A | 3 |
| 40 | A | 0 | A | 0 | A | 1 | A | 1 | A | 1 | A | 1 | A | 1 | A | 2 | A | 1 |
| 41 | A | 0 | A | 0 | A | 1 | A | 1 | A | 1 | A | 1 | A | 1 | A | 2 | B | 6 |
| 42 | A | 2 | A | 2 | A | 3 | A | 2 | A | 3 | A | 3 | A | 2 | A | 3 | C | 8 |
| 43 | A | 2 | A | 2 | A | 3 | A | 2 | A | 3 | A | 3 | A | 2 | A | 3 | C | 9 |
| 44 | A | 2 | A | 0 | A | 3 | B | 4 | A | 3 | A | 1 | B | 4 | A | 3 | A | 1 |
| 45 | A | 2 | A | 0 | A | 3 | B | 4 | A | 3 | A | 1 | B | 4 | A | 3 | A | 1 |
| 46 | A | 2 | A | 0 | A | 3 | C | 7 | A | 3 | A | 1 | B | 5 | A | 3 | A | 1 |
| 47 | A | 2 | A | 0 | A | 3 | C | 7 | A | 3 | A | 1 | B | 5 | A | 3 | A | 1 |
| 48 | A | 0 | A | 0 | A | 1 | A | 1 | A | 1 | A | 1 | A | 1 | A | 2 | A | 1 |
| 49 | A | 0 | A | 0 | A | 1 | A | 1 | A | 1 | A | 1 | A | 1 | A | 2 | A | 1 |
| C.E. 1 | E | 15 | C | 8 | E | 17 | D | 11 | E | 18 | E | 19 | D | 11 | E | 18 | E | 20 |
| C.E. 2 | D | 10 | D | 10 | E | 17 | D | 11 | E | 18 | E | 20 | D | 11 | E | 20 | E | 21 |
| C.E. 3 | D | 10 | C | 7 | D | 12 | D | 9 | D | 10 | D | 11 | D | 9 | D | 11 | D | 12 |
| C.E. 4 | E | 15 | C | 7 | E | 17 | D | 9 | E | 18 | E | 19 | D | 9 | E | 19 | E | 20 |
| C.E. 5 | E | 15 | C | 7 | E | 17 | D | 9 | E | 18 | E | 19 | D | 9 | E | 20 | F | 20 |
| C.E. 6 | D | 10 | C | 7 | D | 12 | D | 9 | D | 10 | D | 12 | D | 9 | D | 12 | D | 12 |
| C.E. 7 | E | 15 | C | 7 | E | 17 | D | 9 | E | 18 | E | 19 | D | 9 | E | 18 | E | 21 |
| C.E. 8 | E | 15 | C | 7 | E | 17 | D | 9 | E | 18 | E | 19 | D | 9 | E | 18 | E | 22 |
| C.E. 9 | D | 10 | C | 7 | D | 12 | D | 9 | D | 10 | E | 19 | D | 9 | E | 18 | E | 21 |
| C.E. 10 | D | 10 | C | 7 | D | 12 | D | 9 | D | 10 | E | 19 | D | 9 | E | 18 | E | 23 |
| C.E. 11 | D | 11 | C | 8 | D | 11 | D | 10 | D | 11 | E | 20 | D | 10 | E | 19 | F | 24 |

In the Tables 3-1 and 3-2, “C.E.” indicates “Comparative Example”.

The present disclosure can provide an electrophotographic image forming apparatus, process cartridge, and image forming method that make it possible to stably output highly uniform halftone images even after durable use for a long period of time in an ultra-low-temperature environment.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-037302, filed Mar. 10, 2025, and Japanese Patent Application No. 2026-025166, filed Feb. 19, 2026, which are hereby incorporated by reference herein in their entirety.

What is claimed is:

1. An electrophotographic image forming apparatus comprising:
a photosensitive drum;
a charging roller for charging a surface of the photosensitive drum;
an exposure means for exposing charged photosensitive drum to form an electrostatic latent image on the photosensitive drum;
a developing means having toner and using the toner to develop the electrostatic latent image formed on the surface of the photosensitive drum, thereby forming a toner image;
a transfer means for transferring the toner image to a transfer material, with or without an intermediate transfer member; and
a fixing means for fixing the toner image on the transfer material, wherein a surface of the charging roller has a plurality of protrusions,
when a group of protrusions having a height of 10.0 μm to 40.0 μm among the plurality of protrusions is taken as a group of first protrusions, and the number of vertices of the protrusions included in the group of first protrusions per unit area on the surface of the charging roller is denoted by Spd1, the Spd1 is 10/mm² to 300/mm²,
the number of vertices of the protrusions having a height exceeding 40.0 μm per unit area on the surface of the charging roller is not more than 3.0/mm²,
the toner comprises a toner particle and titanium oxide fine particles;
the titanium oxide fine particles comprise titanium oxide fine particles A that satisfy all of conditions (i) to (ii) below,
when the toner is observed using a scanning electron microscope, a proportion of the toner particle that can be confirmed to have the titanium oxide fine particles A on surfaces thereof is 80% by number to 99% by number:
(i) The number-average value of major axis is 1.0 μm to 6.0 μm;
(ii) The number-average value of aspect ratio is at least 5.0.

2. The electrophotographic image forming apparatus according to claim 1, wherein a group of second protrusions, which is a group of protrusions having a height of 0.2 μm to 5.0 μm, is present on the surface of the charging roller.

3. The electrophotographic image forming apparatus according to claim 2, wherein when the number of vertices of the protrusions included in the group of second protrusions per unit area on the surface of the charging roller is denoted by Spd2,
the Spd2 is 4000/mm² to 40,000/mm².

4. The electrophotographic image forming apparatus according to claim 3, wherein when the number of vortices of protrusions having a height of 0.2 μm or more per unit area on the surface of the charging roller is denoted by Spda (number/mm²), a ratio of first protrusions and second protrusions expressed as (Spd1+Spd2)/Spda×100 is at least 98.0%.

5. The electrophotographic image forming apparatus according to claim 2, wherein when a universal hardness of the protrusions included in the group of second protrusions measured at an indentation depth of 0.4 μm is defined as HU2,
the HU2 is at least 1.0 N/mm² and less than 2.0 N/mm².

6. The electrophotographic image forming apparatus according to claim 2, wherein the number-average value of major axes of the titanium oxide fine particles A is larger than the average height of the protrusions included in the group of second protrusions.

7. The electrophotographic image forming apparatus according to claim 1, wherein when a universal hardness of the protrusions included in the group of first protrusions measured at an indentation depth of 0.4 μm is defined as HU1,
the HU1 is 1.0 N/mm² to 5.0 N/mm².

8. The electrophotographic image forming apparatus according to claim 1, wherein the charging roller has a conductive support, a base layer provided on the support, and a surface layer provided on the base layer.

9. The electrophotographic image forming apparatus according to claim 8, wherein
the surface layer comprises a binder resin, and
when a universal hardness of the binder resin measured at an indentation depth of 0.4 μm is defined as HUb, HUb is 1.0 N/mm² to 5.0 N/mm².

10. The electrophotographic image forming apparatus according to claim 1, wherein a value obtained by dividing the number-average value of major axes of the titanium oxide fine particles A by the average height of the protrusions included in the group of first protrusions is 0.03 to 0.40.

11. The electrophotographic image forming apparatus according to claim 1, wherein an adhesion rate of the titanium oxide fine particles A to the toner particle is not more than 40% by number.

12. The electrophotographic image forming apparatus according to claim 1, wherein when the toner is observed using a scanning electron microscope, the proportion of the toner particle that can be confirmed to have, on surface thereof, the titanium oxide fine particle A is at least 90% by number.

13. The electrophotographic image forming apparatus according to claim 1, wherein
the toner comprises a compound A having a structure represented by formula (1) below: 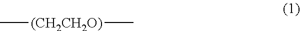
when the toner is subjected to an elution treatment under an elution condition A below, the compound A is eluted into methanol,
when a supernatant obtained by centrifuging an eluate, which is obtained as a result of elution of the compound A into methanol, under a centrifugation condition A below is analyzed by liquid chromatography ESI/MS in a range of m/z=50 to 1500,
a reference peak defined as below is present, and
an average m/z defined as below is 300 to 1000:
Elution condition A: methanol (equivalent to JIS K8891 standard) in an amount 10 times the mass of the toner is used at 25° C., and stirring is performed for 10 h with a stirring device at a rotation speed of a rotor of 200 rpm;
Centrifugation condition A: rotation is performed for 30 min at 25° C., with a rotation radius of 10.1 cm and a rotation speed of 3500 rpm;
Reference peak: in a mass analysis spectrum obtained by liquid chromatography ESI/MS of the supernatant, a relative abundance is determined by setting the abundance of the most intense peak at 100%. Peaks are selected in descending order of relative abundance, and the m/z value of the peak top of the selected peaks is denoted by P. Of the selected peaks that have a relative abundance of at least 10% and a peak top m/z value of P+44 or P−44, a selected peak with the highest relative abundance is designated as the reference peak; and
Average m/z: the m/z value of the peak top of the reference peak is denoted by Ps, and the average m/z value of the peak tops of peaks with a peak top m/z value=Ps+44n (n is an integer) and a relative abundance of at least 30% is designated as the average m/z.

14. The electrophotographic image forming apparatus according to claim 13, wherein the toner comprises a compound B that dissolves in methanol when the toner is subjected to an elution treatment under the elution condition A,
when the supernatant is supplied to a liquid chromatograph ESI/MS analyzer and analyzed under an analysis condition A below,
the compound B contained in the supernatant is ionized and detected as an anion:
Analysis condition A: under conditions of Sheath Gas: 10 (arb. unit), Aux Gas: 5 (arb. unit), spray voltage: 5 kV, and capillary temperature: 275° C., compounds ionized under conditions of capillary voltage: 35 V and tube lens voltage: 110 V are detected as cations, and compounds ionized under conditions of capillary voltage: −35 V and tube lens voltage: −110 V are detected as anions.

15. The electrophotographic image forming apparatus according to claim 1, further comprising a cleaning means equipped with a cleaning blade that is brought into contact with the surface of the photosensitive drum to clean the surface of the photosensitive drum, wherein
a contact line pressure of the cleaning blade against the photosensitive drum is 3 N/m to 300 N/m.

16. A process cartridge comprising:
a photosensitive drum;
a charging roller for charging a surface of the photosensitive drum; and
a developing means having toner and using the toner to develop an electrostatic latent image formed on the surface of the photosensitive drum, thereby forming a toner image, wherein
a surface of the charging roller has a plurality of protrusions;
when a group of protrusions having a height of 10.0 μm to 40.0 μm among the plurality of protrusions is taken as a group of first protrusions, and the number of vertices of the protrusions included in the group of first protrusions per unit area on the surface of the charging roller is denoted by Spd1, the Spd1 is 10/mm² to 300/mm²;
the number of vertices of the protrusions having a height exceeding 40.0 μm per unit area on the surface of the charging roller is not more than 3.0/mm²,
the toner comprises a toner particle and titanium oxide fine particles;
the titanium oxide fine particles comprise titanium oxide fine particles A that satisfy all of conditions (i) to (ii) below, and
when the toner is observed using a scanning electron microscope, a proportion of the toner particle that can be confirmed to have, on the surface thereof, titanium oxide fine particles A is 80% by number to 99% by number:
(i) The number-average value of major axis is 1.0 μm to 6.0 μm;
(ii) The number-average value of aspect ratio is at least 5.0.

17. The process cartridge according to claim 16, further comprising a cleaning means equipped with a cleaning blade that is brought into contact with the surface of the photosensitive drum to clean the surface of the photosensitive drum, wherein
a contact line pressure of the cleaning blade against the photosensitive drum is 3 N/m to 300 N/m.

18. An image forming method comprising:
a charging step of charging a surface of a photosensitive drum by using a charging roller;
an exposure step of exposing charged photosensitive drum to form an electrostatic latent image on the photosensitive drum;
a development step of using toner to develop the electrostatic latent image formed on the surface of the photosensitive drum, thereby forming a toner image;
a transfer step of transferring the toner image to a transfer material, with or without an intermediate transfer member; and
a fixing step of fixing the toner image on the transfer material, wherein
a surface of the charging roller has a plurality of protrusions,
when a group of protrusions having a height of 10.0 μm to 40.0 μm among the plurality of protrusions is taken as a group of first protrusions, and the number of vertices of the protrusions included in the group of first protrusions per unit area on the surface of the charging roller is denoted by Spd1, the Spd1 is 10/mm² to 300/mm²,
the number of vertices of the protrusions having a height exceeding 40.0 μm per unit area on the surface of the charging roller is not more than 3.0/mm²,
the toner comprises a toner particle and titanium oxide fine particles;
the titanium oxide fine particles comprise titanium oxide fine particles A that satisfy all of conditions (i) to (ii) below,
when the toner is observed using a scanning electron microscope, a proportion of the toner particle that can be confirmed to have, on the surface thereof, titanium oxide fine particles A is 80% by number to 99% by number:
(i) The number-average value of major axis is 1.0 μm to 6.0 μm;
(ii) The number-average value of aspect ratio is at least 5.0.

19. The image forming method according to claim 18, further comprising a cleaning step of cleaning the surface of the photosensitive drum with a cleaning blade brought into contact with the surface of the photosensitive drum, wherein
a contact line pressure of the cleaning blade against the photosensitive drum is 3 N/m to 300 N/m.
